SEQUENCE LISTING (124 sequences)

SEQ ID NO: 1 - protein, 335 aa, Aeromonas hydrophila
MKKWFVCLLGLVALTVQAADSRPAFSRIVMFGDSLSDTGKMYSKMRGYLPSSPPYYEGRFSNGPVWLEQLTKQFPGLTIANEAEGGATAVAYNKISWNPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNQLLLNLARQLAPTGMVKLFEIDKQFAEMLRDPQNFGLSDVENPCYDGGYVWKPFATRSVSTDRQLSAFSPQERLAIAGNPLLAQAVASPMARRSASPLNCEGKMFWDQVHPTTVVHAALSERAATFIANQYEFLAH

SEQ ID NO: 2 - protein, 361 aa, Artificial Sequence
  pfam00657 consensus sequence
IVAFGDSLTDGEAYYGDSDGGGWGAGLADRLTALLRLRARPRGVDVFNRGISGRTSDGRLIVDALVALLFLAQSLGLPNLPPYLSGDFLRGANFASAGATILPTSGPFLIQVQFKDFKSQVLELRQALGLLQELLRLLPVLDAKSPDLVTIMIGTNDLITSAFFGPKSTESDRNVSVPEFKDNLRQLIKRLRSNNGARIIVLITLVILNLGPLGCLPLKLALALASSKNVDASGCLERLNEAVADFNEALRELAISKLEDQLRKDGLPDVKGADVPYVDLYSIFQDLDGIQNPSAYVYGFETTKACCGYGGRYNYNRVCGNAGLCNVTAKACNPSSYLLSFLFWDGFHPSEKGYKAVAEAL

SEQ ID NO: 3 - protein, 335 aa, Aeromonas hydrophila
MKKWFVCLLGLVALTVQAADSRPAFSRIVMFGDSLSDTGKMYSKMRGYLPSSPPYYEGRFSNGPVWLEQLTNEFPGLTIANEAEGGPTAVAYNKISWNPKYQVINNLDYEVTQFLQKDSFKPDDLVILWVGANDYLAYGWNTEQDAKRVRDAISDAANRMVLNGAKEILLFNLPDLGQNPSARSQKVVEAASHVSAYHNQLLLNLARQLAPTGMVKLFEIDKQFAEMLRDPQNFGLSDQRNACYGGSYVWKPFASRSASTDSQLSAFNPQERLAIAGNPLLAQAVASPMAARSASTLNCEGKMFWDQVHPTTVVHAALSEPAATFIESQYEFLAH

SEQ ID NO: 4 - protein, 336 aa, Aeromonas salmonicida
MKKWFVCLLGLIALTVQAADTRPAFSRIVMFGDSLSDTGKMYSKMRGYLPSSPPYYEGRFSNGPVWLEQLTKQFPGLTIANEAEGGATAVAYNKISWNPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNKLLLNLARQLAPTGMVKLFEIDKQFAEMLRDPQNFGLSDVENPCYDGGYVWKPFATRSVSTDRQLSAFSPQERLAIAGNPLLAQAVASPMARRSASPLNCEGKMFWDQVHPTTVVHAALSERAATFIETQYEFLAHG

SEQ ID NO: 5 - protein, 295 aa, Streptomyces coelicolor
MPKPALRRVMTATVAAVGTLALGLTDATAHAAPAQATPTLDYVALGDSYSAGSGVLPVDPANLLCLRSTANYPHVIADTTGARLTDVTCGAAQTADFTRAQYPGVAPQLDALGTGTDLVTLTIGGNDNSTFINAITACGTAGVLSGGKGSPCKDRHGTSFDDEIEANTYPALKEALLGVRARAPHARVAALGYPWITPATADPSCFLKLPLAAGDVPYLRAIQAHLNDAVRRAAEETGATYVDFSGVSDGHDACEAPGTRWIEPLLFGHSLVPVHPNALGERRMAEHTMDVLGLD

SEQ ID NO: 6 - protein, 295 aa, Streptomyces coelicolor; identical to SEQ ID NO: 5

SEQ ID NO: 7 - protein, 238 aa, Saccharomyces cerevisiae
MDYEKFLLFGDSITEFAFNTRPIEDGKDQYALGAALVNEYTRKMDILQRGFKGYTSRWALKILPEILKHESNIVMATIFLGANDACSAGPQSVPLPEFIDNIRQMVSLMKSYHIRPIIIGPGLVDREKWEKEKSEEIALGYFRTNENFAIYSDALAKLANEEKVPFVALNKAFQQEGGDAWQQLLTDGLHFSGKGYKIFHDELLKVIETFYPQYHPKNMQYKLKDWRDVLDDGSNIMS

SEQ ID NO: 8 - protein, 347 aa, Ralstonia sp.
MNLRQWMGAATAALALGLAACGGGGTDQSGNPNVAKVQRMVVFGDSLSDIGTYTPVAQAVGGGKFTTNPGPIWAETVAAQLGVTLTPAVMGYATSVQNCPKAGCFDYAQGGSRVTDPNGIGHNGGAGALTYPVQQQLANFYAASNNTFNGNNDVVFVLAGSNDIFFWTTAAATSGSGVTPAIATAQVQQAATDLVGYVKDMIAKGATQVYVFNLPDSSLTPDGVASGTTGQALLHALVGTFNTTLQSGLAGTSARIIDFNAQLTAAIQNGASFGFANTSARACDATKINALVPSAGGSSLFCSANTLVASGADQSYLFADGVHPTTAGHRLIASNVLARLLADNVAH

SEQ ID NO: 9 - protein, 261 aa, Streptomyces coelicolor
MIGSYVAVGDSFTEGVGDPGPDGAFVGWADRLAVLLADRRPEGDFTYTNLAVRGRLLDQIVAEQVPRVVGLAPDLVSFAAGGNDIIRPGTDPDEVAERFELAVAALTAAAGTVLVTTGFDTRGVPVLKHLRGKIATYNGHVRAIADRYGCPVLDLWSLRSVQDRRAWDADRLHLSPEGHTRVALRAGQALGLRVPADPDQPWPPLPPRGTLDVRRDDVHWAREYLVPWIGRRLRGESSGDHVTAKGTLSPDAIKTRIAAVA

SEQ ID NO: 10 - protein, 260 aa, Streptomyces coelicolor
MQTNPAYTSLVAVGDSFTEGMSDLLPDGSYRGWADLLATRMAARSPGFRYANLAVRGKLIGQIVDEQVDVAAAMGADVITLVGGLNDTLRPKCDMARVRDLLTQAVERLAPHCEQLVLMRSPGRQGPVLERFRPRMEALFAVIDDLAGRHGAVVVDLYGAQSLADPRMWDVDRLHLTAEGHRRVAEAVWQSLGHEPEDPEWHAPIPATPPPGWVTRRTADVRFARQHLLPWIGRRLTGRSSGDGLPAKRPDLLPYEDPAR

SEQ ID NO: 11 - protein, 454 aa, Streptomyces coelicolor
MTRGRDGGAGAPPTKHRALLAAIVTLIVAISAAIYAGASADDGSRDHALQAGGRLPRGDAAPASTGAWVGAWATAPAAAEPGTETTGLAGRSVRNVVHTSVGGTGARITLSNLYGQSPLTVTHASIALAAGPDTAAAIADTMRRLTFGGSARVIIPAGGQVMSDTARLAIPYGANVLVTTYSPIPSGPVTYHPQARQTSYLADGDRTADVTAVAYTTPTPYWRYLTALDVLSHEADGTVVAFGDSITDGARSQSDANHRWTDVLAARLHEAAGDGRDTPRYSVVNEGISGNRLLTSRPGRPADNPSGLSRFQRDVLERTNVKAVVVVLGVNDVLNSPELADRDAILTGLRTLVDRAHARGLRVVGATITPFGGYGGYTEARETMRQEVNEEIRSGRVFDTVVDFDKALRDPYDPRRMRSDYDSGDHLHPGDKGYARMGAVIDLAALKGAAPVKA

SEQ ID NO: 12 - protein, 340 aa, Streptomyces coelicolor
MTSMSRARVARRIAAGAAYGGGGIGLAGAAAVGLVVAEVQLARRRVGVGTPTRVPNAQGLYGGTLPTAGDPPLRLMMLGDSTAAGQGVHRAGQTPGALLASGLAAVAERPVRLGSVAQPGACSDDLDRQVALVLAEPDRVPDICVIMVGANDVTHRMPATRSVRHLSSAVRRLRTAGAEVVVGTCPDLGTIERVRQPLRWLARRASRQLAAAQTIGAVEQGGRTVSLGDLLGPEFAQNPRELFGPDNYHPSAEGYATAAMAVLPSVCAALGLWPADEEHPDALRREGFLPVARAAAEAASEAGTEVAAAMPTGPRGPWALLKRRRRRRVSEAEPSSPSGV

SEQ ID NO: 13 - protein, 305 aa, Streptomyces coelicolor
MGRGTDQRTRYGRRRARVALAALTAAVLGVGVAGCDSVGGDSPAPSGSPSKRTRTAPAWDTSPASVAAVGDSITRGFDACAVLSDCPEVSWATGSSAKVDSLAVRLLGKADAAEHSWNYAVTGARMADLTAQVTRAAQREPELVAVMAGANDACRSTTSAMTPVADFRAQFEEAMATLRKKLPKAQVYVSSIPDLKRLWSQGRTNPLGKQVWKLGLCPSMLGDADSLDSAATLRRNTVRDRVADYNEVLREVCAKDRRCRSDDGAVHEFRFGTDQLSHWDWFHPSVDGQARLAEIAYRAVTAKNP

SEQ ID NO: 14 - protein, 268 aa, Streptomyces rimosus
MRLSRRAATASALLLTPALALFGASAAVSAPRIQATDYVALGDSYSSGVGAGSYDSSSGSCKRSTKSYPALWAASHTGTRFNFTACSGARTGDVLAKQLTPVNSGTDLVSITIGGNDAGFADTMTTCNLQGESACLARIAKARAYIQQTLPAQLDQVYDAIDSRAPAAQVVVLGYPRFYKLGGSCAVGLSEKSRAAINAAADDINAVTAKRAADHGFAFGDVNTTFAGHELCSGAPWLHSVTLPVENSYHPTANGQSKGYLPVLNSAT

SEQ ID NO: 15 - protein, 336 aa, Aeromonas salmonicida subsp. Salmonicida; identical to SEQ ID NO: 4

SEQ ID NO: 16 - protein, 318 aa, Aeromonas salmonicida
ADTRPAFSRIVMFGDSLSDTGKMYSKMRGYLPSSPPYYEGRFSNGPVWLEQLTKQFPGLTIANEAEGGATAVAYNKISWDPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNKLLLNLARQLAPTGMVKLFEIDKQFAEMLRDPQNFGLSDVENPCYDGGYVWKPFATRSVSTDRQLSAFSPQERLAIAGNPLLAQAVASPMARRSASPLNCEGKMFWDQVHPTTVVHAALSERAATFIETQYEFLAHG

SEQ ID NO: 17 - protein, 465 aa, Candida parapsilosis
MRYFAIAFLLINTISAFVLAPKKPSQDDFYTPPQGYEAQPLGSILKTRNVPNPLTNVFTPVKVQNAWQLLVRSEDTFGNPNAIVTTIIQPFNAKKDKLVSYQTFEDSGKLDCAPSYAIQYGSDISTLTTQGEMYYISALLDQGYYVVTPDYEGPKSTFTVGLQSGRATLNSLRATLKSGNLTGVSSDAETLLWGYSGGSLASGWAAAIQKEYAPELSKNLLGAALGGFVTNITATAEAVDSGPFAGIISNALAGIGNEYPDFKNYLLKKVSPLLSITYRLGNTHCLLDGGIAYFGKSFFSRIIRYFPDGWDLVNQEPIKTILQDNGLVYQPKDLTPQIPLFIYHGTLDAIVPIVNSRKTFQQWCDWGLKSGEYNEDLTNGHITESIVGAPAALTWIINRFNGQPPVDGCQHNVRASNLEYPGTPQSIKNYFEAALHAILGFDLGPDVKRDKVTLGGLLKLERFAF

SEQ ID NO: 18 - protein, 471 aa, Candida parapsilosis
MRYFAIAFLLINTISAFVLAPKKPSQDDFYTPPQGYEAQPLGSILKTRNVPNPLTNVFTPVKVQNAWQLLVRSEDTFGNPNAIVTTIIQPFNAKKDKLVSYQTFEDSGKLDCAPSYAIQYGSDISTLTTQGEMYYISALLDQGYYVVTPDYEGPKSTFTVGLQSGRATLNSLRATLKSGNLTGVSSDAETLLWGYSGGSLASGWAAAIQKEYAPELSKNLLGAALGGFVTNITATAEAVDSGPFAGIISNALAGIGNEYPDFKNYLLKKVSPLLSITYRLGNTHCLLDGGIAYFGKSFFSRIIRYFPDGWDLVNQEPIKTILQDNGLVYQPKDLTPQIPLFIYHGTLDAIVPIVNSRKTFQQWCDWGLKSGEYNEDLTNGHITESIVGAPAALTWIINRFNGQPPVDGCQHNVRASNLEYPGTPQSIKNYFEAALHAILGFDLGPDVKRDKVTLGGLLKLERFAFHHHHHH

SEQ ID NO: 19 - protein, 261 aa, Streptomyces coelicolor; identical to SEQ ID NO: 9

SEQ ID NO: 20 - protein, 5 aa, Artificial Sequence
  Sequence motif
  VARIANT (2)..(2): Xaa may be Ala or Gly
  VARIANT (5)..(5): Xaa may be Ala, Leu or Tyr
GXNDX

SEQ ID NO: 21 - protein, 18 aa, Aeromonas sp.
MKKWFVCLLGLIALTVQA

SEQ ID NO: 22 - protein, 29 aa, Bacillus subtilis
MRSKKLWISLLFALTLIFTMAFSNMSAQA

SEQ ID NO: 23 - protein, 29 aa, Bacillus licheniformis
MMRKKSFWFGMLTAFMLVFTMEFSDSASA

SEQ ID NO: 24 - DNA, 1047 bp, Aeromonas hydrophila
atgtttaagtttaaaaagaatttcttagttggattatcggcagctttaatgagtattagcttgttttcggcaaccgcctctgcagctagcgccgacagccgtcccgccttttcccggatcgtgatgttcggcgacagcctctccgataccggcaaaatgtacagcaagatgcgcggttacctcccctccagcccgccctactatgagggccgtttctccaacggacccgtctggctggagcagctgaccaaacagttcccgggtctgaccatcgccaacgaagcggaaggcggtgccactgccgtggcttacaacaagatctcctggaatcccaagtatcaggtcatcaacaacctggactacgaggtcacccagttcttgcagaaagacagcttcaagccggacgatctggtgatcctctgggtcggtgccaatgactatctggcctatggctggaacacggagcaggatgccaagcgggttcgcgatgccatcagcgatgcggccaaccgcatggtactgaacggtgccaagcagatactgctgttcaacctgccggatctgggccagaacccgtcagctcgcagtcagaaggtggtcgaggcggtcagccatgtctccgcctatcacaaccagctgctgctgaacctggcacgccagctggcccccaccggcatggtaaagctgttcgagatcgacaagcaatttgccgagatgctgcgtgatccgcagaacttcggcctgagcgacgtcgagaacccctgctacgacggcggctatgtgtggaagccgtttgccacccgcagcgtcagcaccgaccgccagctctccgccttcagtccgcaggaacgcctcgccatcgccggcaacccgctgctggcacaggccgttgccagtcctatggcccgccgcagcgccagccccctcaactgtgagggcaagatgttctgggatcaggtacacccgaccactgtcgtgcacgcagccctgagcgagcgcgccgccaccttcatcgcgaaccagtacgagttcctcgcccactgatga

SEQ ID NO: 25 - protein, 347 aa, Artificial Sequence
  Fusion construct used for mutagenesis
MFKFKKNFLVGLSAALMSISLFSATASAASADSRPAFSRIVMFGDSLSDTGKMYSKMRGYLPSSPPYYEGRFSNGPVWLEQLTKQFPGLTIANEAEGGATAVAYNKISWNPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNQLLLNLARQLAPTGMVKLFEIDKQFAEMLRDPQNFGLSDVENPCYDGGYVWKPFATRSVSTDRQLSAFSPQERLAIAGNPLLAQAVASPMARRSASPLNCEGKMFWDQVHPTTVVHAALSERAATFIANQYEFLAH

SEQ ID NO: 26 - protein, 267 aa, Streptomyces sp.
MRLTRSLSAASVIVFALLLALLGISPAQAAGPAYVALGDSYSSGNGAGSYIDSSGDCHRSNNAYPARWAAANAPSSFTFAACSGAVTTDVINNQLGALNASTGLVSITIGGNDAGFADAMTTCVTSSDSTCLNRLATATNYINTTLLARLDAVYSQIKARAPNARVVVLGYPRMYLASNPWYCLGLSNTKRAAINTTADTLNSVISSRATAHGFRFGDVRPTFNNHELFFGNDWLHSLTLPVWESYHPTSTGHQSGYLPVLNANSST

SEQ ID NO: 27 - protein, 548 aa, Thermobifida sp.
MLPHPAGERGEVGAFFALLVGTPQDRRLRLECHETRPLRGRCGCGERRVPPLTLPGDGVLCTTSSTRDAETVWRKHLQPRPDGGFRPHLGVGCLLAGQGSPGVLWCGREGCRFEVCRRDTPGLSRTRNGDSSPPFRAGWSLPPKCGEISQSARKTPAVPRYSLLRTDRPDGPRGRFVGSGPRAATRRRLFLGIPALVLVTALTLVLAVPTGRETLWRMWCEATQDWCLGVPVDSRGQPAEDGEFLLLSPVQAATWGNYYALGDSYSSGDGARDYYPGTAVKGGCWRSANAYPELVAEAYDFAGHLSFLACSGQRGYAMLDAIDEVGSQLDWNSPHTSLVTIGIGGNDLGFSTVLKTCMVRVPLLDSKACTDQEDAIRKRMAKFETTFEELISEVRTRAPDARILVVGYPRIFPEEPTGAYYTLTASNQRWLNETIQEFNQQLAEAVAVHDEEIAASGGVGSVEFVDVYHALDGHEIGSDEPWVNGVQLRDLATGVTVDRSTFHPNAAGHRAVGERVIEQIETGPGRPLYATFAVVAGATVDTLAGEVG

SEQ ID NO: 28 - protein, 372 aa, Thermobifida sp.
MGSGPRAATRRRLFLGIPALVLVTALTLVLAVPTGRETLWRMWCEATQDWCLGVPVDSRGQPAEDGEFLLLSPVQAATWGNYYALGDSYSSGDGARDYYPGTAVKGGCWRSANAYPELVAEAYDFAGHLSFLACSGQRGYAMLDAIDEVGSQLDWNSPHTSLVTIGIGGNDLGFSTVLKTCMVRVPLLDSKACTDQEDAIRKRMAKFETTFEELISEVRTRAPDARILVVGYPRIFPEEPTGAYYTLTASNQRWLNETIQEFNQQLAEAVAVHDEEIAASGGVGSVEFVDVYHALDGHEIGSDEPWVNGVQLRDLATGVTVDRSTFHPNAAGHRAVGERVIEQIETGPGRPLYATFAVVAGATVDTLAGEVG

SEQ ID NO: 29 - protein, 300 aa, Corynebacterium efficiens
MRTTVIAASALLLLAGCADGAREETAGAPPGESSGGIREEGAEASTSITDVYIALGDSYAAMGGRDQPLRGEPFCLRSSGNYPELLHAEVTDLTCQGAVTGDLLEPRTLGERTLPAQVDALTEDTTLVTLSIGGNDLGFGEVAGCIRERIAGENADDCVDLLGETIGEQLDQLPPQLDRVHEAIRDRAGDAQVVVTGYLPLVSAGDCPELGDVSEADRRWAVELTGQINETVREAAERHDALFVLPDDADEHTSCAPPQQRWADIQGQQTDAYPLHPTSAGHEAMAAAVRDALGLEPVQP

SEQ ID NO: 30 - protein, 284 aa, Novosphingobium aromaticivorans
MGQVKLFARRCAPVLLALAGLAPAATVAREAPLAEGARYVALGSSFAAGPGVGPNAPGSPERCGRGTLNYPHLLAEALKLDLVDATCSGATTHHVLGPWNEVPPQIDSVNGDTRLVTLTIGGNDVSFVGNIFAAACEKMASPDPRCGKWREITEEEWQADEERMRSIVRQIHARAPLARVVVVDYITVLPPSGTCAAMAISPDRLAQSRSAAKRLARITARVAREEGASLLKFSHISRRHHPCSAKPWSNGLSAPADDGIPVHPNRLGHAEAAAALVKLVKLMK

SEQ ID NO: 31 - protein, 268 aa, Streptomyces coelicolor
MRRFRLVGFLSSLVLAAGAALTGAATAQAAQPAAADGYVALGDSYSSGVGAGSYISSSGDCKRSTKAHPYLWAAAHSPSTFDFTACSGARTGDVLSGQLGPLSSGTGLVSISIGGNDAGFADTMTTCVLQSESSCLSRIATAEAYVDSTLPGKLDGVYSAISDKAPNAHVVVIGYPRFYKLGTTCIGLSETKRTAINKASDHLNTVLAQRAAAHGFTFGDVRTTFTGHELCSGSPWLHSVNWLNIGESYHPTAAGQSGGYLPVLNGAA

SEQ ID NO: 32 - protein, 269 aa, Streptomyces avermitilis
MRRSRITAYVTSLLLAVGCALTGAATAQASPAAAATGYVALGDSYSSGVGAGSYLSSSGDCKRSSKAYPYLWQAAHSPSSFSFMACSGARTGDVLANQLGTLNSSTGLVSLTIGGNDAGFSDVMTTCVLQSDSACLSRINTAKAYVDSTLPGQLDSVYTAISTKAPSAHVAVLGYPRFYKLGGSCLAGLSETKRSAINDAADYLNSAIAKRAADHGFTFGDVKSTFTGHEICSSSTWLHSLDLLNIGQSYHPTAAGQSGGYLPVMNSVA

SEQ ID NO: 33 - protein, 267 aa, Streptomyces sp.; identical to SEQ ID NO: 26

SEQ ID NO: 34 - protein, 317 aa, Aeromonas hydrophila
ADSRPAFSRIVMFGDSLSDTGKMYSKMRGYLPSSPPYYEGRFSNGPVWLEQLTKQFPGLTIANEAEGGATAVAYNKISWNPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNQLLLNLARQLAPTGMVKLFEIDKQFAEMLRDPQNFGLSDVENPCYDGGYVWKPFATRSVSTDRQLSAFSPQERLAIAGNPLLAQAVASPMARRSASPLNCEGKMFWDQVHPTTVVHAALSERAATFIANQYEFLAH

SEQ ID NO: 35 - protein, 318 aa, Aeromonas salmonicida
ADTRPAFSRIVMFGDSLSDTGKMYSKMRGYLPSSPPYYEGRFSNGPVWLEQLTKQFPGLTIANEAEGGATAVAYNKISWNPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNKLLLNLARQLAPTGMVKLFEIDKQFAEMLRDPQNFGLSDVENPCYDGGYVWKPFATRSVSTDRQLSAFSPQERLAIAGNPLLAQAVASPMARRSASPLNCEGKMFWDQVHPTTVVHAALSERAATFIETQYEFLAHG

SEQ ID NO: 36 - DNA, 1371 bp, Streptomyces thermosacchari
acaggccgatgcacggaaccgtacctttccgcagtgaagcgctctccccccatcgttcgccgggacttcatccgcgattttggcatgaacacttccttcaacgcgcgtagcttgctacaagtgcggcagcagacccgctcgttggaggctcagtgagattgacccgatccctgtcggccgcatccgtcatcgtcttcgccctgctgctcgcgctgctgggcatcagcccggcccaggcagccggcccggcctatgtggccctgggggattcctattcctcgggcaacggcgccggaagttacatcgattcgagcggtgactgtcaccgcagcaacaacgcgtaccccgcccgctgggcggcggccaacgcaccgtcctccttcaccttcgcggcctgctcgggagcggtgaccacggatgtgatcaacaatcagctgggcgccctcaacgcgtccaccggcctggtgagcatcaccatcggcggcaatgacgcgggcttcgcggacgcgatgaccacctgcgtcaccagctcggacagcacctgcctcaaccggctggccaccgccaccaactacatcaacaccaccctgctcgcccggctcgacgcggtctacagccagatcaaggcccgtgcccccaacgcccgcgtggtcgtcctcggctacccgcgcatgtacctggcctcgaacccctggtactgcctgggcctgagcaacaccaagcgcgcggccatcaacaccaccgccgacaccctcaactcggtgatctcctcccgggccaccgcccacggattccgattcggcgatgtccgcccgaccttcaacaaccacgaactgttcttcggcaacgactggctgcactcactcaccctgccggtgtgggagtcgtaccaccccaccagcacgggccatcagagcggctatctgccggtcctcaacgccaacagctcgacctgatcaacgcacggccgtgcccgccccgcgcgtcacgctcggcgcgggcgccgcagcgcgttgatcagcccacagtgccggtgacggtcccaccgtcacggtcgagggtgtacgtcacggtggcgccgctccagaagtggaacgtcagcaggaccgtggagccgtccctgacctcgtcgaagaactccggggtcagcgtgatcacccctcccccgtagccgggggcgaaggcggcgccgaactccttgtaggacgtccagtcgtgcggcccggcgttgccaccgtccgcgtagaccgcttccatggtcgccagccggtccccgcggaactcggtggggatgtccgtgcccaaggtggtcccggtggtgtccgagagcaccgggggctcgtaccggatgatgtgcagatccaaagaatt

SEQ ID NO: 37 - protein, 267 aa, Streptomyces thermosacchari; identical to SEQ ID NO: 26

SEQ ID NO: 38 - protein, 548 aa, Thermobifida fusca; identical to SEQ ID NO: 27

SEQ ID NO: 39 - DNA, 3000 bp, Thermobifida fusca
ggtggtgaaccagaacacccggtcgtcggcgtgggcgtccaggtgcaggtgcaggttcttcaactgctccagcaggatgccgccgtggccgtgcacgatggccttgggcaggcctgtggtccccgacgagtacagcacccatagcggatggtcgaacggcagcggggtgaactccagttccgcgccttcgcccgcggcttcgaactccgcccaggacagggtgtcggcgacagggccgcagcccaggtacggcaggacgacggtgtgctgcaggctgggcatgccgtcgcgcagggctttgagcacgtcacggcggtcgaagtccttaccgccgtagcggtagccgtccacggccagcagcactttcggttcgatctgcgcgaaccggtcgaggacgctgcgcaccccgaagtcgggggaacaggacgaccaggtcgcaccgatcgcggcgcaggcgaggaatgcggccgtcgcctcggcgatgttcggcaggtaggccacgacccggtcgccggggcccaccccgaggctgcggagggccgcagcgatcgcggcggtgcgggtccgcagttctccccaggtccactcggtcaacggccggagttcggacgcgtgccggatcgccacggctgatgggtcacggtcgcggaagatgtgctcggcgtagttgagggtggcgccggggaaccagacggcgccgggcatggcgtcggaggcgagcactgtggtgtacggggtggcggcgcgcacccggtagtactcccagatcgcggaccagaatccttcgaggtcggttaccgaccagcgccacagtgcctcgtagtccggtgcgtccacaccgcggtgctcccgcacccagcgggtgaacgcggtgaggttggcgcgttctttgcgctcctcgtcgggactccacaggatcggcggctgcggcttgagtgtcatgaaacgcgaccccttcgtggacggtgcggatgcggtgagcgtcgggtgcctcccctaacgctccccggtgacggagtgttgtgcaccacatctagcacgcgggacgcggaaaccgtatggagaaaacacctacaaccccggccggacggtgggtttcggccacacttaggggtcgggtgcctgcttgccgggcagggcagtcccggggtgctgtggtgcgggcgggagggctgtcgcttcgaggtgtgccggcgggacactccgggcctcagccgtacccgcaacggggacagttctcctcccttccgggctggatggtcccttcccccgaaatgcggcgagatctcccagtcagcccggaaaacacccgctgtgcccaggtactctttgcttcgaacagacaggccggacggtccacgggggaggtttgtgggcagcggaccacgtgcggcgaccagacgacggttgttcctcggtatccccgctcttgtacttgtgacagcgctcacgctggtcttggctgtcccgacggggcgcgagacgctgtggcgcatgtggtgtgaggccacccaggactggtgcctgggggtgccggtcgactcccgcggacagcctgcggaggacggcgagtttctgctgctttctccggtccaggcagcgacctgggggaactattacgcgctcggggattcgtactcttcgggggacggggcccgcgactactatcccggcaccgcggtgaagggcggttgctggcggtccgctaacgcctatccggagctggtcgccgaagcctacgacttcgccggacacttgtcgttcctggcctgcagcggccagcgcggctacgccatgcttgacgctatcgacgaggtcggctcgcagctggactggaactcccctcacacgtcgctggtgacgatcgggatcggcggcaacgatctggggttctccacggttttgaagacctgcatggtgcgggtgccgctgctggacagcaaggcgtgcacggaccaggaggacgctatccgcaagcggatggcgaaattcgagacgacgtttgaagagctcatcagcgaagtgcgcacccgcgcgccggacgcccggatccttgtcgtgggctacccccggatttttccggaggaaccgaccggcgcctactacacgctgaccgcgagcaaccagcggtggctcaacgaaaccattcaggagttcaaccagcagctcgccgaggctgtcgcggtccacgacgaggagattgccgcgtcgggcggggtgggcagcgtggagttcgtggacgtctaccacgcgttggacggccacgagatcggctcggacgagccgtgggtgaacggggtgcagttgcgggacctcgccaccggggtgactgtggaccgcagtaccttccaccccaacgccgctgggcaccgggcggtcggtgagcgggtcatcgagcagatcgaaaccggcccgggccgtccgctctatgccactttcgcggtggtggcgggggcgaccgtggacactctcgcgggcgaggtggggtgacccggcttaccgtccggcccgcaggtctgcgagcactgcggcgatctggtccactgcccagtgcagttcgtcttcggtgatgaccagcggcggggagagccggatcgttgagccgtgcgtgtctttgacgagcacaccccgctgcaggagccgttcgcacagttctcttccggtggccagagtcgggtcgacgtcgatcccagcccacaggccgatgctgcgggccgcgaccacgccgttgccgaccagttggtcgaggcgggcgcgcagcacgggggcgagggcgcggacatggtccaggtaagggccgtcgcggacgaggctcaccacggcagtgccgaccgcgcaggcgagggcgttgccgccgaaggtgctgccgtgctggccggggcggatcacgtcgaagacttccgcgtcgcctaccgccgccgccacgggcaggatgccgccgcccagcgctttgccgaacaggtagatatcggcgtcgactccgctgtggtcgcaggcccg

SEQ ID NO: 40 - protein, 372 aa, Thermobifida fusca
VGSGPRAATRRRLFLGIPALVLVTALTLVLAVPTGRETLWRMWCEATQDWCLGVPVDSRGQPAEDGEFLLLSPVQAATWGNYYALGDSYSSGDGARDYYPGTAVKGGCWRSANAYPELVAEAYDFAGHLSFLACSGQRGYAMLDAIDEVGSQLDWNSPHTSLVTIGIGGNDLGFSTVLKTCMVRVPLLDSKACTDQEDAIRKRMAKFETTFEELISEVRTRAPDARILVVGYPRIFPEEPTGAYYTLTASNQRWLNETIQEFNQQLAEAVAVHDEEIAASGGVGSVEFVDVYHALDGHEIGSDEPWVNGVQLRDLATGVTVDRSTFHPNAAGHRAVGERVIEQIETGPGRPLYATFAVVAGATVDTLAGEVG

SEQ ID NO: 41 - protein, 300 aa, Corynebacterium efficiens; identical to SEQ ID NO: 29

SEQ ID NO: 42 - DNA, 3000 bp, Corynebacterium efficiens
ttctggggtgttatggggttgttatcggctcgtcctgggtggatcccgccaggtggggtattcacgggggacttttgtgtccaacagccgagaatgagtgccctgagcggtgggaatgaggtgggcggggctgtgtcgccatgagggggcggcgggctctgtggtgccccgcgacccccggccccggtgagcggtgaatgaaatccggctgtaatcagcatcccgtgcccaccccgtcggggaggtcagcgcccggagtgtctacgcagtcggatcctctcggactcggccatgctgtcggcagcatcgcgctcccgggtcttggcgtccctcggctgttctgcctgctgtccctggaaggcgaaatgatcaccggggagtgatacaccggtggtctcatcccggatgcccacttcggcgccatccggcaattcgggcagctccgggtggaagtaggtggcatccgatgcgtcggtgacgccatagtgggcgaagatctcatcctgctcgagggtgctcaggccactctccggatcgatatcgggggcgtccttgatggcgtccttgctgaaaccgaggtgcagcttgtgggcttccaatttcgcaccacggagcgggacgaggctggaatgacggccgaagagcccgtggtggacctcaacgaaggtgggtagtcccgtgtcatcattgaggaacacgccctccaccgcacccagcttgtggccggagttgtcgtaggcgctggcatccagaagggaaacgatctcatatttgtcggtgtgctcagacatgatcttcctttgctgtcggtgtctggtactaccacggtagggctgaatgcaactgttatttttctgttattttaggaattggtccatatcccacaggctggctgtggtcaaatcgtcatcaagtaatccctgtcacacaaaatgggtggtgggagccctggtcgcggttccgtgggaggcgccgtgccccgcaggatcgtcggcatcggcggatctggccggtaccccgcggtgaataaaatcattctgtaaccttcatcacggttggttttaggtatccgcccctttcgtcctgaccccgtccccggcgcgcgggagcccgcgggttgcggtagacaggggagacgtggacaccatgaggacaacggtcatcgcagcaagcgcattactccttctcgccggatgcgcggatggggcccgggaggagaccgccggtgcaccgccgggtgagtcctccgggggcatccgggaggagggggcggaggcgtcgacaagcatcaccgacgtctacatcgccctcggggattcctatgcggcgatgggcgggcgggatcagccgttacggggtgagccgttctgcctgcgctcgtccggtaattacccggaactcctccacgcagaggtcaccgatctcacctgccagggggcggtgaccggggatctgctcgaacccaggacgctgggggagcgcacgctgccggcgcaggtggatgcgctgacggaggacaccaccctggtcaccctctccatcgggggcaatgacctcggattcggggaggtggcgggatgcatccgggaacggatcgccggggagaacgctgatgattgcgtggacctgctgggggaaaccatcggggagcagctcgatcagcttcccccgcagctggaccgcgtgcacgaggctatccgggaccgcgccggggacgcgcaggttgtggtcaccggttacctgccgctcgtgtctgccggggactgccccgaactgggggatgtctccgaggcggatcgtcgttgggcggttgagctgaccgggcagatcaacgagaccgtgcgcgaggcggccgaacgacacgatgccctctttgtcctgcccgacgatgccgatgagcacaccagttgtgcacccccacagcagcgctgggcggatatccagggccaacagaccgatgcctatccgctgcacccgacctccgccggccatgaggcgatggccgccgccgtccgggacgcgctgggcctggaaccggtccagccgtagcgccgggcgcgcgcttgtcgacgaccaacccatgccaggctgcagtcacatccgcacatagcgcgcgcgggcgatggagtacgcaccatagaggatgagcccgatgccgacgatgatgagcagcacactgccgaagggttgttccccgagggtgcgcagagccgagtccagacctgcggcctgctccggatcatgggcccaaccggcgatgacgatcaacacccccaggatcccgaaggcgataccacgggcgacataaccggctgttccggtgatgatgatcgcggtcccgacctgccctgaccccgcacccgcctccagatcctcccggaaatcccgggtggcccccttccagaggttgtagacacccgcccccagtaccaccagcccggcgaccacaaccagcaccacaccccagggttgggataggacggtggcggtgacatcggtggcggtctccccatcggaggtgctgccgccccgggcgaaggtggaggtggtcaccgccagggagaagtagaccatggccatgaccgcccccttggccctttccttgaggtcctcgcccgccagcagctggctcaattgccagagtcccagggccgccagggcgatgacggcaacccacaggaggaactgcccacccggagcctccgcgatggtggccagggcacctgaattcgaggcctcatcacccgaaccgccggatccagtggcgatgcgcaccgcgatccacccgatgaggatgtgcagtatgcccaggacaatgaaaccacctctggccagggtggtcagcgcggggtggtcctcggcctggtcggcagcccgttcgatcgtccgtttcgcggatctggtgtcgcccttatccatagctcccattgaaccgccttgaggggtgggcggccactgtcagggcggattgtgatctgaactgtgatgttccatcaaccc

SEQ ID NO: 43 - protein, 268 aa, Streptomyces coelicolor; identical to SEQ ID NO: 31

SEQ ID NO: 44 - DNA, 2000 bp, Streptomyces coelicolor
cccggcggcccgtgcaggagcagcagccggcccgcgatgtcctcgggcgtcgtcttcatcaggccgtccatcgcgtcggcgaccggcgccgtgtagttggcccggacctcgtcccaggtgcccgcggcgatctggcgggtggtgcggtgcgggccgcgccgaggggagacgtaccagaagcccatcgtcacgttctccggctgcggttcgggctcgtccgccgctccgtccgtcgcctcgccgagcaccttctcggcgaggtcggcgctggtcgccgtcaccgtgacgtcggcgccccggctccagcgcgagatcagcagcgtccagccgtcgccctccgccagcgtcgcgctgcggtcgtcgtcgcgggcgatccgcagcacgcgcgcgccgggcggcagcagcgtggcgccggaccgtacgcggtcgatgttcgccgcgtgcgagtacggctgctcacccgtggcgaaacggccgaggaacagcgcgtcgacgacgtcggacggggagtcgctgtcgtccacgttgagccggatcggcagggcttcgtgcgggttcacggacatgtcgccatgatcgggcacccggccgccgcgtgcacccgctttcccgggcacgcacgacaggggctttctcgccgtcttccgtccgaacttgaacgagtgtcagccatttcttggcatggacacttccagtcaacgcgcgtagctgctaccacggttgtggcagcaatcctgctaagggaggttccatgagacgtttccgacttgtcggcttcctgagttcgctcgtcctcgccgccggcgccgccctcaccggggcagcgaccgcccaggcggcccaacccgccgccgccgacggctatgtggccctcggcgactcctactcctccggggtcggagcgggcagctacatcagctcgagcggcgactgcaagcgcagcacgaaggcccatccctacctgtgggcggccgcccactcgccctccacgttcgacttcaccgcctgttccggcgcccgtacgggtgatgttctctccggacagctcggcccgctcagctccggcaccggcctcgtctcgatcagcatcggcggcaacgacgccggtttcgccgacaccatgacgacctgtgtgctccagtccgagagctcctgcctgtcgcggatcgccaccgccgaggcgtacgtcgactcgacgctgcccggcaagctcgacggcgtctactcggcaatcagcgacaaggcgccgaacgcccacgtcgtcgtcatcggctacccgcgcttctacaagctcggcaccacctgcatcggcctgtccgagaccaagcggacggcgatcaacaaggcctccgaccacctcaacaccgtcctcgcccagcgcgccgccgcccacggcttcaccttcggcgacgtacgcaccaccttcaccggccacgagctgtgctccggcagcccctggctgcacagcgtcaactggctgaacatcggcgagtcgtaccaccccaccgcggccggccagtccggtggctacctgccggtcctcaacggcgccgcctgacctcaggcggaaggagaagaagaaggagcggagggagacgaggagtgggaggccccgcccgacggggtccccgtccccgtctccgtctccgtcccggtcccgcaagtcaccgagaacgccaccgcgtcggacgtggcccgcaccggactccgcacctccacgcgcacggcactctcgaacgcgccggtgtcgtcgtgcgtcgtcaccaccacgccgtcctggcgcgagcgctcgccgcccgacgggaaggacagcgtccgccaccccggatcggagaccgacccgtccgcggtcacccaccggtagccgacctccgcgggcagccgcccgaccgtgaacgtcgccgtgaacgcgggtgcccggtcgtgcggcggcggacaggcccccgagtagtgggtgcgcgagcccaccacggtcacctccaccgactgcgctgcggggc

SEQ ID NO: 45 - protein, 269 aa, Streptomyces avermitilis; identical to SEQ ID NO: 32

SEQ ID NO: 46 - DNA, 1980 bp, Streptomyces avermitilis
ccaccgccgggtcggcggcgagtctcctggcctcggtcgcggagaggttggccgtgtagccgttcagcgcggcgccgaacgtcttcttcaccgtgccgccgtactcgttgatcaggcccttgcccttgctcgacgcggccttgaagccggtgcccttcttgagcgtgacgatgtagctgcccttgatcgcggtgggggagccggcggcgagcaccgtgccctcggccggggtggcctgggcgggcagtgcggtgaatccgcccacgagggcgccggtcgccacggcggttatcgcggcgatccggatcttcttgctacgcagctgtgccatacgagggagtcctcctctgggcagcggcgcgcctgggtggggcgcacggctgtggggggtgcgcgcgtcatcacgcacacggccctggagcgtcgtgttccgccctgggttgagtaaagcctcggccatctacgggggtggctcaagggagttgagaccctgtcatgagtctgacatgagcacgcaatcaacggggccgtgagcaccccggggcgaccccggaaagtgccgagaagtcttggcatggacacttcctgtcaacacgcgtagctggtacgacggttacggcagagatcctgctaaagggaggttccatgagacgttcccgaattacggcatacgtgacctcactcctcctcgccgtcggctgcgccctcaccggggcagcgacggcgcaggcgtccccagccgccgcggccacgggctatgtggccctcggcgactcgtactcgtccggtgtcggcgccggcagctacctcagctccagcggcgactgcaagcgcagttcgaaggcctatccgtacctctggcaggccgcgcattcaccctcgtcgttcagtttcatggcttgctcgggcgctcgtacgggtgatgtcctggccaatcagctcggcaccctgaactcgtccaccggcctggtctccctcaccatcggaggcaacgacgcgggcttctccgacgtcatgacgacctgtgtgctccagtccgacagcgcctgcctctcccgcatcaacacggcgaaggcgtacgtcgactccaccctgcccggccaactcgacagcgtgtacacggcgatcagcacgaaggccccgtcggcccatgtggccgtgctgggctacccccgcttctacaaactgggcggctcctgcctcgcgggcctctcggagaccaagcggtccgccatcaacgacgcggccgactatctgaacagcgccatcgccaagcgcgccgccgaccacggcttcaccttcggcgacgtcaagagcaccttcaccggccatgagatctgctccagcagcacctggctgcacagtctcgacctgctgaacatcggccagtcctaccacccgaccgcggccggccagtccggcggctatctgccggtcatgaacagcgtggcctgagctcccacggcctgaatttttaaggcctgaatttttaaggcgaaggtgaaccggaagcggaggccccgtccgtcggggtctccgtcgcacaggtcaccgagaacggcacggagttggacgtcgtgcgcaccgggtcgcgcacctcgacggcgatctcgttcgagatcgttccgctcgtgtcgtacgtggtgacgaacacctgcttctgctgggtctttccgccgctcgccgggaaggacagcgtcttccagcccggatccgggacctcgcccttcttggtcacccagcggtactccacctcgaccggcacccggcccaccgtgaaggtcgccgtgaacgtgggcgcctgggcggtgggcggcgggcaggcaccggagtagtcggtgtgcacgccggtgaccgtcaccttcacggactgggccggcggggtcgtcgtaccgccgccgccaccgccgcctcccggagtggagcccgagctgtggtcgcccccgccgtcggcgttgtcgtcctcgggggttttcgaac

SEQ ID NO: 47 - protein, 372 aa, Thermobifida fusca; identical to SEQ ID NO: 28

SEQ ID NO: 48 - DNA, 968 bp, Thermobifida fusca
ctgcagacacccgccccgccttctcccggatcgtcatgttcggcgactccctcagcgacaccggcaagatgtactccaagatgcgcggctacctgccgtcctccccgccgtactacgagggccgcttctcgaacggcccggtctggctggagcagctgacgaagcagttccccggcctgacgatcgccaacgaggccgaggggggcgcgaccgcagtcgcctacaacaagatctcctggaacccgaagtaccaggtcattaacaacctcgactacgaggtcacccagttcttgcagaaggactcgttcaagcccgacgacctggtcatcctgtgggtgggcgccaacgactacctggcctacggttggaacacggagcaggacgccaagcgggtgcgcgacgccatctcggacgcggcaaaccgcatggtcctgaacggcgcgaagcagatcctgctgttcaacctgcccgacctgggccagaacccgtccgcccgctcccagaaggtcgtcgaggccgtctcgcacgtgtccgcctaccacaacaagctgctcctcaacctcgcccggcagctcgccccgacgggcatggtcaagctgttcgagatcgacaagcagttcgcggagatgctgcgcgacccccagaacttcggcctgagcgacgtggagaacccgtgctacgacggcggctacgtgtggaagccgttcgccacccggtccgtctcgaccgaccggcagctgtcggccttctcgccccaggagcgcctggcgatcgctggcaacccgctcctggcacaggcggtagcttcgccgatggcccgccgctcggcctcgcccctcaactgcgagggcaagatgttctgggaccaggtccaccccaccaccgtggtccacgccgccctctcggagcgcgccgccaccttcatcgagacccagtacgagttcctcgcccactagtctagaggatcc

SEQ ID NO: 49 - DNA, 1044 bp, Aeromonas salmonicida
atgaaacaacaaaaacggctttacgcccgattgctgacgctgttatttgcgctcatcttcttgctgcctcattctgcagcttcagcagcagatacaagaccggcgtttagccggatcgtcatgtttggagatagcctgagcgatacgggcaaaatgtatagcaaaatgagaggctatcttccgtcaagcccgccgtattatgaaggccgctttagcaatggaccggtctggctggaacaactgacgaaacaatttccgggactgacgatcgctaatgaagcagaaggaggagcaacagcggtcgcctataacaaaatcagctgggacccgaaatatcaggtcatcaacaacctggactatgaagtcacacagtttcttcagaaagacagctttaaaccggatgatctggtcatcctttgggtcggcgccaatgattatctggcgtatggctggaacacagaacaagatgccaaaagagtcagagatgccatcagcgatgccgctaatagaatggtcctgaacggcgccaaacaaatcctgctgtttaacctgccggatctgggacaaaatccgagcgccagaagccaaaaagtcgtcgaagcagtcagccatgtcagcgcctatcataacaaactgctgctgaacctggcaagacaattggcaccgacgggaatggttaaattgtttgaaattgacaaacagtttgccgaaatgctgagagatccgcaaaattttggcctgagcgatgtcgaaaacccgtgctatgatggcggatatgtctggaaaccgtttgccacaagaagcgtcagcacggatagacaactgtcagcgtttagcccgcaagaaagactggcaatcgccggaaatccgcttttggcacaagcagttgcttcaccgatggcaagaagatcagcaagcccgctgaattgcgaaggcaaaatgttttgggatcaggtccatccgacaacagttgtccatgctgccctttcagaaagagcggcgacgtttatcgaaacacagtatgaatttctggcccatggctga

SEQ ID NO: 50 - DNA, 1005 bp, Aeromonas hydrophila
atgaaaaaatggtttgtgtgtttattgggattggtcgcgctgacagttcaggcagccgacagccgtcccgccttctcccggatcgtgatgtttggcgacagcctctccgataccggcaagatgtacagcaagatgcgcggttacctcccctccagccccccctactatgagggccgcttctccaacgggcccgtctggctggagcagctgaccaacgagttcccgggcctgaccatagccaacgaggcggaaggcggaccgaccgccgtggcttacaacaagatctcctggaatcccaagtatcaggtcatcaacaacctggactacgaggtcacccagttcctgcaaaaagacagcttcaagccggacgatctggtgatcctctgggtcggcgccaacgactatctggcctatggctggaacacagagcaggatgccaagcgggtgcgcgacgccatcagcgatgcggccaaccgcatggtgctgaacggcgccaaggagatactgctgttcaacctgccggatctgggccagaacccctcggcccgcagccagaaggtggtcgaggcggccagccatgtctccgcctaccacaaccagctgctgctgaacctggcacgccagctggctcccaccggcatggtgaagctgttcgagatcgacaagcagtttgccgagatgctgcgtgatccgcagaacttcggcctgagcgaccagaggaacgcctgctacggtggcagctatgtatggaagccgtttgcctcccgcagcgccagcaccgacagccagctctccgccttcaacccgcaggagcgcctcgccatcgccggcaacccgctgctggcccaggccgtcgccagccccatggctgcccgcagcgccagcaccctcaactgtgagggcaagatgttctgggatcaggtccaccccaccactgtcgtgcacgccgccctgagcgagcccgccgccaccttcatcgagagccagtacgagttcctcgcccac

SEQ ID NO: 51 - DNA, 1011 bp, Aeromonas salmonicida
atgaaaaaatggtttgtttgtttattggggttgatcgcgctgacagttcaggcagccgacactcgccccgccttctcccggatcgtgatgttcggcgacagcctctccgataccggcaaaatgtacagcaagatgcgcggttacctcccctccagcccgccctactatgagggccgtttctccaacggacccgtctggctggagcagctgaccaagcagttcccgggtctgaccatcgccaacgaagcggaaggcggtgccactgccgtggcttacaacaagatctcctggaatcccaagtatcaggtctacaacaacctggactacgaggtcacccagttcttgcagaaagacagcttcaagccggacgatctggtgatcctctgggtcggtgccaatgactatctggcatatggctggaatacggagcaggatgccaagcgagttcgcgatgccatcagcgatgcggccaaccgcatggtactgaacggtgccaagcagatactgctgttcaacctgccggatctgggccagaacccgtcagcccgcagtcagaaggtggtcgaggcggtcagccatgtctccgcctatcacaacaagctgctgctgaacctggcacgccagctggcccccaccggcatggtaaagctgttcgagatcgacaagcaatttgccgagatgctgcgtgatccgcagaacttcggcctgagcgacgtcgagaacccctgctacgacggcggctatgtgtggaagccgtttgccacccgcagcgtcagcaccgaccgccagctctccgccttcagtccgcaggaacgcctcgccatcgccggcaacccgctgctggcacaggccgttgccagtcctatggcccgccgcagcgccagccccctcaactgtgagggcaagatgttctgggatcaggtacacccgaccactgtcgtgcacgcagccctgagcgagcgcgccgccaccttcatcgagacccagtacgagttcctcgcccacggatga

SEQ ID NO: 52 - DNA, 888 bp, Streptomyces coelicolor
atgccgaagcctgcccttcgccgtgtcatgaccgcgacagtcgccgccgtcggcacgctcgccctcggcctcaccgacgccaccgcccacgccgcgcccgcccaggccactccgaccctggactacgtcgccctcggcgacagctacagcgccggctccggcgtcctgcccgtcgaccccgccaacctgctctgtctgcgctcgacggccaactacccccacgtcatcgcggacacgacgggcgcccgcctcacggacgtcacctgcggcgccgcgcagaccgccgacttcacgcgggcccagtacccgggcgtcgcaccccagttggacgcgctcggcaccggcacggacctggtcacgctcaccatcggcggcaacgacaacagcaccttcatcaacgccatcacggcctgcggcacggcgggtgtcctcagcggcggcaagggcagcccctgcaaggacaggcacggcacctccttcgacgacgagatcgaggccaacacgtaccccgcgctcaaggaggcgctgctcggcgtccgcgccagggctccccacgccagggtggcggctctcggctacccgtggatcaccccggccaccgccgacccgtcctgcttcctgaagctccccctcgccgccggtgacgtgccctacctgcgggccatccaggcacacctcaacgacgcggtccggcgggccgccgaggagaccggagccacctacgtggacttctccggggtgtccgacggccacgacgcctgcgaggcccccggcacccgctggatcgaaccgctgctcttcgggcacagcctcgttcccgtccaccccaacgccctgggcgagcggcgcatggccgagcacacgatggacgtcctcggcctggactga

SEQ ID NO: 53 - DNA, 888 bp, Streptomyces coelicolor
tcagtccaggccgaggacgtccatcgtgtgctcggccatgcgccgctcgcccagggcgttggggtggacgggaacgaggctgtgcccgaagagcagcggttcgatccagcgggtgccgggggcctcgcaggcgtcgtggccgtcggacaccccggagaagtccacgtaggtggctccggtctcctcggcggcccgccggaccgcgtcgttgaggtgtgcctggatggcccgcaggtagggcacgtcaccggcggcgagggggagcttcaggaagcaggacgggtcggcggtggccggggtgatccacgggtagccgagagccgccaccctggcgtggggagccctggcgcggacgccgagcagcgcctccttgagcgcggggtacgtgttggcctcgatctcgtcgtcgaaggaggtgccgtgcctgtccttgcaggggctgcccttgccgccgctgaggacacccgccgtgccgcaggccgtgatggcgttgatgaaggtgctgttgtcgttgccgccgatggtgagcgtgaccaggtccgtgccggtgccgagcgcgtccaactggggtgcgacgcccgggtactgggcccgcgtgaagtcggcggtctgcgcggcgccgcaggtgacgtccgtgaggcgggcgcccgtcgtgtccgcgatgacgtgggggtagttggccgtcgagcgcagacagagcaggttggcggggtcgacgggcaggacgccggagccggcgctgtagctgtcgccgagggcgacgtagtccagggtcggagtggcctgggcgggcgcggcgtgggcggtggcgtcggtgaggccgagggcgagcgtgccgacggcggcgactgtcgcggtcatgacacggcgaagggcaggcttcggcat

SEQ ID NO: 54 - DNA, 717 bp, Saccharomyces cerevisiae
atggattacgagaagtttctgttatttggggattccattactgaatttgcttttaatactaggcccattgaagatggcaaagatcagtatgctcttggagccgcattagtcaacgaatatacgagaaaaatggatattcttcaaagagggttcaaagggtacacttctagatgggcgttgaaaatacttcctgagattttaaagcatgaatccaatattgtcatggccacaatatttttgggtgccaacgatgcatgctcagcaggtccccaaagtgtccccctccccgaatttatcgataatattcgtcaaatggtatctttgatgaagtcttaccatatccgtcctattataataggaccggggctagtagatagagagaagtgggaaaaagaaaaatctgaagaaatagctctcggatacttccgtaccaacgagaactttgccatttattccgatgccttagcaaaactagccaatgaggaaaaagttcccttcgtggctttgaataaggcgtttcaacaggaaggtggtgatgcttggcaacaactgctaacagatggactgcacttttccggaaaagggtacaaaatttttcatgacgaattattgaaggtcattgagacattctacccccaatatcatcccaaaaacatgcagtacaaactgaaagattggagagatgtgctagatgatggatctaacataatgtcttga

SEQ ID NO: 55 - DNA, 1044 bp, Ralstonia sp.
atgaacctgcgtcaatggatgggcgccgccacggctgcccttgccttgggcttggccgcgtgcgggggcggtgggaccgaccagagcggcaatcccaatgtcgccaaggtgcagcgcatggtggtgttcggcgacagcctgagcgatatcggcacctacacccccgtcgcgcaggcggtgggcggcggcaagttcaccaccaacccgggcccgatctgggccgagaccgtggccgcgcaactgggcgtgacgctcacgccggcggtgatgggctacgccacctccgtgcagaattgccccaaggccggctgcttcgactatgcgcagggcggctcgcgcgtgaccgatccgaacggcatcggccacaacggcggcgcgggggcgctgacctacccggttcagcagcagctcgccaacttctacgcggccagcaacaacacattcaacggcaataacgatgtcgtcttcgtgctggccggcagcaacgacattttcttctggaccactgcggcggccaccagcggctccggcgtgacgcccgccattgccacggcccaggtgcagcaggccgcgacggacctggtcggctatgtcaaggacatgatcgccaagggtgcgacgcaggtctacgtgttcaacctgcccgacagcagcctgacgccggacggcgtggcaagcggcacgaccggccaggcgctgctgcacgcgctggtgggcacgttcaacacgacgctgcaaagcgggctggccggcacctcggcgcgcatcatcgacttcaacgcacaactgaccgcggcgatccagaatggcgcctcgttcggcttcgccaacaccagcgcccgggcctgcgacgccaccaagatcaatgccctggtgccgagcgccggcggcagctcgctgttctgctcggccaacacgctggtggcttccggtgcggaccagagctacctgttcgccgacggcgtgcacccgaccacggccggccatcgcctgatcgccagcaacgtgctggcgcgcctgctggcggataacgtcgcgcactga

SEQ ID NO: 56 - DNA, 786 bp, Streptomyces coelicolor
gtgatcgggtcgtacgtggcggtgggggacagcttcaccgagggcgtcggcgaccccggccccgacggggcgttcgtcggctgggccgaccggctcgccgtactgctcgcggaccggcgccccgagggcgacttcacgtacacgaacctcgccgtgcgcggcaggctcctcgaccagatcgtggcggaacaggtcccgcgggtcgtcggactcgcgcccgacctcgtctcgttcgcggcgggcggcaacgacatcatccggcccggcaccgatcccgacgaggtcgccgagcggttcgagctggcggtggccgcgctgaccgccgcggccggaaccgtcctggtgaccaccgggttcgacacccggggggtgcccgtcctcaagcacctgcgcggcaagatcgccacgtacaacgggcacgtccgcgccatcgccgaccgctacggctgcccggtgctcgacctgtggtcgctgcggagcgtccaggaccgcagggcgtgggacgccgaccggctgcacctgtcgccggaggggcacacccgggtggcgctgcgcgcggggcaggccctgggcctgcgcgtcccggccgaccctgaccagccctggccgcccctgccgccgcgcggcacgctcgacgtccggcgcgacgacgtgcactgggcgcgcgagtacctggtgccgtggatcgggcgccggctgcggggcgagtcgtcgggcgaccacgtgacggccaaggggacgctgtcgccggacgccatcaagacgcggatcgccgcggtggcctga

SEQ ID NO: 57 - DNA, 783 bp, Streptomyces coelicolor
atgcagacgaaccccgcgtacaccagtctcgtcgccgtcggcgactccttcaccgagggcatgtcggacctgctgcccgacggctcctaccgtggctgggccgacctcctcgccacccggatggcggcccgctcccccggcttccggtacgccaacctggcggtgcgcgggaagctgatcggacagatcgtcgacgagcaggtggacgtggccgccgccatgggagccgacgtgatcacgctggtcggcgggctcaacgacacgctgcggcccaagtgcgacatggcccgggtgcgggacctgctgacccaggccgtggaacggctcgccccgcactgcgagcagctggtgctgatgcgcagtcccggtcgccagggtccggtgctggagcgcttccggccccgcatggaggccctgttcgccgtgatcgacgacctggccgggcggcacggcgccgtggtcgtcgacctgtacggggcccagtcgctggccgaccctcggatgtgggacgtggaccggctgcacctgaccgccgagggccaccgccgggtcgcggaggcggtgtggcagtcgctcggccacgagcccgaggaccccgagtggcacgcgccgatcccggcgacgccgccgccggggtgggtgacgcgcaggaccgcggacgtccggttcgcccggcagcacctgctgccctggataggccgcaggctgaccgggcgctcgtccggggacggcctgccggccaagcgcccggacctgctgccctacgaggaccccgcacggtga

SEQ ID NO: 58 - DNA, 1365 bp, Streptomyces coelicolor
atgacccggggtcgtgacgggggtgcgggggcgccccccaccaagcaccgtgccctgctcgcggcgatcgtcaccctgatagtggcgatctccgcggccatatacgccggagcgtccgcggacgacggcagcagggaccacgcgctgcaggccggaggccgtctcccacgaggagacgccgcccccgcgtccaccggtgcctgggtgggcgcctgggccaccgcaccggccgcggccgagccgggcaccgagacgaccggcctggcgggccgctccgtgcgcaacgtcgtgcacacctcggtcggcggcaccggcgcgcggatcaccctctcgaacctgtacgggcagtcgccgctgaccgtcacacacgcctcgatcgccctggccgccgggcccgacaccgccgccgcgatcgccgacaccatgcgccggctcaccttcggcggcagcgcccgggtgatcatcccggcgggcggccaggtgatgagcgacaccgcccgcctcgccatcccctacggggcgaacgtcctggtcaccacgtactcccccatcccgtccgggccggtgacctaccatccgcaggcccggcagaccagctacctggccgacggcgaccgcacggcggacgtcaccgccgtcgcgtacaccacccccacgccctactggcgctacctgaccgccctcgacgtgctgagccacgaggccgacggcacggtcgtggcgttcggcgactccatcaccgacggcgcccgctcgcagagcgacgccaaccaccgctggaccgacgtcctcgccgcacgcctgcacgaggcggcgggcgacggccgggacacgccccgctacagcgtcgtcaacgagggcatcagcggcaaccggctcctgaccagcaggccggggcggccggccgacaacccgagcggactgagccggttccagcgggacgtgctggaacgcaccaacgtcaaggccgtcgtcgtcgtcctcggcgtcaacgacgtcctgaacagcccggaactcgccgaccgcgacgccatcctgaccggcctgcgcaccctcgtcgaccgggcgcacgcccggggactgcgggtcgtcggcgccacgatcacgccgttcggcggctacggcggctacaccgaggcccgcgagacgatgcggcaggaggtcaacgaggagatccgctccggccgggtcttcgacacggtcgtcgacttcgacaaggccctgcgcgacccgtacgacccgcgccggatgcgctccgactacgacagcggcgaccacctgcaccccggcgacaaggggtacgcgcgcatgggcgcggtcatcgacctggccgcgctgaagggcgcggcgccggtcaaggcgtag

SEQ ID NO: 59 - DNA, 1023 bp, Streptomyces coelicolor
atgacgagcatgtcgagggcgagggtggcgcggcggatcgcggccggcgcggcgtacggcggcggcggcatcggcctggcgggagcggcggcggtcggtctggtggtggccgaggtgcagctggccagacgcagggtgggggtgggcacgccgacccgggtgccgaacgcgcagggactgtacggcggcaccctgcccacggccggcgacccgccgctgcggctgatgatgctgggcgactccacggccgccgggcagggcgtgcaccgggccgggcagacgccgggcgcgctgctggcgtccgggctcgcggcggtggcggagcggccggtgcggctggggtcggtcgcccagccgggggcgtgctcggacgacctggaccggcaggtggcgctggtgctcgccgagccggaccgggtgcccgacatctgcgtgatcatggtcggcgccaacgacgtcacccaccggatgccggcgacccgctcggtgcggcacctgtcctcggcggtacggcggctgcgcacggccggtgcggaggtggtggtcggcacctgtccggacctgggcacgatcgagcgggtgcggcagccgctgcgctggctggcccggcgggcctcacggcagctcgcggcggcacagaccatcggcgccgtcgagcagggcgggcgcacggtgtcgctgggcgacctgctgggtccggagttcgcgcagaacccgcgggagctcttcggccccgacaactaccacccctccgccgaggggtacgccacggccgcgatggcggtactgccctcggtgtgcgccgcgctcggcctgtggccggccgacgaggagcacccggacgcgctgcgccgcgagggcttcctgccggtggcgcgcgcggcggcggaggcggcgtccgaggcgggtacggaggtcgccgccgccatgcctacggggcctcgggggccctgggcgctgctgaagcgccggagacggcgtcgggtgtcggaggcggaaccgtccagcccgtccggcgtttga

SEQ ID NO: 60 - DNA, 918 bp, Streptomyces coelicolor
atgggtcgagggacggaccagcggacgcggtacggccgtcgccgggcgcgtgtcgcgctcgccgccctgaccgccgccgtcctgggcgtgggcgtggcgggctgcgactccgtgggcggcgactcacccgctccttccggcagcccgtcgaagcggacgaggacggcgcccgcctgggacaccagcccggcgtccgtcgccgccgtgggcgactccatcacgcgcggcttcgacgcctgtgcggtgctgtcggactgcccggaggtgtcgtgggcgaccggcagcagcgcgaaggtcgactcgctggccgtacggctgctggggaaggcggacgcggccgagcacagctggaactacgcggtcaccggggcccggatggcggacctgaccgctcaggtgacgcgggcggcgcagcgcgagccggagctggtggcggtgatggccggggcgaacgacgcgtgccggtccacgacctcggcgatgacgccggtggcggacttccgggcgcagttcgaggaggcgatggccaccctgcgcaagaagctccccaaggcgcaggtgtacgtgtcgagcatcccggacctcaagcggctctggtcccagggccgcaccaacccgctgggcaagcaggtgtggaagctcggcctgtgcccgtcgatgctgggcgacgcggactccctggactcggcggcgaccctgcggcgcaacacggtgcgcgaccgggtggcggactacaacgaggtgctgcgggaggtctgcgcgaaggaccggcggtgccgcagcgacgacggcgcggtgcacgagttccggttcggcacggaccagttgagccactgggactggttccacccgagtgtggacggccaggcccggctggcggagatcgcctaccgcgcggtcaccgcgaagaatccctga

SEQ ID NO: 61 - DNA, 1068 bp, Streptomyces rimosus
ttcatcacaacgatgtcacaacaccggccatccgggtcatccctgatcgtgggaatgggtgacaagccttcccgtgacgaaagggtcctgctacatcagaaatgacagaaatcctgctcagggaggttccatgagactgtcccgacgcgcggccacggcgtccgcgctcctcctcaccccggcgctcgcgctcttcggcgcgagcgccgccgtgtccgcgccgcgaatccaggccaccgactacgtggccctcggcgactcctactcctcgggggtcggcgcgggcagctacgacagcagcagtggctcctgtaagcgcagcaccaagtcctacccggccctgtgggccgcctcgcacaccggtacgcggttcaacttcaccgcctgttcgggcgcccgcacaggagacgtgctggccaagcagctgaccccggtcaactccggcaccgacctggtcagcattaccatcggcggcaacgacgcgggcttcgccgacaccatgaccacctgcaacctccagggcgagagcgcgtgcctggcgcggatcgccaaggcgcgcgcctacatccagcagacgctgcccgcccagctggaccaggtctacgacgccatcgacagccgggcccccgcagcccaggtcgtcgtcctgggctacccgcgcttctacaagctgggcggcagctgcgccgtcggtctctcggagaagtcccgcgcggccatcaacgccgccgccgacgacatcaacgccgtcaccgccaagcgcgccgccgaccacggcttcgccttcggggacgtcaacacgaccttcgccgggcacgagctgtgctccggcgccccctggctgcacagcgtcacccttcccgtggagaactcctaccaccccacggccaacggacagtccaagggctacctgcccgtcctgaactccgccacctgatctcgcggctactccgcccctgacgaagtcccgcccccgggcggggcttcgccgtaggtgcgcgtaccgccgtcgcccgtcgcgccggtggccccgccgtacgtgccgccgcccccggacgcggtcggttc

SEQ ID NO: 62 - DNA, 1008 bp, Aeromonas hydrophila
atgaaaaaatggtttgtgtgtttattgggattggtcgcgctgacagttcaggcagccgacagtcgccccgccttttcccggatcgtgatgttcggcgacagcctctccgataccggcaaaatgtacagcaagatgcgcggttacctcccctccagcccgccctactatgagggccgtttctccaacggacccgtctggctggagcagctgaccaaacagttcccgggtctgaccatcgccaacgaagcggaaggcggtgccactgccgtggcttacaacaagatctcctggaatcccaagtatcaggtcatcaacaacctggactacgaggtcacccagttcttgcagaaagacagcttcaagccggacgatctggtgatcctctgggtcggtgccaatgactatctggcctatggctggaacacggagcaggatgccaagcgggttcgcgatgccatcagcgatgcggccaaccgcatggtactgaacggtgccaagcagatactgctgttcaacctgccggatctgggccagaacccgtcagctcgcagtcagaaggtggtcgaggcggtcagccatgtctccgcctatcacaaccagctgctgctgaacctggcacgccagctggcccccaccggcatggtaaagctgttcgagatcgacaagcaatttgccgagatgctgcgtgatccgcagaacttcggcctgagcgacgtcgagaacccctgctacgacggcggctatgtgtggaagccgtttgccacccgcagcgtcagcaccgaccgccagctctccgccttcagtccgcaggaacgcctcgccatcgccggcaacccgctgctggcacaggccgttgccagtcctatggcccgccgcagcgccagccccctcaactgtgagggcaagatgttctgggatcaggtacacccgaccactgtcgtgcacgcagccctgagcgagcgcgccgccaccttcatcgcgaaccagtacgagttcctcgcccactga

SEQ ID NO: 63 - DNA, 1011 bp, Aeromonas salmonicida subsp. Salmonicida
atgaaaaaatggtttgtttgtttattggggttgatcgcgctgacagttcaggcagccgacactcgccccgccttctcccggatcgtgatgttcggcgacagcctctccgataccggcaaaatgtacagcaagatgcgcggttacctcccctccagcccgccctactatgagggccgtttctccaacggacccgtctggctggagcagctgaccaagcagttcccgggtctgaccatcgccaacgaagcggaaggcggtgccactgccgtggcttacaacaagatctcctggaatcccaagtatcaggtcatcaacaacctggactacgaggtcacccagttcttgcagaaagacagcttcaagccggacgatctggtgatcctctgggtcggtgccaatgactatctggcatatggctggaatacggagcaggatgccaagcgagttcgcgatgccatcagcgatgcggccaaccgcatggtactgaacggtgccaagcagatactgctgttcaacctgccggatctgggccagaacccgtcagcccgcagtcagaaggtggtcgaggcggtcagccatgtctccgcctatcacaacaagctgctgctgaacctggcacgccagctggcccccaccggcatggtaaagctgttcgagatcgacaagcaatttgccgagatgctgcgtgatccgcagaacttcggcctgagcgacgtcgagaacccctgctacgacggcggctatgtgtggaagccgtttgccacccgcagcgtcagcaccgaccgccagctctccgccttcagtccgcaggaacgcctcgccatcgccggcaacccgctgctggcacaggccgttgccagtcctatggcccgccgcagcgccagccccctcaactgtgagggcaagatgttctgggatcaggtacacccgaccactgtcgtgcacgcagccctgagcgagcgcgccgccaccttcatcgagacccagtacgagttcctcgcccacggatga

SEQ ID NO: 64 - DNA, 51 bp, Artificial Sequence
  alpha-amylase terminator sequence
cgggacttaccgaaagaaaccatcaatgatggtttcttttttgttcataaa

SEQ ID NO: 65 - DNA, 59 bp, Artificial Sequence
  alkaline protease terminator sequence
caagactaaagaccgttcgcccgtttttgcaataagcgggcgaatcttacataaaaata

SEQ ID NO: 66 - DNA, 61 bp, Artificial Sequence
  glutamic-acid specific terminator sequence
acggccgttagatgtgacagcccgttccaaaaggaagcgggctgtcttcgtgtattattgt

SEQ ID NO: 67 - DNA, 54 bp, Artificial Sequence
  levanase terminator sequence
tcttttaaaggaaaggctggaatgcccggcattccagccacatgatcatcgttt

SEQ ID NO: 68 - protein, 280 aa, Aeromonas salmonicida
ADTRPAFSRIVMFGDSLSDTGKMYSKMRGYLPSSPPYYEGRFSNGPVWLEQLTKQFPGLTIANEAEGGATAVAYNKISWDPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNKLLLNLARQLAPTGMVKLFEIDKQFAEMLRDPQNFGLSDVENPCYDGGYVWKPFRSASPLNCEGKMFWDQVHPTTVVHAALSERAATFIETQYEFLAHG

SEQ ID NO: 69 - protein, 4 aa, Artificial Sequence
  Sequence motif
  VARIANT (4)..(4): Xaa may be any of the following amino acid residues Leu, Ala, Val, Ile, Phe, Tyr, His, Gln, Thr, Asn, Met or Ser.
GDSX

SEQ ID NO: 70 - protein, 8 aa, Artificial Sequence
  Consensus sequence
MRRSRFLA

SEQ ID NO: 71 - protein, 8 aa, Artificial Sequence
  Consensus sequence
ALILLTLA

SEQ ID NO: 72 - protein, 5 aa, Artificial Sequence
  Consensus sequence
ARAAP

SEQ ID NO: 73 - protein, 11 aa, Artificial Sequence
  Consensus sequence
YVALGDSYSSG

SEQ ID NO: 74 - protein, 5 aa, Artificial Sequence
  Consensus sequence
GAGSY

SEQ ID NO: 75 - protein, 4 aa, Artificial Sequence
  Consensus sequence
SSGD

SEQ ID NO: 76 - protein, 15 aa, Artificial Sequence
  Consensus sequence
RSTKAYPALWAAAHA

SEQ ID NO: 77 - protein, 5 aa, Artificial Sequence
  Consensus sequence
SSFSF

SEQ ID NO: 78 - protein, 12 aa, Artificial Sequence
  Consensus sequence
ACSGARTYDVLA

SEQ ID NO: 79 - protein, 15 aa, Artificial Sequence
  Consensus sequence
LVSITIGGNDAGFAD

SEQ ID NO: 80 - protein, 6 aa, Artificial Sequence
  Consensus sequence
MTTCVL

SEQ ID NO: 81 - protein, 6 aa, Artificial Sequence
  Consensus sequence
SDSACL

SEQ ID NO: 82 - protein, 4 aa, Artificial Sequence
  Consensus sequence
TLPA

SEQ ID NO: 83 - protein, 9 aa, Artificial Sequence
  Consensus sequence
RLDSVYSAI

SEQ ID NO: 84 - protein, 4 aa, Artificial Sequence
  Consensus sequence
TRAP

SEQ ID NO: 85 - protein, 12 aa, Artificial Sequence
  Consensus sequence
ARVVVLGYPRIY

SEQ ID NO: 86 - protein, 4 aa, Artificial Sequence
  Consensus sequence
LGLS

SEQ ID NO: 87 - protein, 11 aa, Artificial Sequence
  Consensus sequence
TKRAAINDAAD

SEQ ID NO: 88 - protein, 12 aa, Artificial Sequence
  Consensus sequence
LNSVIAKRAADH

SEQ ID NO: 89 - protein, 7 aa, Artificial Sequence
  Consensus sequence
GFTFGDV

SEQ ID NO: 90 - protein, 7 aa, Artificial Sequence
  Consensus sequence
GHELCSA

SEQ ID NO: 91 - protein, 9 aa, Artificial Sequence
  Consensus sequence
PWLHSLTLP

SEQ ID NO: 92 - protein, 6 aa, Artificial Sequence
  Consensus sequence
SYHPTA

SEQ ID NO: 93 - protein, 13 aa, Artificial Sequence
  Consensus sequence
GHAAGYLPVLNSI

SEQ ID NO: 94 - protein, 230 aa, Aspergillus aculeatus
TTVYLAGDSTMAKNGGGSGTNGWGEYLASYLSATVVNDAVAGRSARSYTREGRFENIADVVTAGDYVIVEFGHNDGGSLSTDNGRTDCSGTGAEVCYSVYDGVNETILTFPAYLENAAKLFTAKGAKVILSSQTPNNPWETGTFVNSPTRFVEYAELAAEVAGVEYVDHWSYVDSIYETLGNATVNSYFPIDHTHTSPAGAEVVAEAFLKAVVCTGTSLKSVLTTTSFEG

SEQ ID NO: 95 - protein, 184 aa, Escherichia coli
ADTLLILGDSLSAGYRMSASAAWPALLNDKWQSKTSVVNASISGDTSQQGLARLPALLKQHQPRWVLVELGGNDGLRGFQPQQTEQTLRQILQDVKAANAEPLLMQIRLPANYGRRYNEAFSAIYPKLAKEFDVPLLPFFMEEVYLKPQWMQDDGIHPNRDAQPFIADWMAKQLQPLVNHDSLE

SEQ ID NO: 96 - protein, 308 aa, Aeromonas hydrophila
IVMFGDSLSDTGKMYSKMRGYLPSSPPYYEGRFSNGPVWLEQLTNEFPGLTIANEAEGGPTAVAYNKISWNPKYQVINNLDYEVTQFLQKDSFKPDDLVILWVGANDYLAYGWNTEQDAKRVRDAISDAANRMVLNGAKEILLFNLPDLGQNPSARSQKVVEAASHVSAYHNQLLLNLARQLAPTGMVKLFEIDKQFAEMLRDPQNFGLSDQRNACYGGSYVWKPFASRSASTDSQLSAFNPQERLAIAGNPLLAQAVASPMAARSASTLNCEGKMFWDQVHPTTVVHAALSEPAATFIESQYEFLAH

SEQ ID NO: 97 - protein, 232 aa, Aspergillus aculeatus
TTVYLAGDSTMAKNGGGSGTNGWGEYLASYLSATVVNDAVAGRSARSYTREGRFENIADVVTAGDYVIVEFGHNDGGSLSTDNGRTDCSGTGAEVCYSVYDGVNETILTFPAYLENAAKLFTAKGAKVILSSQTPNNPWETGTFVNSPTRFVEYAELAAEVAGVEYVDHWSYVDSIYETLGNATVNSYFPIDHTHTSPAGAEVVAEAFLKAVVCTGTSLKSVLTTTSFEGTC

SEQ ID NO: 98 - protein, 167 aa, Escherichia coli
LLILGDSLSAGYRMSASAAWPALLNDKWQSKTSVVNASISGDTSQQGLARLPALLKQHQPRWVLVELGGNDGLRGFQPQQTEQTLRQILQDVKAANAEPLLMQIRLPANYGRRYNEAFSAIYPKLAKEFDVPLLPFFMEEVYLKPQWMQDDGIHPNRDAQPFIADWM

SEQ ID NO: 99 - protein, 295 aa, Aeromonas hydrophila
IVMFGDSLSDTGKMYSKMRGYLPSSPPYYEGRFSNGPVWLEQLTNEFPGLTIANEAEGGPTAVAYNKISWNPKYQVINNLDYEVTQFLQKDSFKPDDLVILWVGANDYLAYGWNTEQDAKRVRDAISDAANRMVLNGAKEILLFNLPDLGQNPSARSQKVVEAASHVSAYHNQLLLNLARQLAPTGMVKLFEIDKQFAEMLRDPQNFGLSDQRNACYGGSYVWKPFASRSASTDSQLSAFNPQERLAIAGNPLLAQAVASPMAARSASTLNCEGKMFWDQVHPTTVVHAALSEPA

SEQ ID NO: 100 - protein, 50 aa, Artificial Sequence
  Consensus sequence
RPAFSRIVMFGDSLSDTGKMYSKMRGYLPSSPPYYEGRFSNGPVWLEQLT

SEQ ID NO: 101 - protein, 13 aa, Artificial Sequence
  Consensus sequence
FPGLTIANEAEGG

SEQ ID NO: 102 - protein, 79 aa, Artificial Sequence
  Consensus sequence
TAVAYNKISWNPKYQVINNLDYEVTQFLQKDSFKPDDLVILWVGANDYLAYGWNTEQDAKRVRDAISDAANRMVLNGAK

SEQ ID NO: 103 - protein, 23 aa, Artificial Sequence
  Consensus sequence
ILLFNLPDLGQNPSARSQKVVEA

SEQ ID NO: 104 - protein, 8 aa, Artificial Sequence
  Consensus sequence
SHVSAYHN

SEQ ID NO: 105 - protein, 38 aa, Artificial Sequence
  Consensus sequence
LLLNLARQLAPTGMVKLFEIDKQFAEMLRDPQNFGLSD

SEQ ID NO: 106 - protein, 7 aa, Artificial Sequence
  Consensus sequence
YVWKPFA

SEQ ID NO: 107 - protein, 5 aa, Artificial Sequence
  Consensus sequence
QLSAF

SEQ ID NO: 108 - protein, 22 aa, Artificial Sequence
  Consensus sequence
PQERLAIAGNPLLAQAVASPMA

SEQ ID NO: 109 - protein, 4 aa, Artificial Sequence
  Consensus sequence
RSAS

SEQ ID NO: 110 - protein, 24 aa, Artificial Sequence
  Consensus sequence
LNCEGKMFWDQVHPTTVVHAALSE

SEQ ID NO: 111 - protein, 5 aa, Artificial Sequence
  Consensus sequence
AATFI

SEQ ID NO: 112 - protein, 7 aa, Artificial Sequence
  Consensus sequence
QYEFLAH

SEQ ID NO: 113 - DNA, 1225 bp, Artificial Sequence
  XhoI insert containing the LAT-KLM3′ precursor gene
  CDS (101)..(1144)
gcttttcttttggaagaaaatatagggaaaatggtacttgttaaaaattcggaatatttatacaatatcatatgtttcacattgaaaggggaggagaatcatgaaacaacaaaaacggctttacgcccgattgctgacgctgttatttgcgctcatcttcttgctgcctcattctgcagcttcagcagcagatacaagaccggcgtttagccggatcgtcatgtttggagatagcctgagcgatacgggcaaaatgtatagcaaaatgagaggctatcttccgtcaagcccgccgtattatgaaggccgctttagcaatggaccggtctggctggaacaactgacgaaacaatttccgggactgacgatcgctaatgaagcagaaggaggagcaacagcggtcgcctataacaaaatcagctgggacccgaaatatcaggtcatcaacaacctggactatgaagtcacacagtttcttcagaaagacagctttaaaccggatgatctggtcatcctttgggtcggcgccaatgattatctggcgtatggctggaacacagaacaagatgccaaaagagtcagagatgccatcagcgatgccgctaatagaatggtcctgaacggcgccaaacaaatcctgctgtttaacctgccggatctgggacaaaatccgagcgccagaagccaaaaagtcgtcgaagcagtcagccatgtcagcgcctatcataacaaactgctgctgaacctggcaagacaattggcaccgacgggaatggttaaattgtttgaaattgacaaacagtttgccgaaatgctgagagatccgcaaaattttggcctgagcgatgtcgaaaacccgtgctatgatggcggatatgtctggaaaccgtttgccacaagaagcgtcagcacggatagacaactgtcagcgtttagcccgcaagaaagactggcaatcgccggaaatccgcttttggcacaagcagttgcttcaccgatggcaagaagatcagcaagcccgctgaattgcgaaggcaaaatgttttgggatcaggtccatccgacaacagttgtccatgctgccctttcagaaagagcggcgacgtttatcgaaacacagtatgaatttctggcccatggctgagttaacagaggacggatttcctgaaggaaatccgtttttttattttaagcttggagacaaggtaaaggataaaacctcgag

SEQ ID NO: 114 - protein, 347 aa, Artificial Sequence
  Synthetic Construct
MKQQKRLYARLLTLLFALIFLLPHSAASAADTRPAFSRIVMFGDSLSDTGKMYSKMRGYLPSSPPYYEGRFSNGPVWLEQLTKQFPGLTIANEAEGGATAVAYNKISWDPKYQVINNLDYEVTQFLQKDSFKPDDLVILWVGANDYLAYGWNTEQDAKRVRDAISDAANRMVLNGAKQILLFNLPDLGQNPSARSQKVVEAVSHVSAYHNKLLLNLARQLAPTGMVKLFEIDKQFAEMLRDPQNFGLSDVENPCYDGGYVWKPFATRSVSTDRQLSAFSPQERLAIAGNPLLAQAVASPMARRSASPLNCEGKMFWDQVHPTTVVHAALSERAATFIETQYEFLAHG

SEQ ID NO: 115 - protein, 5 aa, Artificial Sequence
  Sequence motif
RRSAS

SEQ ID NO: 116 - protein, 4 aa, Artificial Sequence
  Sequence motif
  misc_feature (2)..(3): Xaa can be any naturally occurring amino acid
DXXH

SEQ ID NO: 117 - DNA, 102 bp, Artificial Sequence
  Primer
ccccgctcgaggcttttcttttggaagaaaatatagggaaaatggtacttgttaaaaattcggaatatttatacaatatcatatgtttcacattgaaagggg

SEQ ID NO: 118 - DNA, 35 bp, Artificial Sequence
  Primer
tggaatctcgaggttttatcctttaccttgtctcc

SEQ ID NO: 119 - DNA, 56 bp, Artificial Sequence
  subtilisin E terminator sequence
gctgacaaataaaaagaagcaggtatggaggaacctgcttctttttactattattg

SEQ ID NO: 120-123 - skipped (4 entries)

SEQ ID NO: 124 - protein, 79 aa, Aeromonas salmonicida
AEMLRDPQNFGLSDVENPCYDGGYVWKPFATRSVSTDRQLSASPQERLAIAGNPLLAQAVASPMARRSASPLNCEGKMF

(19) United States
(12) Patent Application Publication
(10) Pub. No.: US 2012/0231116 A1
(43) Pub. Date: Sep. 13, 2012

(54) METHOD

(75) Inventors: Niels Erik Larsen, Shanghai (CN); Jørn Borch Søe, Orovaenget (DK)

(73) Assignee: DANISCO A/S, DK-1001 COPENHAGEN K (DK)

(21) Appl. No.: 13/510,499

(22) PCT Filed: Nov. 8, 2010
(86) PCT No.: PCT/IB2010/055057

§ 371 Date: May 17, 2012

(30) Foreign Application Priority Data
Nov. 17, 2009 (GB) 0920089.0
Nov. 18, 2009 (US) 61262285

(51) Int. Cl. A23C 9/18

(52) U.S. Cl. 426/35

(57) ABSTRACT

A method of producing powder milk, said method comprising: (a) contacting milk or a fraction thereof with a lipid acyltransferase enzyme; and (b) drying the enzyme treated milk to produce powder milk; is disclosed. Powder milk products produced by the method and use of a lipid acyltransferase in the manufacture of powder milk for improving the rehydration properties, the perceptible sensory difference (smell and/or taste) and the flowability of the powder milk, and for reducing the cholesterol content and/or the free fatty acid content of the powder milk, and for reducing fouling of the equipment used in the manufacture of the powder milk, are also disclosed.

### REFERENCE TO RELATED APPLICATIONS

Reference is made to the following related applications: US 2002-0009518, US 2004-0091574, WO 2004/064537, WO 2004/064987, WO 2005/066347, WO 2005/066351, U.S. Application Ser. No. 60/764,430 filed on 2 Feb. 2006, WO 2006/008508, WO 2008/090395, US 2008-0063783, WO 2009/024862 and PCT/IB2009/054535. Each of these applications and each of the documents cited in each of these applications (“application cited documents”), and each document referenced or cited in the application cited documents, either in the text or during the prosecution of those applications, as well as all arguments in support of patentability advanced during such prosecution, are hereby incorporated herein by reference. Various documents are also cited in this text (“herein cited documents”). Each of the herein cited documents, and each document cited or referenced in the herein cited documents, is hereby incorporated herein by reference.

### FIELD OF THE INVENTION

The present invention relates to a method for the production of powder milk, an enzymatically treated powder milk and uses of an enzyme for the treatment of powder milk to provide new and unexpected technical advantages.

### BACKGROUND TO THE INVENTION

Powder milk (also referred to herein as ‘dried milk’) is a manufactured dairy product made by drying milk. The principal objective of drying is to increase its shelf life and avoid the need for refrigeration, due to the low moisture content. Powder milk and powdered dairy products may comprise dried whole milk, dried skim milk, dried buttermilk, dry whey products and dry dairy blends.

Typically, powder milk is made by spray drying non-fat skim milk, whole milk, buttermilk or whey. Pasteurized milk is first concentrated in an evaporator to about 50% milk solids. The resulting concentrated milk is sprayed into a heated chamber where the water almost instantly evaporates, leaving fine particles of powdered milk solids. The powder particles are separated from the air stream and recovered at the bottom of the dryer while the humid air is moved out of the evaporator.

Alternatively, the milk can be dried by drum drying (also known as roller drying). Milk is applied as a thin film to the surface of a heated drum (typically heated by steam). The evaporated water is drawn off, leaving dried milk solids which form a layer on the drum which is then scraped off. Powdered milk made this way tends to have a ‘cooked’ flavour, due to caramelization caused by greater heat exposure.

Another process used to produce powder milk is freeze drying, which preserves many nutrients in milk, compared to drum drying. However, this method is generally more expensive than drum or spray drying.

Powder milk products and processes used to produce them are described in general terms in “Milk and Dairy Products”, R. Jost, publ, Wiley-VCH, Weinheim, 2007, which is incorporated herein by reference.

WO 2006/066590 describes a method of producing a milk powder using phospholipases, in particular phospholipase A. However, this document does not disclose or suggest that producing milk powder using this enzyme would prevent fouling of the equipment used in the method.

Lipid acyltransferases are known to be advantageous in food applications. Lipid acyltransferases have been found to have significant acyltransferase activity in foodstuffs. This activity has surprising beneficial applications in methods of preparing foodstuffs.

For instance, WO 2004/064537 discloses a method for the in situ production of an emulsifier by use of a lipid acyltransferase and the advantages associated therewith.

WO 2008/090395 teaches the expression of lipid acyltransferases in a (heterologous) host cell and is incorporated herein by reference.

WO 2009/024862 describes a method for manufacturing UHT milk using a lipid acyltransferase and milk produced by the method.

The principal constituents of milk are water, fat, proteins, lactose (milk sugar) and minerals (salts). Milk also contains smaller amounts of other substances such as pigments, enzymes, vitamins, phospholipids (substances with fat-like properties), sterols and gases.

The many lipids of milk, together forming the ‘milk fat’, have a very complicated composition and structure, even more complicated than most other naturally occurring fats. Typically milk fat consists of triglycerides, di- and monoglycerides, fatty acids, sterols, carotenoids and vitamins (A, D, E and K). Other components include phospholipids, lipoproteins, glycerides, cerebrosides, proteins, nucleic acids, enzymes, metals and water.

Phospholipids are the most surface-active class, as they are amphipolar. As the molecular size is relatively large, they tend to form lamellar bilayers. Phospholipids of milk are generally seen in close connection with proteins, especially when located in the membrane(s) of milk fat globules. The main constituent of phospholipids in milk comprise lecithins, which are surface active at moderate hydrophilicity. Thus lecithin can be seen as a suspending and dispersing agent or as an emulsifier for O/W emulsions as well as for W/O emulsions.

Phospholipids comprise 0.8-1.0% of the natural milk fat. The main types of phospholipids/lecithin in milk are phosphatidylcholine and phosphatidylethanolamine.

Sterols are highly insoluble in water, and show very little surface activity. They easily associate with phospholipids. The cholesterol may be considered an unwanted ingredient in milk when considering the nutritional value of milk. Cholesterol comprises 0.3-0.4% of the natural milk fat.

### SUMMARY OF THE INVENTION

Aspects of the present invention are presented in the claims and in the following commentary.

It has surprisingly been found that exposing milk or a fraction thereof to a lipid acyltransferase during production of powder milk results in the powder milk having improved flowability and rehydration properties, and also results in the powder milk having decreased free fatty acid content (compared with powder milk which during its manufacture has been treated with a phospholipase) and decreased cholesterol content.

According to a first aspect of the present invention there is provided a method of producing powder milk, said method comprising:

(a) contacting milk or a fraction thereof with a lipid acyltransferase enzyme; and
(b) drying the enzyme treated milk to produce powder milk.

According to a second aspect of the present invention there is provided powder milk obtained or obtainable by the method of the invention.

According to a third aspect of the present invention there is provided a milk product produced by rehydrating the powder milk of the invention.

According to a fourth aspect of the present invention there is provided a use of a lipid acyltransferase in the manufacture of powder milk for improving the rehydration properties of the powder milk. In one aspect, such improved rehydration properties of the powder milk comprise an improved wettability and/or lowered wetting time.

According to a fifth aspect of the present invention there is provided a use of a lipid acyltransferase in the manufacture of powder milk for improving the perceptible sensory difference of the powder milk. In one aspect the term “perceptible sensory difference” includes improved smell and/or taste, for example a reduced cooked taste and/or aroma and/or a reduced rancidity taste and/or aroma.

According to a sixth aspect of the present invention there is provided a use of a lipid acyltransferase in the manufacture of powder milk for reducing the cholesterol content of the powder milk.

According to a seventh aspect of the present invention there is provided a use of a lipid acyltransferase in the manufacture of powder milk for reducing the free fatty acid content of the powder milk compared with powder milk which during its manufacture has been treated with a phospholipase.

A reduction in cholesterol can be measured by Thin Layer Chromatography (TLC) and/or Gas Liquid Chromatography (GLC).

According to an eighth aspect of the present invention there is provided a use of a lipid acyltransferase in the manufacture of powder milk for improving the flowability of the powder milk.

According to a ninth aspect of the present invention there is provided a use of a lipid acyltransferase in the manufacture of powder milk for reducing fouling of the equipment used in the manufacture of the powder milk.

### DETAILED DESCRIPTION OF PREFERRED EMBODIMENTS

As described above, in one aspect the present invention comprises a method of producing powder milk, comprising: (a) contacting milk or a fraction thereof with a lipid acyltransferase enzyme; and (b) drying the enzyme treated milk to produce powder milk.

### Milk

The term ‘milk’ as used herein may comprise milk from either animal or vegetable origin, and includes whole milk, skim milk, and semi-skim milk.

It is possible to use milk from animal sources such as buffalo, (traditional) cow, sheep, goat etc. either individually or combined. Vegetable milks such as soya milk may also be used, either alone or in combination with the animal milk. When vegetable milks are used in combination with animal milk, the combination typically comprises a low percentage (of vegetable milk) say below 15%, or below 20%, or below 25% v/v. The term milk preferably does not comprise cheese milk and cream.

The term ‘essentially consists’ as used herein, when referring to a product or composition, preferably means that the product or composition, may consist of other products or compositions but only to a maximum concentration of, preferably 10%, such as 5%, such as 3%, such as 2% 1%, or 0.5% or 0.1%.

For the enzyme modification of milk and/or cream for example it may be preferable to use a temperature of less than about 30° C. for example, suitably less than 20° C. for example, suitably less than 10° C. for example. Suitable temperatures of between 1-30° C. may be used, such as between 3-20° C. for example, such as between 1-10° C.

### Incubation

The milk is contacted according to the present invention with a lipid acyltransferase enzyme such that the enzyme is incubated therewith. Suitable lipid acyltransferase enzymes are described in more detail herein.

Suitably, the lipid acyltransferase is contacted with the milk and incubated therewith at a temperature of between about 0° C. and about 70° C. In one embodiment, the lipid acyltransferase is contacted with the milk and incubated therewith at a temperature of between about 20° C. and about 60° C., more preferably between about 30° C. and about 50° C., still more preferably between about 35° C. and about 45° C., and most preferably about 40° C. In another embodiment, the lipid acyltransferase is contacted with the milk and incubated therewith at a temperature of between about 0° C. and about 20° C., more preferably between about 5° C. and about 15° C., and still more preferably between about 5° C. and about 10° C.

Preferably the lipid acyltransferase is contacted with the milk and incubated therewith in a concentration of about 0.01 to about 1 mg enzyme/kg milk, more preferably about 0.01 to about 0.05 mg enzyme/kg milk, even more preferably about 0.01 to about 0.2 mg enzyme/kg milk, still more preferably about 0.01 to about 0.1 mg enzyme/kg milk, yet more preferably about 0.01 to about 0.05 mg enzyme/kg milk, and most preferably about 0.05 mg enzyme/kg milk.

Preferably the incubation time is effective to ensure that there is at least 10% transferase activity, more preferably at least 15%, 20%, 25%, 26%, 28%, 30%, 40%, 50%, 60% or 70% transferase activity.

The transferase activity is measured by the Transferase Assay referred to herein.

Suitably the incubation time may be from 1 minute up to 36 hours, preferably from 2 minutes up to 24 hours, more preferably from 5 minutes up to 18 hours, even preferably from 10 minutes up to 12 hours, and still more preferably from 20 minutes up to 8 hours.

In one embodiment the incubation time may be from about 20 minutes to about 2 hours, preferably from about 30 minutes to about 1 hour, more preferably about 35 minutes to about 45 minutes.

In another embodiment the incubation time may be from about 2 hours to about 36 hours, preferably from about 4 hours to about 24 hours.

Preferably the combination of temperature and the incubation time is effective to ensure that there is at least 5% transferase activity, preferably at least 10% transferase activity, preferably at least 15%, 20%, 25% 26%, 28%, 30%, 40% 50%, 60% or 75% transferase activity.

Suitably, the method may further comprise a step of removing the enzyme and/or denaturing the enzyme.

Suitably the enzyme for use in the present invention may be an immobilised enzyme.

The reaction may take place in any suitable vessel, non-limiting examples of which include a continuous flow reactor.

### Drying

Following treatment with an acyltransferase enzyme as described herein, the treated milk is dried to produce powder milk.

In one embodiment, the enzyme treated milk is dried by spray drying to produce powder milk. Suitable spray drying conditions described in general terms in “Milk and Dairy Products”, R. Jost, publ. Wiley-VCH, Weinheim, 2007, which is incorporated herein by reference.

In this embodiment, the enzyme treated milk is suitably fed into the spray dryer at a temperature ranging from about 20° C. to about 95° C., preferably from about 50° C. to about 95° C., more preferably from about 60° C. to about 80° C. In one alternative embodiment, the enzyme treated milk is suitably fed into the spray dryer at a temperature ranging from 35° C. to 45° C., preferably about 40° C.

In this embodiment, the outlet air temperature of the spray dryer suitably ranges from about 50° C. to about 150° C., preferably from about 70° C. to about 130° C., more preferably from about 90° C. to about 110° C., and most preferably about 100° C.

In this embodiment, the product outlet temperature of the spray dryer suitably ranges from about 20° C. to about 80° C., preferably from about 30° C. to about 70° C., more preferably from about 35° C. to about 45° C., and most preferably about 40° C.

In another embodiment the enzyme treated milk is dried by roller drying (also known as drum drying) to produce powder milk. Suitable roller drying conditions are described in general terms in “Milk and Dairy Products”, R. Jost, publ. Wiley-VCH, Weinheim, 2007, which is incorporated herein by reference.

In this embodiment, the temperature of the drum suitably ranges from about 90° C. to about 150° C., more preferably from about 100° C. to about 130° C.

### ADVANTAGES

A surprising advantage conferred by the present invention is the greatly improved rehydration properties of the powder milk. In one aspect, such improved rehydration properties of the powder milk comprise an improved wettability and/or lowered wetting time. Wettability may be measured in accordance with IDF method 87:1979.

A further advantage conferred by the present invention is an improvement in the perceptible sensory difference of the powder milk. Suitably the perceptible sensory difference of the powder milk may be measured using the “triangle test” taught herein under. In one aspect the “perceptible sensory difference” includes improved smell and/or taste, for example a reduced cooked taste and/or aroma and/or a reduced rancidity taste and/or aroma.

A further advantage of the present invention may be the reduction of fouling of the powder process plant (e.g. of the plant tubes and/or steel surfaces) when using the powder milk treated in accordance with the present invention compared with powder milk which has not been enzymatically treated and/or compared with powder milk which during its manufacture has been treated with a phospholipase (in particular either a phospholipase A1 enzyme classified as E.C. 3.1.1.32 or a phospholipase A2 enzyme classified as EC.3.1.1.4) (rather than the lipid acyltransferase as described herein).

A further advantage of the present invention may be a reduction in free fatty acids in powder milk treated in accordance with the present invention compared with powder milk which during its manufacture has been treated with a phospholipase (in particular either a phospholipase A1 enzyme classified as E.C. 3.1.1.32 or a phospholipase A2 enzyme classified as EC.3.1.1.4) (rather than the lipid acyltransferase as described herein).

A further advantage of the present invention is a reduction in cholesterol content in the powder milk which may have major health benefits.

A further advantage of the present invention is the improved flowability of the powder milk.

Suitably the improvement in the rehydration properties and/or the improvement in the perceptible sensory difference and/or the improvement in smell and/or taste and/or the reduction in cholesterol content and/or the improved flowability of the powder milk and/or reduced fouling of the equipment used in its manufacture means an improvement when the enzymatically treated milk (treated with enzymes in accordance with the present invention) is compared with powder milk which has not been enzymatically treated and/or compared with powder milk which has been treated with a phospholipase (in particular either a phospholipase A1 enzyme classified as E.C. 3.1.1.32 or a phospholipase A2 enzyme classified as EC.3.1.1.4).

Suitably the improvement in the rehydration properties and/or the improvement in the perceptible sensory difference and/or the improvement in smell and/or taste and/or the reduction in cholesterol content and/or the improved flowability of the powder milk and/or reduced fouling of the equipment used in its manufacture may mean an improvement when the enzymatically treated milk (treated with enzymes in accordance with the present invention) is compared with powder milk which has been treated with one or more of the following phospholipases: Phospholipase A1 from Fusarium oxysporum (Lipopan F™) and/or a phospholipase from Fusarium heterosporum and/or a phospholipase A1 from Fusarium venenatum (YieldMax™) and/or a phospholipase from Aspergillus niger and/or a phospholipase A2 from Streptomyces violaceoruber and/or a phospholipase A2 from porcine pancreas and/or a phospholipase A2 from Tuber borchii.

### Host Cell

The host organism can be a prokaryotic or a eukaryotic organism.

In one embodiment of the present invention the lipid acyl transferase according to the present invention in expressed in a host cell, for example a bacterial cells, such as a Bacillus spp, for example a Bacillus licheniformis host cell.

Alternative host cells may be fungi, yeasts or plants for example.

It has been found that the use of a Bacillus licheniformis host cell results in increased expression of a lipid acyltransferase when compared with other organisms, such as Bacillus subtilis.

A lipid acyltransferase from Aeromonas salmonicida has been inserted into a number of conventional expression vectors, designed to be optimal for the expression in Bacillus subtilis, Hansenula polymorpha, Schizosaccharomyces pombe and Aspergillus tubigensis, respectively. Only very low levels were, however, detected in Hansenula polymorpha, Schizosaccharomyces pombe and Aspergillus tubigensis. The expression levels were below 1 μg/ml, and it was not possible to select cells which yielded enough protein to initiate a commercial production (results not shown). In contrast, Bacillus licheniformis was able to produce protein levels, which are attractive for an economically feasible production.

In particular, it has been found that expression in B. licheniformis is approximately 100-times greater than expression in B. subtilis under the control of aprE promoter or is approximately 100-times greater than expression in S. lividans under the control of an A4 promoter and fused to cellulose (results not shown herein).

The host cell may be any Bacillus cell other than B. subtilis. Preferably, said Bacillus host cell being from one of the following species: Bacillus licheniformis; B. alkalophilus; B. amyloliquefaciens; B. circulars; B. clausii; B. coagulans; B. firmus; B. lautus; B. lentus; B. megaterium; B. pumilus or B. stearothermophilus.

The term “host cell”—in relation to the present invention includes any cell that comprises either a nucleotide sequence encoding a lipid acyltransferase as defined herein or an expression vector as defined herein and which is used in the recombinant production of a lipid acyltransferase having the specific properties as defined herein.

Suitably, the host cell may be a protease deficient or protease minus strain and/or an α-amylase deficient or α-amylase minus strain.

The term “heterologous” as used herein means a sequence derived from a separate genetic source or species. A heterologous sequence is a non-host sequence, a modified sequence, a sequence from a different host cell strain, or a homologous sequence from a different chromosomal location of the host cell.

A “homologous” sequence is a sequence that is found in the same genetic source or species i.e. it is naturally occurring in the relevant species of host cell.

The term “recombinant lipid acyltransferase” as used herein means that the lipid acyltransferase has been produced by means of genetic recombination. For instance, the nucleotide sequence encoding the lipid acyltransferase has been inserted into a cloning vector, resulting in a B. licheniformis cell characterised by the presence of the heterologous lipid acyltransferase.

### Regulatory Sequences

In some applications, a lipid acyltransferase sequence for use in the methods and/or uses of the present invention may be obtained by operably linking a nucleotide sequence encoding same to a regulatory sequence which is capable of providing for the expression of the nucleotide sequence, such as by the chosen host cell (such as a B. licheniformis cell).

By way of example, a vector comprising the nucleotide sequence of the present invention operably linked to such a regulatory sequence, i.e. the vector is an expression vector, may be used.

The term “operably linked” refers to a juxtaposition wherein the components described are in a relationship permitting them to function in their intended manner. A regulatory sequence “operably linked” to a coding sequence is ligated in such a way that expression of the coding sequence is achieved under conditions compatible with the control sequences.

The term “regulatory sequences” includes promoters and enhancers and other expression regulation signals.

The term “promoter” is used in the normal sense of the art, e.g. an RNA polymerase binding site.

Enhanced expression of the nucleotide sequence encoding the enzyme having the specific properties as defined herein may also be achieved by the selection of regulatory regions, e.g. promoter, secretion leader and terminator regions that are not regulatory regions for the nucleotide sequence encoding the enzyme in nature.

Suitably, the nucleotide sequence of the present invention may be operably linked to at least a promoter.

Suitably, the nucleotide sequence encoding a lipid acyltransferase may be operably linked to at a nucleotide sequence encoding a terminator sequence. Examples of suitable terminator sequences for use in any one of the vectors, host cells, methods and/or uses of the present invention include: an α-amylase terminator sequence (for instance, CGGGACTTACCGAAAGAAACCATCAATGATGGTTTCTTTTTTGTTCATAAA—SEQ ID No. 64), an alkaline protease terminator sequence (for instance, CAAGACTAAAGACCGTTCGCCCGTTTTTGCAATAAGCGGGCGAATCTTACATAAAA ATA—SEQ ID No. 65), a glutamic-acid specific terminator sequence (for instance, ACGGCCGTTAGATGTGACAGCCCGTTCCAAAAGGAAGCGGGCTGTCTTCGTGTAT TATTGT—SEQ ID No. 66), a levanase terminator sequence (for instance, TCTTTTAAAGGAAAGGCTGGAATGCCCGGCATTCCAGCCACATGATCATCGTTT—SEQ ID No. 67) and a subtilisin E terminator sequence (for instance, GCTGACAAATAAAAAGAAGCAGGTATGGAGGAACCTGCTTCTTTTTACTATTATTG—SEQ ID No. 119). Suitably, the nucleotide sequence encoding a lipid acyltransferase may be operably linked to an α-amylase terminator, such as a B. licheniformis α-amylase terminator.

### Promoter

The promoter sequence to be used in accordance with the present invention may be heterologous or homologous to the sequence encoding a lipid acyltransferase.

The promoter sequence may be any promoter sequence capable of directing expression of a lipid acyltransferase in the host cell of choice.

Suitably, the promoter sequence may be homologous to a Bacillus species, for example B. licheniformis. Preferably, the promoter sequence is homologous to the host cell of choice.

Suitably the promoter sequence may be homologous to the host cell. “Homologous to the host cell” means originating within the host organism; i.e. a promoter sequence which is found naturally in the host organism.

Suitably, the promoter sequence may be selected from the group consisting of a nucleotide sequence encoding: an α-amylase promoter, a protease promoter, a subtilisin promoter, a glutamic acid-specific protease promoter and a levansucrase promoter.

Suitably the promoter sequence may be a nucleotide sequence encoding: the LAT (e.g. the alpha-amylase promoter from B. licheniformis, also known as AmyL), AprL (e.g. subtilisin Carlsberg promoter), EndoGluC (e.g. the glutamic-acid specific promoter from B. licheniformis), AmyQ (e.g. the alpha amylase promoter from B. amyloliquefaciens alpha-amylase promoter) and SacB (e.g. the B. subtilis levansucrase promoter).

Other examples of promoters suitable for directing the transcription of a nucleic acid sequence in the methods of the present invention include: the promoter of the Bacillus lentus alkaline protease gene (aprH); the promoter of the Bacillus subtilis alpha-amylase gene (amyE); the promoter of the Bacillus stearothermophilus maltogenic amylase gene (amyM); the promoter of the Bacillus licheniformis penicillinase gene (penP); the promoters of the Bacillus subtilis xylA and xylB genes; and/or the promoter of the Bacillus thuringiensis subsp. tenebrionis CryIIIA gene.

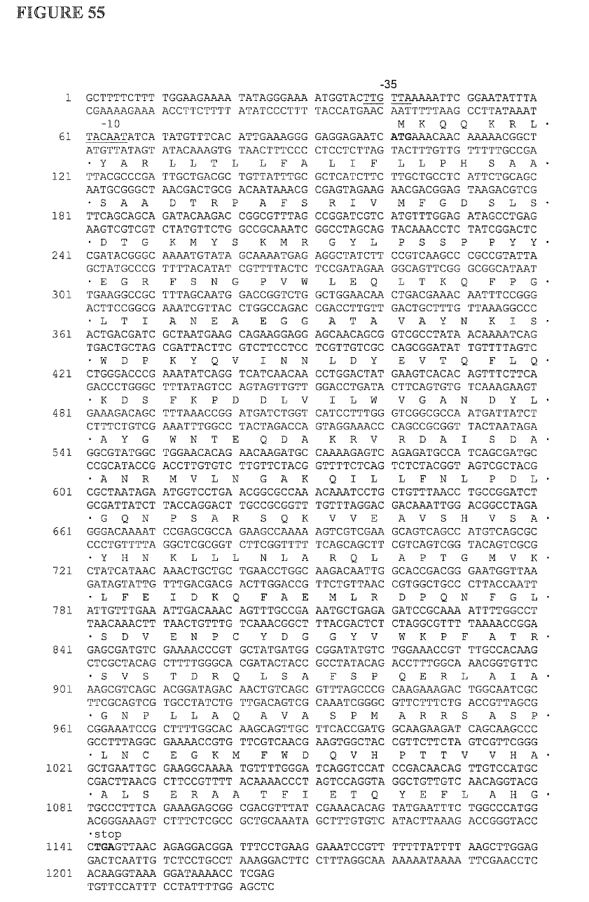

In a preferred embodiment, the promoter sequence is an α-amylase promoter (such as a Bacillus licheniformis α-amylase promoter). Preferably, the promoter sequence comprises the −35 to −10 sequence of the B. licheniformis α-amylase promoter—see FIGS. 53 and 55.

The “−35 to −10 sequence” describes the position relative to the transcription start site. Both the “−35” and the “−10” are boxes, i.e. a number of nucleotides, each comprising 6 nucleotides and these boxes are separated by 17 nucleotides. These 17 nucleotides are often referred to as a “spacer”. This is illustrated in FIG. 55, where the −35 and the −10 boxes are underlined. For the avoidance of doubt, where “−35 to −10 sequence” is used herein it refers to a sequence from the start of the −35 box to the end of the −10 box i.e. including both the −35 box, the 17 nucleotide long spacer and the −10 box.

### Signal Peptide

The lipid acyltransferase produced by a host cell by expression of the nucleotide sequence encoding the lipid acyltransferase may be secreted or may be contained intracellularly depending on the sequence and/or the vector used.

A signal sequence may be used to direct secretion of the coding sequences through a particular cell membrane. The signal sequences may be natural or foreign to the lipid acyltransferase coding sequence. For instance, the signal peptide coding sequence may be obtained form an amylase or protease gene from a Bacillus species, preferably from Bacillus licheniformis.

Suitable signal peptide coding sequences may be obtained from one or more of the following genes: maltogenic α-amylase gene, subtilisin gene, beta-lactamase gene, neutral protease gene, prsA gene, and/or acyltransferase gene.

Preferably, the signal peptide is a signal peptide of B. licheniformis α-amylase, Aeromonas acyltransferase (for instance, mkkwfvcllglialtvqa—SEQ ID No. 21), B. subtilis subtilisin (for instance, mrskklwisllfaltliftmafsnmsaqa—SEQ ID No. 22) or B. licheniformis subtilisin (for instance, mmrkksfwfgmltafmlvftmefsdsasa—SEQ ID No. 23). Suitably, the signal peptide may be the signal peptide of B. licheniformis α-amylase.

However, any signal peptide coding sequence capable of directing the expressed lipid acyltransferase into the secretory pathway of a Bacillus host cell (preferably a B. licheniformis host cell) of choice may be used.

In some embodiments of the present invention, a nucleotide sequence encoding a signal peptide may be operably linked to a nucleotide sequence encoding a lipid acyltransferase of choice.

The lipid acyltransferase of choice may be expressed in a host cell as defined herein as a fusion protein.

### Expression Vector

The term “expression vector” means a construct capable of in vivo or in vitro expression.

Preferably, the expression vector is incorporated in the genome of the organism, such as a B. licheniformis host. The term “incorporated” preferably covers stable incorporation into the genome.

The nucleotide sequence encoding a lipid acyltransferase as defined herein may be present in a vector, in which the nucleotide sequence is operably linked to regulatory sequences such that the regulatory sequences are capable of providing the expression of the nucleotide sequence by a suitable host organism (such as B. licheniformis), i.e. the vector is an expression vector.

The vectors of the present invention may be transformed into a suitable host cell as described above to provide for expression of a polypeptide having lipid acyltransferase activity as defined herein.

The choice of vector, e.g. plasmid, cosmid, virus or phage vector, genomic insert, will often depend on the host cell into which it is to be introduced. The present invention may cover other forms of expression vectors which serve equivalent functions and which are, or become, known in the art.

Once transformed into the host cell of choice, the vector may replicate and function independently of the host cell's genome, or may integrate into the genome itself.

The vectors may contain one or more selectable marker genes—such as a gene which confers antibiotic resistance e.g. ampicillin, kanamycin, chloramphenicol or tetracycline resistance. Alternatively, the selection may be accomplished by co-transformation (as described in WO 91/17243).

Vectors may be used in vitro, for example for the production of RNA or used to transfect or transform a host cell.

The vector may further comprise a nucleotide sequence enabling the vector to replicate in the host cell in question. Examples of such sequences are the origins of replication of plasmids pUC19, pACYCI77, pUB110, pE194, pAMB1 and pIJ702.

### Lipid Acyltransferase

The nucleotide sequence encoding a lipid acyl transferase for use in any one of the methods and/or uses of the present invention may encode a natural lipid acyl transferase or a variant lipid acyl transferase.

The lipid acyl transferase for use in any one of the methods and/or uses of the present invention may be a natural lipid acyl transferase or a variant lipid acyl transferase.

For instance, the nucleotide sequence encoding a lipid acyl transferase for use in the present invention may be one as described in WO 2004/064537, WO 2004/064987, WO 2005/066347, WO 2006/008508, WO 2009/024862 or PCT/IB2009/054535. These documents are incorporated herein by reference.

The term “lipid acyl transferase” as used herein preferably means an enzyme that has acyltransferase activity (generally classified as E.C. 2.3.1.x, for example 2.3.1.43), whereby the enzyme is capable of transferring an acyl group from a lipid to one or more acceptor substrates, such as one or more of the following: a sterol; a stanol; a carbohydrate; a protein; a protein subunit; a sugar alcohol, such as ascorbic acid and/or glycerol—preferably glycerol and/or a sterol, such as cholesterol.

Preferably, the lipid acyl transferase for use in any one of the methods and/or uses of the present invention is a lipid acyltransferase that is capable of transferring an acyl group from a phospholipid (as defined herein) to a sugar alcohol, such as ascorbic acid and/or glycerol and/or a sterol, preferably glycerol or a sterol, most preferably a sterol (e.g. cholesterol).

For some aspects the “acyl acceptor” according to the present invention may be any compound comprising a hydroxy group (—OH), such as for example, polyvalent alcohols, including glycerol; sterols; stanols; carbohydrates; hydroxy acids including fruit acids, citric acid, tartaric acid, lactic acid and ascorbic acid; proteins or a sub-unit thereof, such as amino acids, protein hydrolysates and peptides (partly hydrolysed protein) for example; and mixtures and derivatives thereof. Preferably, the “acyl acceptor” according to the present invention is not water. Preferably, the “acyl acceptor” according to the present invention is a sugar alcohol, such as a polyol, most preferably glycerol. For the purpose of this invention ascorbic acid is also considered a sugar-alcohol.

The acyl acceptor is preferably not a monoglyceride.

The acyl acceptor is preferably not a diglyceride.

In one aspect, the lipid acyltransferase for use in any one of the methods and/or uses of the present invention is a lipid acyltransferase that may, as well as being able to transfer an acyl group from a lipid to glycerol, additionally be able to transfer the acyl group from a lipid to one or more of the following: a carbohydrate, a protein, a protein subunit, sterol and/or a stanol, preferably it is capable of transferring to both a sugar alcohol, such as ascorbic acid and/or glycerol, most preferably a sterol such as cholesterol, and/or plant sterols/stanols.

In some aspects, the lipid acyltransferase for use in any one of the methods and/or uses of the present invention is a lipid acyltransferase that is capable of esterifying at least about 10%, more preferably at least about 20%, 30%, 40%, 50%, 60% or 70% of the acyl acceptor.

In preferred aspects, the lipid acyltransferase for use in any one of the methods and/or uses of the present invention is a lipid acyltransferase that is capable of esterifying at least about 10%, more preferably at least about 20%, 30%, 40%, 50%, 60% or 70% of cholesterol present in the starting milk.

Preferably, the lipid substrate upon which the lipid acyltransferase acts is one or more of the following lipids: a phospholipid, such as a lecithin, e.g. phosphatidylcholine and/or phophatidylethanolamine.

This lipid substrate may be referred to herein as the “lipid acyl donor”. The term lecithin as used herein encompasses phosphatidylcholine, phosphatidylethanolamine, phosphatidylinositol, phosphatidylserine and phosphatidylglycerol.

For some aspects, preferably the lipid acyl transferase for use in any one of the methods and/or uses of the present invention is a lipid acyltransferase that is incapable, or substantially incapable, of acting on a triglyceride and/or a 1-monoglyceride and/or 2-monoglyceride.

For some aspects, preferably the lipid acyl transferase for use in any one of the methods and/or uses of the present invention is a lipid acyltransferase that does not exhibit triacylglycerol lipase activity (E.C. 3.1.1.3) or does not exhibit significant triacylglycerol lipase activity (E.C. 3.1.1.3).

Triaclgycerol lipase activity based on tributyrin is measured according to Food Chemical Codex, 4^{th} Edition, National Academy Press, 1996, p 803, with the modifications that the sample is dissolved in deionized water instead of glycine buffer, and the pH stat set point is 5.5 instead of 7. This reference is incorporated herein by reference. 1 Lipase Unit (LIPU) is defined as the quantity of enzyme which can liberate 1 μmol butyric acid per minute under these assay conditions.

The lipid acyl transferase for use in any one of the methods and/or uses of the present invention may be a lipid acyltransferase which is substantially incapable of acting on a triglyceride may have a LIPU of less than 5/kg milk, more preferably a LIPU of less than 0.25/kg milk, and most preferably a LIPU of less than 0.05/kg milk.

Suitably, the lipid acyltransferase for use in any one of the methods and/or uses of the present invention is a lipid acyltransferase that may exhibit one or more of the following phospholipase activities: phospholipase A2 activity (E.C. 3.1.1.4) and/or phospholipase A1 activity (E.C. 3.1.1.32). The lipid acyl transferase may also have phospholipase B activity (E.C 3.1.1.5).

Suitably, for some aspects the lipid acyltransferase may be capable of transferring an acyl group from a phospholipid to a sugar alcohol, preferably glycerol and/or ascorbic acid.

Suitably, for some aspects the lipid acyltransferase may be capable of transferring an acyl group from a phospholipid to a stanol and/or sterol, preferably cholesterol.

For some aspects, preferably the lipid acyltransferase for use any one of the methods and/or uses of the present invention encodes a lipid acyltransferase that is capable of transferring an acyl group from a phospholipid to a sterol and/or a stanol to form at least a sterol ester and/or a stanol ester.

The lipid acyltransferase may be capable of transferring an acyl group from a lipid to a polyol such as glycerol, and/or a sterol such as cholesterol or plant sterol/stanols. Thus, in one embodiment the “acyl acceptor” according to the present invention may be glycerol and/or cholesterol or plant sterol/stanols.

In some aspects, the lipid acyltransferase for use in any one of the methods and/or uses of the present invention may comprise a GDSx motif and/or a GANDY motif.

Preferably, the lipid acyltransferase enzyme is characterised as an enzyme which possesses acyltransferase activity and which comprises the amino acid sequence motif GDSX, wherein X is one or more of the following amino acid residues L, A, V, I, F, Y, H, Q, T, N, M or S.

Suitably, the nucleotide sequence encoding a lipid acyltransferase or lipid acyltransferase for use in any one of the methods and/or uses of the present invention may be obtainable, preferably obtained, from an organism from one or more of the following genera: Aeromonas, Streptomyces, Saccharomyces, Lactococcus, Mycobacterium, Streptococcus, Lactobacillus, Desulfitobacterium, Bacillus, Campylobacter, Vibrionaceae, Xylella, Sulfolobus, Aspergillus, Schizosaccharomyces, Listeria, Neisseria, Mesorhizobium, Ralstonia, Xanthomonas and Candida. Preferably, the lipid acyltransferase is obtainable, preferably obtained, from an organism from the genus Aeromonas.

In some aspects of the present invention, the nucleotide sequence encoding a lipid acyltransferase for use in any one of the methods and/or uses of the present invention encodes a lipid acyltransferase that comprises an aspartic acid residue at a position corresponding to N-80 in the amino acid sequence of the Aeromonas hydrophila lipid acyltransferase shown as SEQ ID No. 34.

In some aspects of the present invention, the lipid acyltransferase for use in any one of the methods and/or uses of the present invention is a lipid acyltransferase that comprises an aspartic acid residue at a position corresponding to N-80 in the amino acid sequence of the Aeromonas hydrophila lipid acyltransferase shown as SEQ ID No. 34.

In addition or in the alternative, the nucleotide sequence encoding a lipid acyltransferase for use in any one of the methods and/or uses of the present invention encodes a lipid acyltransferase that may comprise the amino acid sequence shown as SEQ ID No. 16, or an amino acid sequence which has 75% or more homology thereto. Suitably, the nucleotide sequence encoding a lipid acyltransferase encodes a lipid acyltransferase that may comprise the amino acid sequence shown as SEQ ID No. 16.

In addition or in the alternative, the nucleotide sequence encoding a lipid acyltransferase for use in any one of the methods and/or uses of the present invention encodes a lipid acyltransferase that may comprise the amino acid sequence shown as SEQ ID No. 68, or an amino acid sequence which has 75% or more homology thereto. Suitably, the nucleotide sequence encoding a lipid acyltransferase encodes a lipid acyltransferase that may comprise the amino acid sequence shown as SEQ ID No. 68.

In one embodiment the lipid acyltransferase for use in any on of the methods and/or uses of the present invention has an amino acid sequence shown in SEQ ID No. 16 or SEQ ID No. 68, or has an amino acid sequence which has at least 75% identity therewith, preferably at least 80%, preferably at least 85%, preferably at least 95%, preferably at least 98% identity therewith.

Preferably, the lipid acyltransferase enzyme may be characterised using the following criteria:
the enzyme possesses acyl transferase activity which may be defined as ester transfer activity whereby the acyl part of an original ester bond of a lipid acyl donor is transferred to an acyl acceptor, preferably glycerol or cholesterol, to form a new ester; and
the enzyme comprises the amino acid sequence motif GDSX, wherein X is one or more of the following amino acid residues L, A, V, I, F, Y, H, Q, T, N, M or S.

Preferably, X of the GDSX motif is L or Y. More preferably, X of the GDSX motif is L. Thus, preferably the enzyme according to the present invention comprises the amino acid sequence motif GDSL.

The GDSX motif is comprised of four conserved amino acids. Preferably, the serine within the motif is a catalytic serine of the lipid acyl transferase enzyme. Suitably, the serine of the GDSX motif may be in a position corresponding to Ser-16 in Aeromonas hydrophila lipid acyltransferase enzyme taught in Brumlik & Buckley (Journal of Bacteriology April 1996, Vol. 178, No. 7, p 2060-2064).

To determine if a protein has the GDSX motif according to the present invention, the sequence is preferably compared with the hidden markov model profiles (HMM profiles) of the pfam database in accordance with the procedures taught in WO 2004/064537 or WO 2004/064987, incorporated herein by reference.

Preferably the lipid acyl transferase enzyme can be aligned using the Pfam00657 consensus sequence (for a full explanation see WO 2004/064537 or WO 2004/064987).

Preferably, a positive match with the hidden markov model profile (HMM profile) of the pfam00657 domain family indicates the presence of the GDSL or GDSX domain according to the present invention.

Preferably when aligned with the Pfam00657 consensus sequence the lipid acyltransferase for use in the methods or uses of the invention may have at least one, preferably more than one, preferably more than two, of the following, a GDSx block, a GANDY block, a HPT block. Suitably, the lipid acyltransferase may have a GDSx block and a GANDY block. Alternatively, the enzyme may have a GDSx block and a HPT block. Preferably the enzyme comprises at least a GDSx block. See WO 2004/064537 or WO 2004/064987 for further details.

Preferably, residues of the GANDY motif are selected from GANDY, GGNDA, GGNDL, most preferably GANDY.

Preferably, when aligned with the Pfam00657 consensus sequence the enzyme for use in the methods or uses of the invention have at least one, preferably more than one, preferably more than two, preferably more than three, preferably more than four, preferably more than five, preferably more than six, preferably more than seven, preferably more than eight, preferably more than nine, preferably more than ten, preferably more than eleven, preferably more than twelve, preferably more than thirteen, preferably more than fourteen, of the following amino acid residues when compared to the reference A. hydrophilia polypeptide sequence, namely SEQ ID No. 1: 28His, 29His, 30His, 31His, 32Gly, 33Asp, 34Ser, 35His, 130His, 131Gly, 132His, 133Asn, 134Asp, 135His, 309His.

The pfam00657 GDSX domain is a unique identifier which distinguishes proteins possessing this domain from other enzymes.

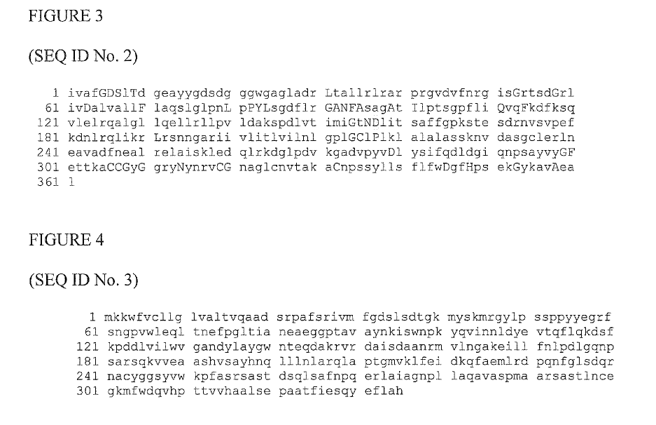

The pfam00657 consensus sequence is presented in FIG. 3 as SEQ ID No. 2. This is derived from the identification of the pfam family 00657, database version 6, which may also be referred to as pfam00657.6 herein.

The consensus sequence may be updated by using further releases of the pfam database (for example see WO 2004/064537 or WO 2004/064987).

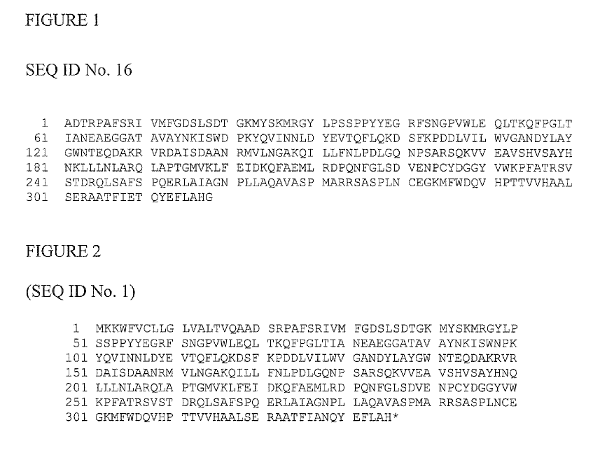

In one embodiment, the lipid acyl transferase enzyme for use in any one of the methods and/or uses of the present invention is a lipid acyltransferase that may be characterised using the following criteria:
(i) the enzyme possesses acyl transferase activity which may be defined as ester transfer activity whereby the acyl part of an original ester bond of a lipid acyl donor is transferred to acyl acceptor, preferably glycerol or cholesterol, to form a new ester, preferably monoglyceride or cholesterol ester respectfully;
(ii) the enzyme comprises the amino acid sequence motif GDSX, wherein X is one or more of the following amino acid residues L, A, V, I, F, Y, H, Q, T, N, M or S;
(iii) the enzyme comprises His-309 or comprises a histidine residue at a position corresponding to His-309 in the Aeromonas hydrophila lipid acyltransferase enzyme shown in FIGS. 2 and 4 (SEQ ID No. 1 or SEQ ID No. 3).

Preferably, the amino acid residue of the GDSX motif is L.

In SEQ ID No. 3 or SEQ ID No. 1 the first 18 amino acid residues form a signal sequence. His-309 of the full length sequence, that is the protein including the signal sequence, equates to His-291 of the mature part of the protein, i.e. the sequence without the signal sequence.

In one embodiment, the lipid acyl transferase enzyme for use any one of the methods and uses of the present invention is a lipid acyltransferase that comprises the following catalytic triad: Ser-34, Asp-306 and His-309 or comprises a serine residue, an aspartic acid residue and a histidine residue, respectively, at positions corresponding to Ser-34, Asp-306 and His-309 in the Aeromonas hydrophila lipid acyl transferase enzyme shown in FIG. 4 (SEQ ID No. 3) or FIG. 2 (SEQ ID No. 1). As stated above, in the sequence shown in SEQ ID No. 3 or SEQ ID No. 1 the first 18 amino acid residues form a signal sequence. Ser-34, Asp-306 and His-309 of the full length sequence, that is the protein including the signal sequence, equate to Ser-16, Asp-288 and His-291 of the mature part of the protein, i.e. the sequence without the signal sequence. In the pfam00657 consensus sequence, as given in FIG. 3 (SEQ ID No. 2) the active site residues correspond to Ser-7, Asp-345 and His-348.

In one embodiment, the lipid acyl transferase enzyme for use in any one of the methods and/or uses of the present invention is a lipid acyl transferase that may be characterised using the following criteria:
the enzyme possesses acyl transferase activity which may be defined as ester transfer activity whereby the acyl part of an original ester bond of a first lipid acyl donor is transferred to an acyl acceptor to form a new ester; and
the enzyme comprises at least Gly-32, Asp-33, Ser-34, Asp-134 and His-309 or comprises glycine, aspartic acid, serine, aspartic acid and histidine residues at positions corresponding to Gly-32, Asp-33, Ser-34, Asp-306 and His-309, respectively, in the Aeromonas hydrophila lipid acyltransferase enzyme shown in SEQ ID No. 3 or SEQ ID No. 1.

Suitably, the lipid acyltransferase enzyme for use in any one of the methods and/or uses of the present invention may be encoded by one of the following nucleotide sequences:

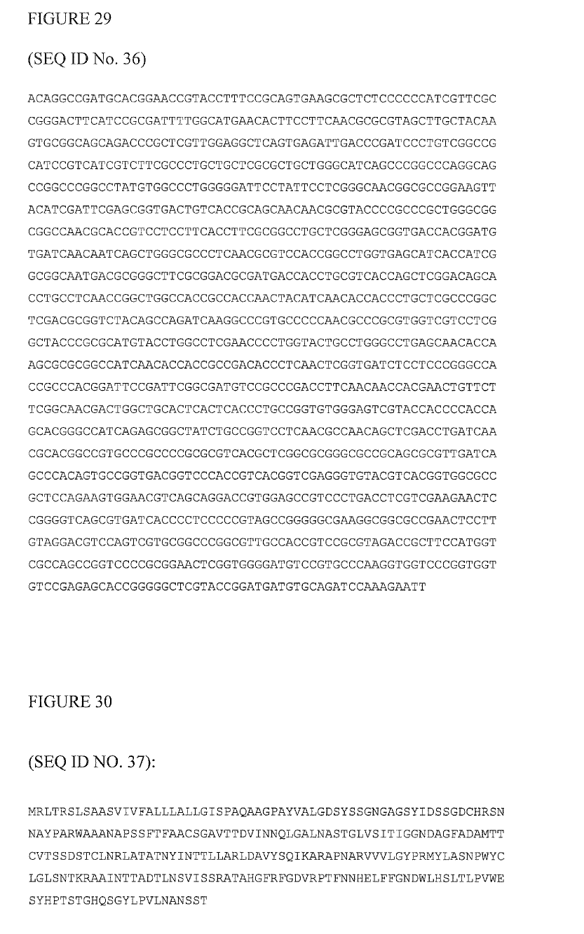

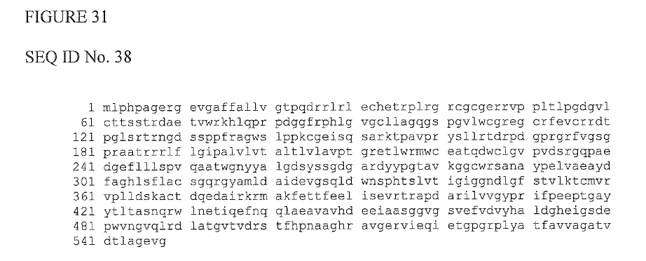

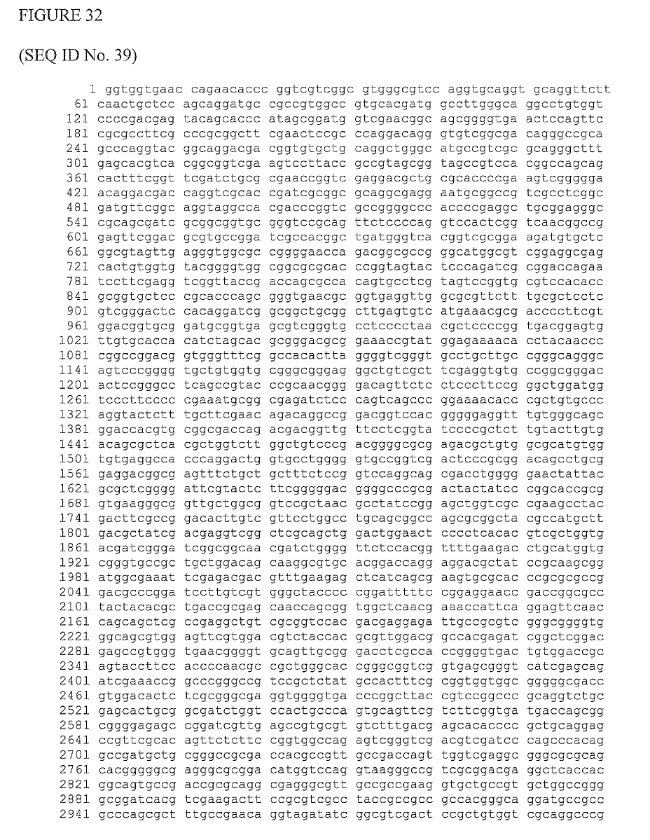

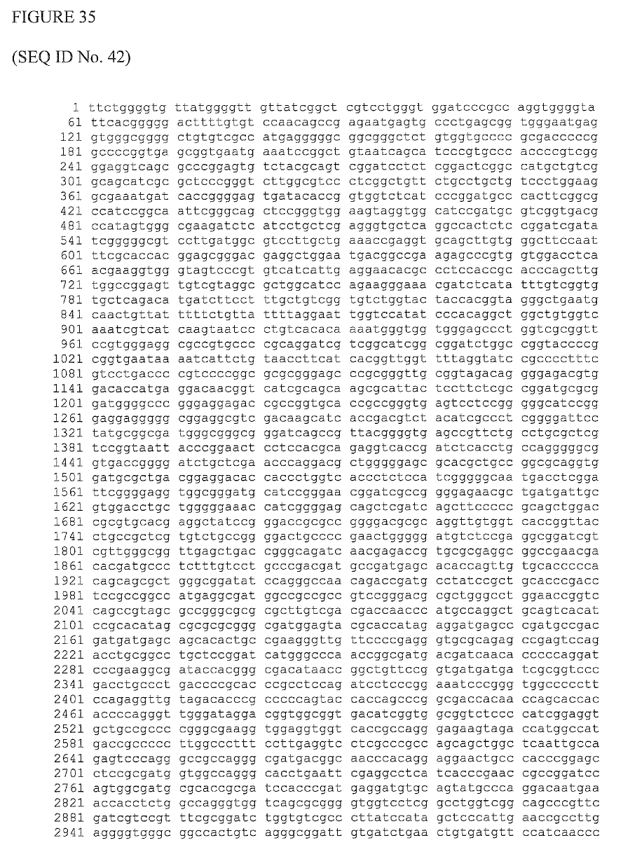

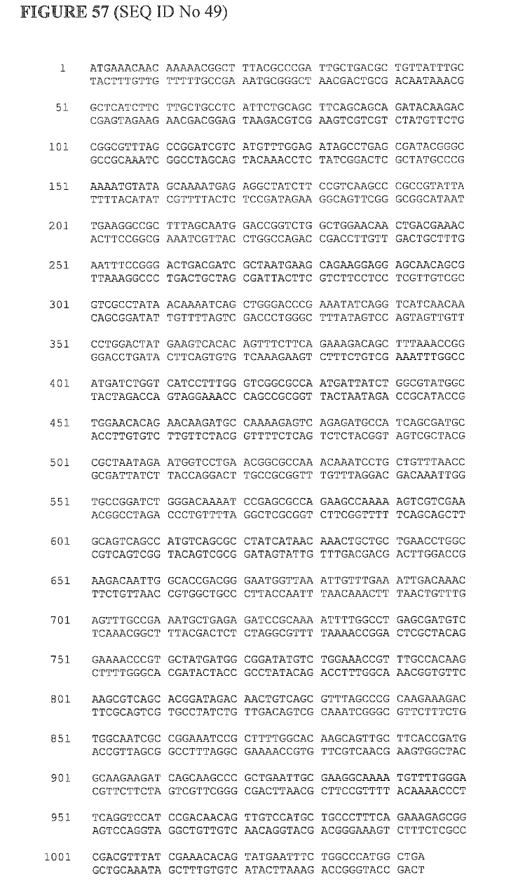

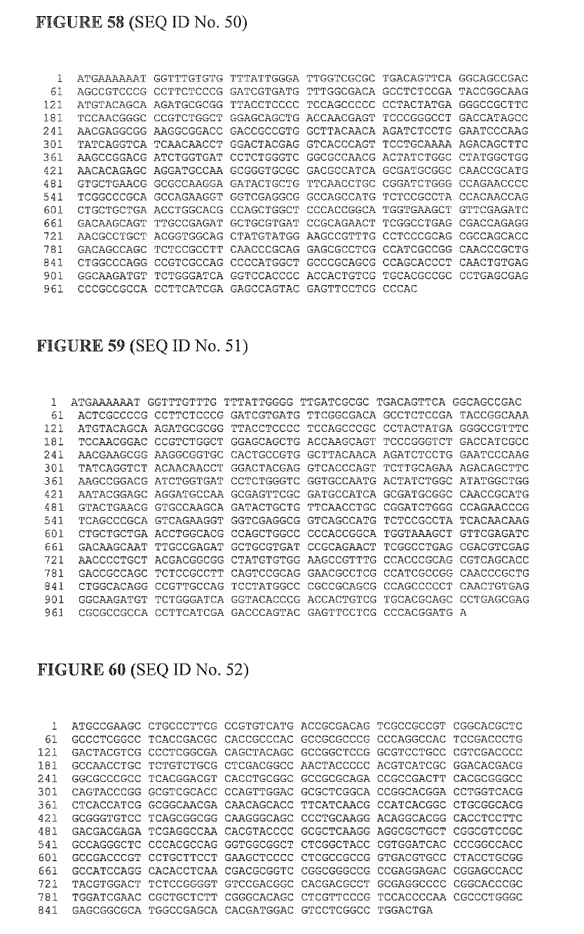

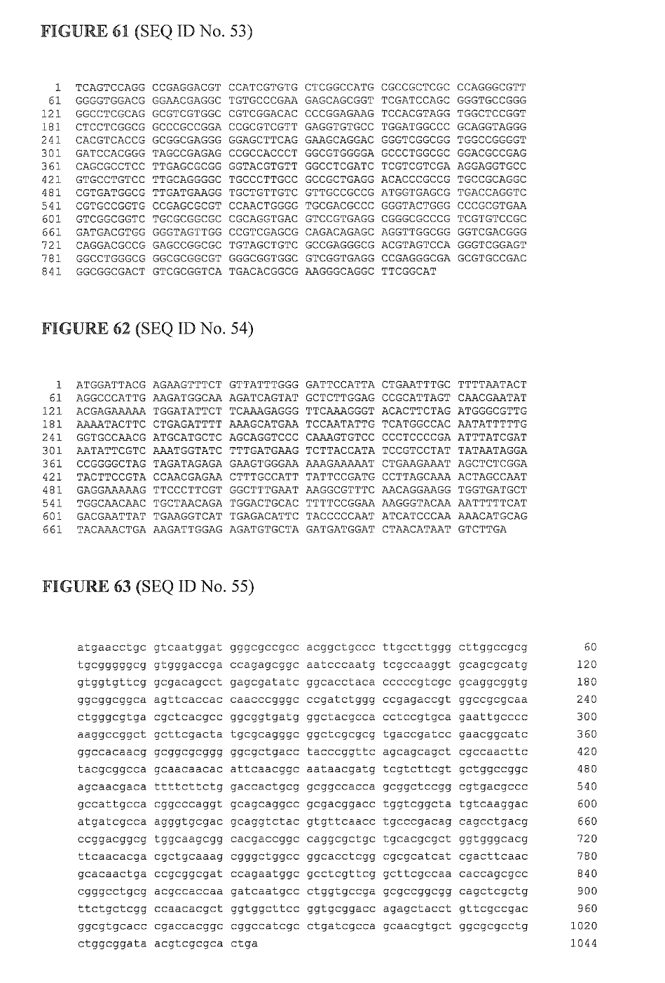

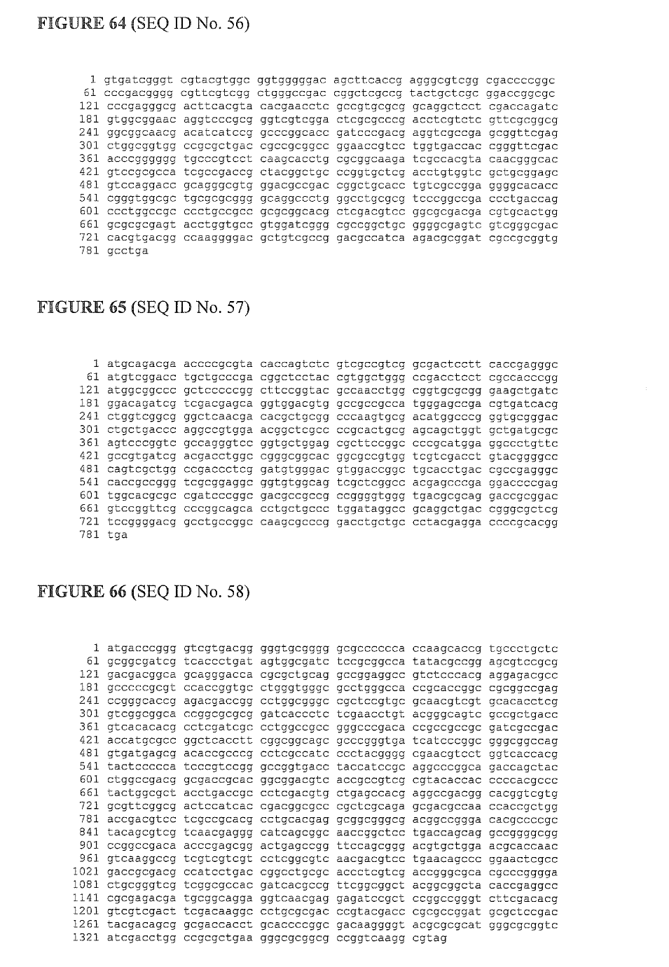

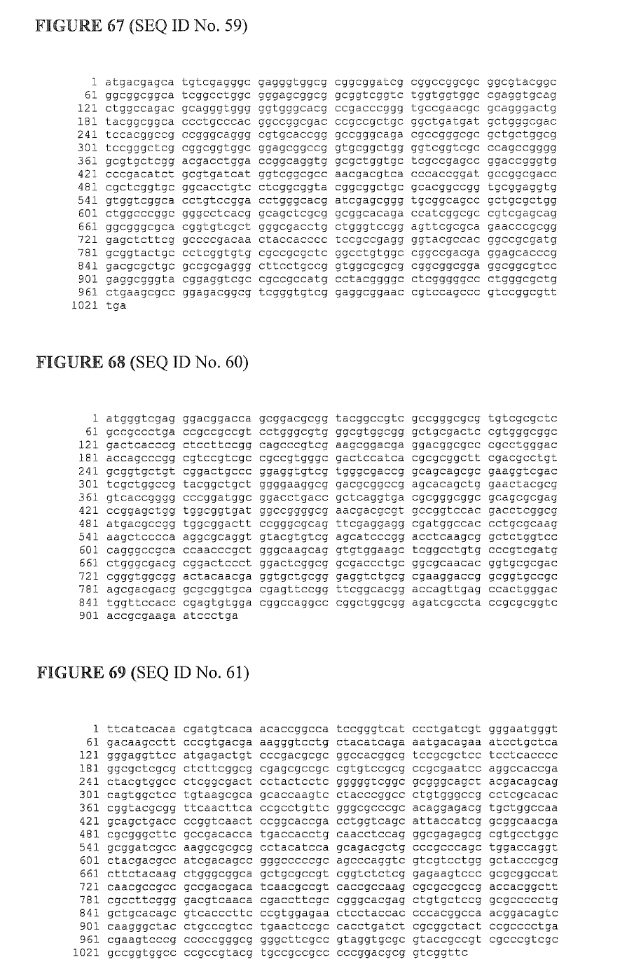

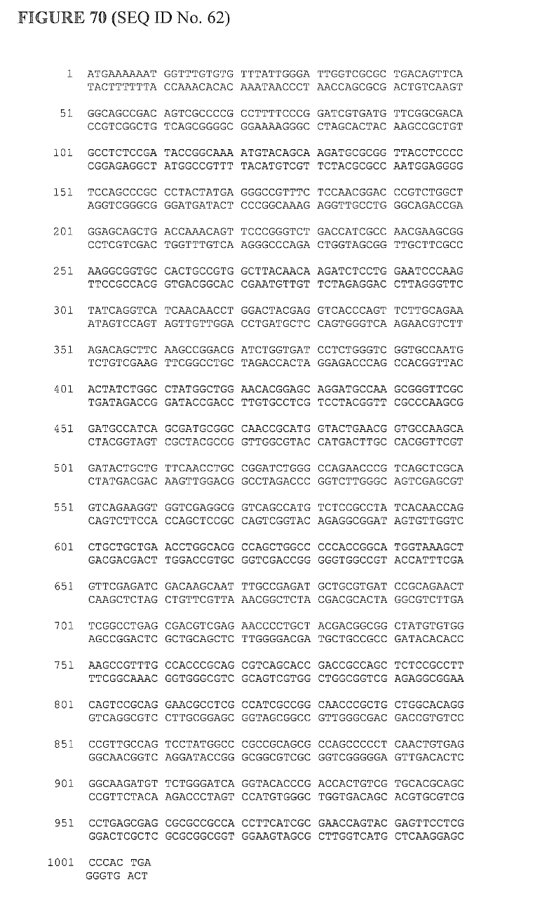

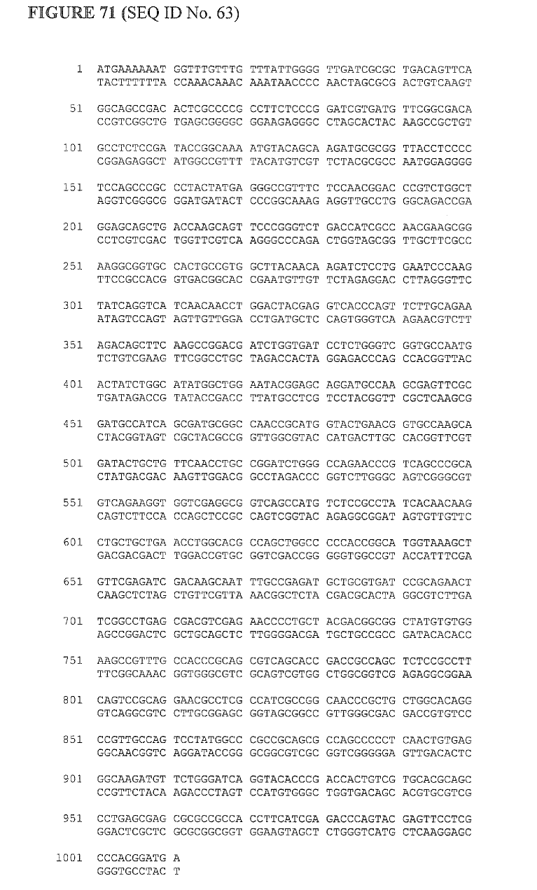

(a) the nucleotide sequence shown as SEQ ID No. 36 (see FIG. 29);
(b) the nucleotide sequence shown as SEQ ID No. 38 (see FIG. 31);
(c) the nucleotide sequence shown as SEQ ID No. 39 (see FIG. 32);
(d) the nucleotide sequence shown as SEQ ID No. 42 (see FIG. 35);
(e) the nucleotide sequence shown as SEQ ID No. 44 (see FIG. 37);
(f) the nucleotide sequence shown as SEQ ID No. 46 (see FIG. 39);
(g) the nucleotide sequence shown as SEQ ID No. 48 (see FIG. 41);
(h) the nucleotide sequence shown as SEQ ID No. 49 (see FIG. 57);
(i) the nucleotide sequence shown as SEQ ID No. 50 (see FIG. 58);
(j) the nucleotide sequence shown as SEQ ID No. 51 (see FIG. 59);
(k) the nucleotide sequence shown as SEQ ID No. 52 (see FIG. 60);
(l) the nucleotide sequence shown as SEQ ID No. 53 (see FIG. 61);
(m) the nucleotide sequence shown as SEQ ID No. 54 (see FIG. 62);
(n) the nucleotide sequence shown as SEQ ID No. 55 (see FIG. 63);
(o) the nucleotide sequence shown as SEQ ID No. 56 (see FIG. 64);
(p) the nucleotide sequence shown as SEQ ID No. 57 (see FIG. 65);
(q) the nucleotide sequence shown as SEQ ID No. 58 (see FIG. 66);
(r) the nucleotide sequence shown as SEQ ID No. 59 (see FIG. 67);
(s) the nucleotide sequence shown as SEQ ID No. 60 (see FIG. 68);
(t) the nucleotide sequence shown as SEQ ID No. 61 (see FIG. 69);
(u) the nucleotide sequence shown as SEQ ID No. 62 (see FIG. 70);
(v) the nucleotide sequence shown as SEQ ID No. 63 (see FIG. 71);
(w) or
a nucleotide sequence which has 70% or more, preferably 75% or more, identity with any one of the sequences shown as SEQ ID No. 36, SEQ ID No. 38, SEQ ID No. 39, SEQ ID No. 42, SEQ ID No. 44, SEQ ID No. 46, SEQ ID No. 48, SEQ ID No. 49, SEQ ID No. 50, SEQ ID No. 51, SEQ ID No. 52, SEQ ID No. 53, SEQ ID No. 54, SEQ ID No. 55, SEQ ID No. 56, SEQ ID No. 57, SEQ ID No. 58, SEQ ID No. 59, SEQ ID No. 60, SEQ ID No. 61, SEQ ID No. 62 or SEQ ID No. 63.

Suitably the nucleotide sequence may have 80% or more, preferably 85% or more, more preferably 90% or more and even more preferably 95% or more identity with any one of the sequences shown as SEQ ID No. 36, SEQ ID No. 38, SEQ ID No. 39, SEQ ID No. 42, SEQ ID No. 44, SEQ ID No. 46, SEQ ID No. 48, SEQ ID No. 49, SEQ ID No. 50, SEQ ID No. 51, SEQ ID No. 52, SEQ ID No. 53, SEQ ID No. 54, SEQ ID No. 55, SEQ ID No. 56, SEQ ID No. 57, SEQ ID No. 58, SEQ ID No. 59, SEQ ID No. 60, SEQ ID No. 61, SEQ ID No. 62 or SEQ ID No. 63.

In one embodiment, the nucleotide sequence encoding a lipid acyltransferase enzyme for use any one of the methods and uses of the present invention is a nucleotide sequence which has 70% or more, preferably 75% or more, identity with any one of the sequences shown as: SEQ ID No. 49, SEQ ID No. 50, SEQ ID No. 51, SEQ ID No. 62, and SEQ ID No. 63. Suitably the nucleotide sequence may have 80% or more, preferably 85% or more, more preferably 90% or more and even more preferably 95% or more identity with any one of the sequences shown as: SEQ ID No. 49, SEQ ID No. 50, SEQ ID No. 51, SEQ ID No. 62, and SEQ ID No. 63.

In one embodiment, the nucleotide sequence encoding a lipid acyltransferase enzyme for use in any one of the methods and uses of the present invention is a nucleotide sequence which has 70% or more, 75% or more, 80% or more, preferably 85% or more, more preferably 90% or more and even more preferably 95% or more identity the sequence shown as SEQ ID No. 49.

Suitably, the lipid acyl transferase enzyme for use in any one of the methods and/or uses of the present invention may be a lipid acyltransferase that comprises one or more of the following amino acid sequences:

(i) the amino acid sequence shown as SEQ ID No. 3
(ii) the amino acid sequence shown as SEQ ID No. 4
(iii) the amino acid sequence shown as SEQ ID No. 5
(iv) the amino acid sequence shown as SEQ ID No. 6
(v) the amino acid sequence shown as SEQ ID No. 7
(vi) the amino acid sequence shown as SEQ ID No. 8
(vii) the amino acid sequence shown as SEQ ID No. 9
(viii) the amino acid sequence shown as SEQ ID No. 10
(ix) the amino acid sequence shown as SEQ ID No. 11
(x) the amino acid sequence shown as SEQ ID No. 12
(xi) the amino acid sequence shown as SEQ ID No. 13
(xii) the amino acid sequence shown as SEQ ID No. 14
(xiii) the amino acid sequence shown as SEQ ID No. 1
(xiv) the amino acid sequence shown as SEQ ID No. 15
(xv) the amino acid sequence shown as SEQ ID No. 16
(xvi) the amino acid sequence shown as SEQ ID No. 17
(xvii) the amino acid sequence shown as SEQ ID No. 18
(xviii) the amino acid sequence shown as SEQ ID No. 34
(xix) the amino acid sequence shown as SEQ ID No. 35
(xx) the amino acid sequence shown as SEQ ID No. 68
(xxi) the amino acid sequence shown as SEQ ID No. 121
(xxii) the amino acid sequence shown as SEQ ID No. 122
(xxiii) the amino acid sequence shown as SEQ ID No. 123 or
an amino acid sequence which has 75%, 80%, 85%, 90%, 95%, 98% or more identity with any one of the sequences shown as SEQ ID No. 1, SEQ ID No. 3, SEQ ID No. 4, SEQ ID No. 5, SEQ ID No. 6, SEQ ID No. 7, SEQ ID No. 8, SEQ ID No. 9, SEQ ID No. 10, SEQ ID No. 11, SEQ ID No. 12, SEQ ID No. 13, SEQ ID No. 14 or SEQ ID No. 15, SEQ ID No. 16, SEQ ID No. 17, SEQ ID No. 18, SEQ ID No. 34, SEQ ID No. 35, SEQ ID No. 68, SEQ ID No. 121, SEQ ID No. 122 or SEQ ID No. 123.

Suitably, the lipid acyl transferase enzyme for use in any one of the methods and uses of the present invention may be a lipid acyltransferase that comprises either the amino acid sequence shown as SEQ ID No. 3 or as SEQ ID No. 4 or SEQ ID No. 1 or SEQ ID No. 15 or SEQ ID No. 16, or SEQ ID No. 34, SEQ ID No. 35, SEQ ID No. 68, SEQ ID No. 121, SEQ ID No. 122 or SEQ ID No. 123 or comprises an amino acid sequence which has 75% or more, preferably 80% or more, preferably 85% or more, preferably 90% or more, preferably 95% or more, identity with the amino acid sequence shown as SEQ ID No. 3 or the amino acid sequence shown as SEQ ID No. 4 or the amino acid sequence shown as SEQ ID No. 1 or the amino acid sequence shown as SEQ ID No. 15 or the amino acid sequence shown as SEQ ID No. 16 or the amino acid sequence shown as SEQ ID No. 34 or the amino acid sequence shown as SEQ ID No. 35 or the amino acid sequence shown as SEQ ID No. 68 or the amino acid sequence shown as SEQ ID No. 121 or the amino acid sequence shown as SEQ ID No. 122 or the amino acid sequence shown as SEQ ID No. 123.

Suitably the lipid acyl transferase enzyme for use any one of the methods and/or uses of the present invention may be a lipid acyltransferase that comprises an amino acid sequence which has 80% or more, preferably 85% or more, more preferably 90% or more and even more preferably 95% or more identity with any one of the sequences shown as SEQ ID No. 3, SEQ ID No. 4, SEQ ID No. 5, SEQ ID No. 6, SEQ ID No. 7, SEQ ID No. 8, SEQ ID No. 9, SEQ ID No. 10, SEQ ID No. 11, SEQ ID No. 12, SEQ ID No. 13, SEQ ID No. 14, SEQ ID No. 1, SEQ ID No. 15, SEQ ID No. 16, SEQ ID No. 17, SEQ ID No. 18, SEQ ID No. 34 or SEQ ID No. 35, SEQ ID No. 68, SEQ ID No. 121, SEQ ID No. 122 or SEQ ID No. 123.

Suitably, the lipid acyl transferase enzyme for use any one of the methods and/or uses of the present invention may be a lipid acyltransferase that comprises one or more of the following amino acid sequences:
(a) an amino acid sequence shown as amino acid residues 1-100 of SEQ ID No. 3 or SEQ ID No. 1;
(b) an amino acid sequence shown as amino acids residues 101-200 of SEQ ID No. 3 or SEQ ID No. 1;
(c) an amino acid sequence shown as amino acid residues 201-300 of SEQ ID No. 3 or SEQ ID No. 1; or
(d) an amino acid sequence which has 75% or more, preferably 85% or more, more preferably 90% or more, even more preferably 95% or more identity to any one of the amino acid sequences defined in (a)-(c) above.

Suitably, the lipid acyl transferase enzyme for use in methods and uses of the present invention may comprise one or more of the following amino acid sequences:
(a) an amino acid sequence shown as amino acid residues 28-39 of SEQ ID No. 3 or SEQ ID No. 1;
(b) an amino acid sequence shown as amino acids residues 77-88 of SEQ ID No. 3 or SEQ ID No. 1;
(c) an amino acid sequence shown as amino acid residues 126-136 of SEQ ID No. 3 or SEQ ID No. 1;
(d) an amino acid sequence shown as amino acid residues 163-175 of SEQ ID No. 3 or SEQ ID No. 1;
(e) an amino acid sequence shown as amino acid residues 304-311 of SEQ ID No. 3 or SEQ ID No. 1; or
(f) an amino acid sequence which has 75% or more, preferably 85% or more, more preferably 90% or more, even more preferably 95% or more identity to any one of the amino acid sequences defined in (a)-(e) above.

In one aspect, the lipid acyl transferase enzyme for use any one of the methods and/or uses of the present invention is a lipid acyltransferase that may be the lipid acyl transferase from Candida parapsilosis as taught in EP 1 275 711. Thus in one aspect the lipid acyl transferase for use in the method and uses of the present invention may be a lipid acyl transferase comprising one of the amino acid sequences taught in SEQ ID No. 17 or SEQ ID No. 18.

Much by preference, the lipid acyl transferase enzyme for use in any one of the methods and uses of the present invention is a lipid acyltransferase that may be a lipid acyl transferase comprising the amino acid sequence shown as SEQ ID No. 16, or an amino acid sequence which has 75% or more, preferably 85% or more, more preferably 90% or more, even more preferably 95% or more, even more preferably 98% or more, or even more preferably 99% or more identity to SEQ ID No. 16. This enzyme could be considered a variant enzyme.

In one aspect, the lipid acyltransferase enzyme for use any one of the methods and/or uses of the present invention is a lipid acyltransferase that may be a lecithin:cholesterol acyltransferase (LCAT) or variant thereof (for example a variant made by molecular evolution)

Suitable LCATs are known in the art and may be obtainable from one or more of the following organisms for example: mammals, rat, mice, chickens, Drosophila melanogaster, plants, including Arabidopsis and Oryza sativa, nematodes, fungi and yeast.

In one embodiment the lipid acyltransferase enzyme for use any one of the methods and/or uses of the present invention is a lipid acyltransferase that may be the lipid acyltransferase obtainable, preferably obtained, from the E. coli strains TOP 10 harbouring pPet12aAhydro and pPet12aASalmo deposited by Danisco A/S of Langebrogade 1, DK-1001 Copenhagen K, Denmark under the Budapest Treaty on the International Recognition of the Deposit of Microorganisms for the purposes of Patent Procedure at the National Collection of Industrial, Marine and Food Bacteria (NCIMB) 23 St. Machar Street, Aberdeen, Scotland, United Kingdom on 22 Dec. 2003 under accession numbers NCIMB 41204 and NCIMB 41205, respectively.

A lipid acyltransferase enzyme for use in any one of the methods and/or uses of the present invention may be a phospholipid glycerol acyl transferase. Phospholipid glycerol acyl transferases include those isolated from Aeromonas spp., preferably Aeromonas hydrophila or A. salmonicida, most preferably A. salmonicida or variants thereof.

Most preferred lipid acyl transferases for use in the present invention are encoded by SEQ ID No.s 1, 3, 4, 15, 16, 34 and 35. It will be recognised by the skilled person that it is preferable that the signal peptides of the acyl transferase has been cleaved during expression of the transferase. The signal peptide of SEQ ID No.s 1, 3, 4, and 15 are amino acids 1-18. Therefore the most preferred regions are amino acids 19-335 for SEQ ID No. 1 and SEQ ID No. 3 (A. hydrophilia) and amino acids 19-336 for SEQ ID No. 4, and SEQ ID No. 15 (A. salmonicida). When used to determine the homology of identity of the amino acid sequences, it is preferred that the alignments as herein described use the mature sequence.

In one embodiment, suitably the lipid acyl transferase for use in the present invention comprises (or consists of) the amino acid sequence shown in SEQ ID No. 16 or comprises (or consists of) an amino acid sequence which has at least 70%, at least 75%, at least 85%, at least 90%, at least 95%, at least 98% identity to SEQ ID No. 16.

In one embodiment, suitably the lipid acyl transferase for use in the present invention is encoded by a nucleotide sequence comprising (or consisting of) a nucleotide sequence shown in SEQ ID No. 49 or comprises (or consists of) a nucleotide sequence which has at least 70%, at least 75%, at least 85%, at least 90%, at least 95%, at least 98% identity to SEQ ID No. 49.

Therefore the most preferred regions for determining homology (identity) are amino acids 19-335 for SEQ ID No. 1 and 3 (A. hydrophilia) and amino acids 19-336 for SEQ ID No.s 4, 15 (A. salmonicida). SEQ ID No.s 34 and 35 are mature protein sequences of a lipid acyl transferase from A. hydrophilia and A. salmonicida respectively which may or may not undergo further post-translational modification.

A lipid acyltransferase enzyme for use any one of the methods and uses of the present invention may be a lipid acyltransferase that may also be isolated from Thermobifida, preferably T. fusca, most preferably that encoded by SEQ ID No. 28.

Suitable lipid acyltransferases for use in accordance with the present invention and/or in the methods of the present invention may comprise any one of the following amino acid sequences and/or be encoded by the following nucleotide sequences:

a) a nucleic acid which encodes a polypeptide exhibiting lipid acyltransferase activity and is at least 70% identical (preferably at least 80%, more preferably at least 90% identical) with the polypeptide sequence shown in SEQ ID No. 16 or with the polypeptide shown in SEQ ID no. 68 or with the polypeptide shown in SEQ ID no. 121 or with the polypeptide shown in SEQ ID no. 122 or with the polypeptide shown in SEQ ID no. 123;
b) a (isolated) polypeptide comprising (or consisting of) an amino acid sequence as shown in SEQ ID No. 16 or SEQ ID No. 68 or an amino acid sequence which is at least 70% identical (preferably at least 80% identical, more preferably at least 90% identical) with SEQ ID No. 16, SEQ ID No. 68, SEQ ID No. 121, SEQ ID No. 122 or SEQ ID No. 123;
c) a nucleic acid encoding a lipid acyltransferase, which nucleic acid comprises (or consists of) a nucleotide sequence shown as SEQ ID No. 49 or a nucleotide sequence which is at least 70% identical (preferably at least 80%, more preferably at least 90% identical) with the nucleotide sequence shown as SEQ ID No. 49;
d) a nucleic acid which hybridises under medium or high stringency conditions to a nucleic acid probe comprising the nucleotide sequence shown as SEQ ID No. 49 and encodes for a polypeptide exhibiting lipid acyltransferase activity;
e) a nucleic acid which is a fragment of the nucleic acid sequences specified in a), c) or d); or
f) a polypeptide which is a fragment of the polypeptide specified in b).

A lipid acyltransferase enzyme for use any one of the methods and uses of the present invention may be a lipid acyltransferase that may also be isolated from Streptomyces, preferable S. avermitis, most preferably that encoded by SEQ ID No. 32. Other possible enzymes for use in the present invention from Streptomyces include those encoded by SEQ ID No.s 5, 6, 9, 10, 11, 12, 13, 14, 31, and 33.

An enzyme for use in the invention may also be isolated from Corynebacterium, preferably C. efficiens, most preferably that encoded by SEQ ID No. 29.

Suitably, the lipid acyltransferase enzyme for use any one of the methods and/or uses of the present invention may be a lipid acyltransferase that comprises any one of the amino acid sequences shown as SEQ ID Nos. 37, 38, 40, 41, 43, 45, or 47 or an amino acid sequence which has at least 70%, 75%, 80%, 85%, 90%, 95%, 96%, 97% or 98% identity therewith, or may be encoded by any one of the nucleotide sequences shown as SEQ ID Nos. 36, 39, 42, 44, 46, or 48 or a nucleotide sequence which has at least 70%, 75%, 80%, 85%, 90%, 95%, 96%, 97% or 98% identity therewith.

In one embodiment, the nucleotide sequence encoding a lipid acyltransferase enzyme for use any one of the methods and/or uses of the present invention is selected from the group consisting of:
a) a nucleic acid comprising a nucleotide sequence shown in SEQ ID No. 36;
b) a nucleic acid which is related to the nucleotide sequence of SEQ ID No. 36 by the degeneration of the genetic code; and
c) a nucleic acid comprising a nucleotide sequence which has at least 70% identity with the nucleotide sequence shown in SEQ ID No. 36.

In one embodiment, the lipid acyltransferase enzyme for use any one of the methods and/or uses of the present invention is a lipid acyltransferase that comprises an amino acid sequence as shown in SEQ ID No. 37 or an amino acid sequence which has at least 60% identity thereto.

In a further embodiment the lipid acyltransferase enzyme for use any one of the methods and/or uses of the present invention may be a lipid acyltransferase comprising any one of the amino acid sequences shown as SEQ ID No. 37, 38, 40, 41, 43, 45 or 47 or an amino acid sequence which has at least 70%, 75%, 80%, 85%, 90%, 95%, 96%, 97% or 98% identity therewith, or may be encoded by any one of the nucleotide sequences shown as SEQ ID No. 39, 42, 44, 46 or 48 or a nucleotide sequence which has at least 70%, 75%, 80%, 85%, 90%, 95%, 96%, 97% or 98% identity therewith.

In a further embodiment the lipid acyltransferase enzyme for use any one of the methods and/or uses of the present invention may be a lipid acyltransferase comprising any one of amino sequences shown as SEQ ID No. 38, 40, 41, 45 or 47 or an amino acid sequence which has at least 70%, 75%, 80%, 85%, 90%, 95%, 96%, 97% or 98% identity therewith for the uses described herein.

In a further embodiment the lipid acyltransferase for use in any one of the methods and/or uses of the present invention may be a lipid acyltransferase comprising any one of amino sequences shown as SEQ ID No. 38, 40, or 47 or an amino acid sequence which has at least 70%, 75%, 80%, 85%, 90%, 95%, 96%, 97% or 98% identity therewith for the uses described herein.

More preferably in one embodiment the lipid acyltransferase for use in any one of the methods and/or uses of the present invention may be a lipid acyltransferase comprising the amino acid sequence shown as SEQ ID No. 47 or an amino acid sequence which has at least 70%, 75%, 80%, 85%, 90%, 95%, 96%, 97% or 98% identity therewith.

In another embodiment the lipid acyltransferase for use in any one of the methods and uses of the present invention may be a lipid acyltransferase comprising the amino acid sequence shown as SEQ ID No. 43 or 44 or an amino acid sequence which has at least 80%, 85%, 90%, 95%, 96%, 97% or 98% identity therewith.

In another embodiment the lipid acyltransferase for use in any one of the methods and uses of the present invention may be a lipid acyltransferase comprising the amino acid sequence shown as SEQ ID No. 41 or an amino acid sequence which has at least 70%, 75%, 80%, 85%, 90%, 95%, 96%, 97% or 98% identity therewith.

In one embodiment the lipid acyltransferase for use in any one of the methods and uses of the present invention may be encoded by a nucleic acid selected from the group consisting of:
a) a nucleic acid comprising a nucleotide sequence shown in SEQ ID No. 36;
b) a nucleic acid which is related to the nucleotide sequence of SEQ ID No. 36 by the degeneration of the genetic code; and
c) a nucleic acid comprising a nucleotide sequence which has at least 70% identity with the nucleotide sequence shown in SEQ ID No. 36.

In one embodiment the lipid acyltransferase according to the present invention may be a lipid acyltransferase obtainable, preferably obtained, from the Streptomyces strains L130 or L131 deposited by Danisco A/S of Langebrogade 1, DK-1001 Copenhagen K, Denmark under the Budapest Treaty on the International Recognition of the Deposit of Microorganisms for the purposes of Patent Procedure at the National Collection of Industrial, Marine and Food Bacteria (NCIMB) 23 St. Machar Street, Aberdeen, Scotland, United Kingdom on 23 Jun. 2004 under accession numbers NCIMB 41226 and NCIMB 41227, respectively.

Suitable nucleotide sequences encoding a lipid acyltransferase for use in any one of the methods and/or uses of the present invention may encode a polynucleotide encoding a lipid acyltransferase (SEQ ID No. 16); or may encode an amino acid sequence of a lipid acyltransferase (SEQ ID No. 16).

A suitable lipid acyltransferases for use in any one of the methods and/or uses of the present invention may be an amino acid sequence which may be identified by alignment to the L131 (SEQ ID No. 37) sequence using Align X, the Clustal W pairwise alignment algorithm of Vector NTI using default settings.

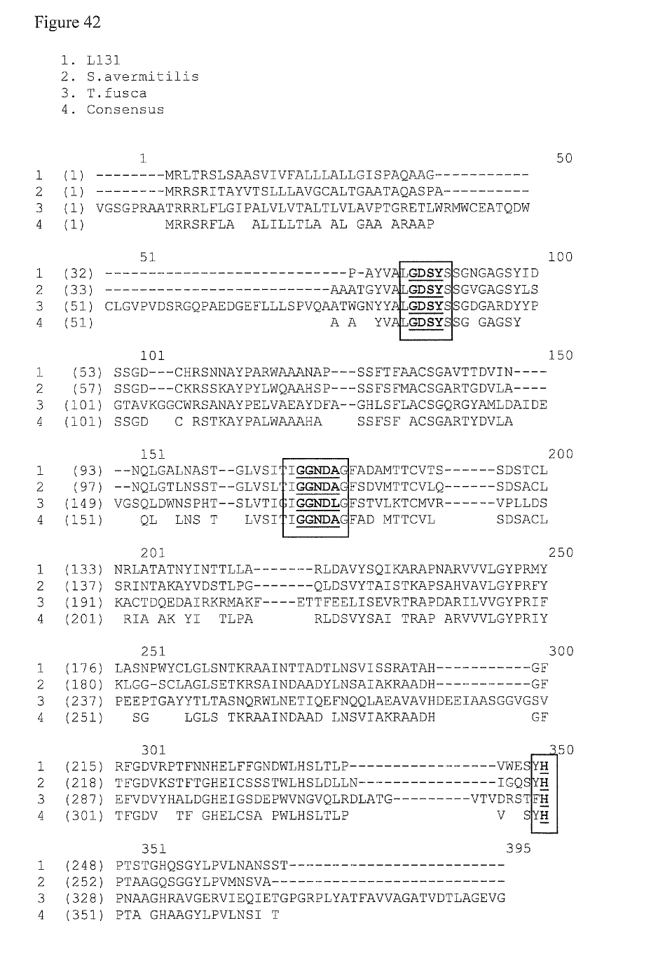

An alignment of the L131 and homologues from S. avermitilis and T. fusca illustrates that the conservation of the GDSx motif (GDSY in L131 and S. avermitilis and T. fusca), the GANDY box, which is either GGNDA or GGNDL, and the HPT block (considered to be the conserved catalytic histidine). These three conserved blocks are highlighted in FIG. 42.

When aligned to either the pfam Pfam00657 consensus sequence (as described in WO 2004/064987) and/or the L131 sequence herein disclosed (SEQ ID No 37) it is possible to identify three conserved regions, the GDSx block, the GANDY block and the HTP block (see WO 2004/064987 for further details).

When aligned to either the pfam Pfam00657 consensus sequence (as described in WO 2004/064987) and/or the L131 sequence herein disclosed (SEQ ID No 37)
i) The lipid acyltransferase for use in any one of the methods and uses of the present invention may be a lipid acyltransferase that has a GDSx motif, more preferably a GDSx motif selected from GDSL or GDSY motif.
and/or
ii) The lipid acyltransferase for use in any one of the methods and uses of the present invention may be a lipid acyltransferase that has a GANDY block, more preferably a GANDY block comprising amino GGNDx, more preferably GGNDA or GGNDL.
and/or
iii) The lipid acyltransferase for use in any one of the methods and uses of the present invention may be a lipid acyltransferase that has preferably an HTP block.
and preferably
iv) the lipid acyltransferase for use in any one of the methods and uses of the present invention may be a lipid acyltransferase that has preferably a GDSx or GDSY motif, and a GANDY block comprising amino GGNDx, preferably GGNDA or GGNDL, and a HTP block (conserved histidine).

The lipid acyltransferase as used herein may be referred to as a glycerophospholipid cholesterol acyltransferase. In other words the lipid acyltransferase for use in the present invention preferably has the ability to “hydrolyse” phospholipids and at the same time esterify cholesterol with the free fatty acid from the hydrolyzation this is effective a tranferase reaction (i.e. an interesterification and/or a transesterification reaction.

The degree of “hydrolysis” can be described as the ratio of phosphatidylcholine (PC) and/or phosphatidylethanolamine (PE) converted into lyso-PC or lyso-PE respectively. By the enzymatic hydrolyzation of PC into lyso-PC, the ratio between the hydrophilic part of the phospholipid molecule (polar head group) and the hydrophobic part (fatty acid chains) is altered. By removing one fatty acid (saturated and/or unsaturated fatty acids) the hydrophobic part is reduced, thus making the entire molecule more hydrophilic. Furthermore the sterical molecule conformation may be changed, which may influence phase structures (e.g. micellation) formed by the molecules in dispersion, as well as interactions with other molecules like e.g. milk proteins.

Lyso-lecithin products are known to possess improved emulsifying properties. With a high degree of interesterification and/or transesterification it is possible to obtain smaller mean oil droplet sizes in a comparative emulsification test.

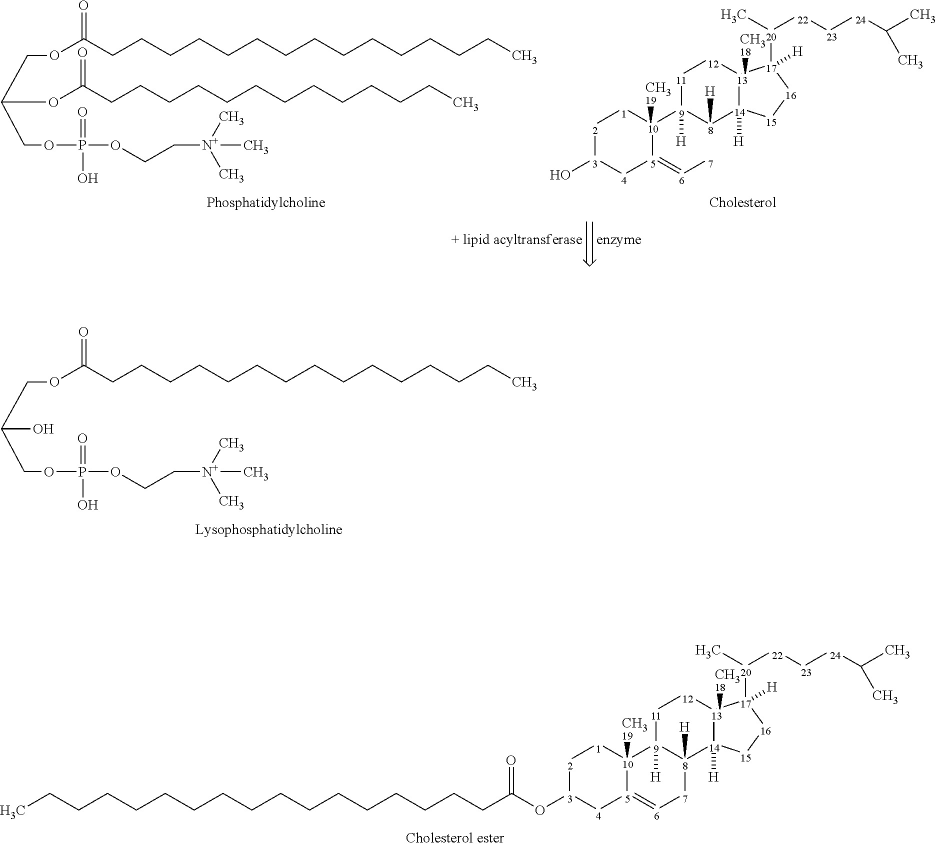

The function of lipid acyltransferase is that cholesterol and phospholipids will be changed into cholesterol-esters and lyso-phospholipids, giving two resulting components with surface-active properties in relation to O/W emulsions. Thus the final products will contain no or significantly reduced cholesterol and have an improved emulsion stability.

The enzyme according to the present invention is preferably not a phospholipase enzyme, such as a phospholipase A1 classified as E.C. 3.1.1.32 or a phospholipase A2 classified as E.C. 3.1.1.4.

Variant Lipid Acyl Transferase

In a preferred embodiment the nucleotide sequence encoding a lipid acyltransferase for use in any one of the methods and/or uses of the present invention may encode a lipid acyltransferase that is a variant lipid acyl transferase.

Variants which have an increased activity on phospholipids, such as increased hydrolytic activity and/or increased transferase activity, preferably increased transferase activity on phospholipids may be used.

Preferably the variant lipid acyltransferase is prepared by one or more amino acid modifications of the lipid acyl transferases as defined hereinabove.

Suitably, the lipid acyltransferase for use in any one of the methods and uses of the present invention may be a lipid acyltransferase that may be a variant lipid acyltransferase, in which case the enzyme may be characterised in that the enzyme comprises the amino acid sequence motif GDSX, wherein X is one or more of the following amino acid residues L, A, V, I, F, Y, H, Q, T, N, M or S, and wherein the variant enzyme comprises one or more amino acid modifications compared with a parent sequence at any one or more of the amino acid residues defined in set 2 or set 4 or set 6 or set 7 (as defined in WO 2005/066347 and hereinbelow).

For instance the variant lipid acyltransferase may be characterised in that the enzyme comprises the amino acid sequence motif GDSX, wherein X is one or more of the following amino acid residues L, A, V, I, F, Y, H, Q, T, N, M or S, and wherein the variant enzyme comprises one or more amino acid modifications compared with a parent sequence at any one or more of the amino acid residues detailed in set 2 or set 4 or set 6 or set 7 (as defined in WO 2005/066347 and hereinbelow) identified by said parent sequence being structurally aligned with the structural model of P10480 defined herein, which is preferably obtained by structural alignment of P10480 crystal structure coordinates with 1IVN.PDB and/or 1DEO.PDB as defined in WO 2005/066347 and hereinbelow.

In a further embodiment a lipid acyltransferase for use in any one of the methods and/or uses of the present invention may be a variant lipid acyltransferase that may be characterised in that the enzyme comprises the amino acid sequence motif GDSX, wherein X is one or more of the following amino acid residues L, A, V, I, F, Y, H, Q, T, N, M or S, and wherein the variant enzyme comprises one or more amino acid modifications compared with a parent sequence at any one or more of the amino acid residues taught in set 2 identified when said parent sequence is aligned to the pfam consensus sequence (SEQ ID No. 2—FIG. 3) and modified according to a structural model of P10480 to ensure best fit overlap as defined in WO 2005/066347 and hereinbelow.

Suitably a lipid acyltransferase for use in any one of the methods and uses of the present invention may be a variant lipid acyltransferase enzyme that may comprise an amino acid sequence, which amino acid sequence is shown as SEQ ID No. 34, SEQ ID No. 3, SEQ ID No. 4, SEQ ID No. 5, SEQ ID No. 6, SEQ ID No. 7, SEQ ID No. 8, SEQ ID No. 9, SEQ ID No. 10, SEQ ID No. 11, SEQ ID No. 12, SEQ ID No. 13, SEQ ID No. 14, SEQ ID No. 1, SEQ ID No. 15, SEQ ID No. 25, SEQ ID No. 26, SEQ ID No. 27, SEQ ID No. 28, SEQ ID No. 29, SEQ ID No. 30, SEQ ID No. 32, SEQ ID No. 33 or SEQ ID No. 35 except for one or more amino acid modifications at any one or more of the amino acid residues defined in set 2 or set 4 or set 6 or set 7 (as defined in WO 2005/066347 and hereinbelow) identified by sequence alignment with SEQ ID No. 34.

Alternatively the lipid acyltransferase may be a variant lipid acyltransferase enzyme comprising an amino acid sequence, which amino acid sequence is shown as SEQ ID No. 34, SEQ ID No. 3, SEQ ID No. 4, SEQ ID No. 5, SEQ ID No. 6, SEQ ID No. 7, SEQ ID No. 8, SEQ ID No. 9, SEQ ID No. 10, SEQ ID No. 11, SEQ ID No. 12, SEQ ID No. 13, SEQ ID No. 14, SEQ ID No. 1, SEQ ID No. 15, SEQ ID No. 25, SEQ ID No. 26, SEQ ID No. 27, SEQ ID No. 28, SEQ ID No. 29, SEQ ID No. 30, SEQ ID No. 32, SEQ ID No. 33 or SEQ ID No. 35 except for one or more amino acid modifications at any one or more of the amino acid residues defined in set 2 or set 4 or set 6 or set 7 as defined in WO 2005/066347 and hereinbelow, identified by said parent sequence being structurally aligned with the structural model of P10480 defined herein, which is preferably obtained by structural alignment of P10480 crystal structure coordinates with 1IVN.PDB and/or 1DEO.PDB as taught within WO 2005/066347 and hereinbelow.

Alternatively, the lipid acyltransferase may be a variant lipid acyltransferase enzyme comprising an amino acid sequence, which amino acid sequence is shown as SEQ ID No. 34, SEQ ID No. 3, SEQ ID No. 4, SEQ ID No. 5, SEQ ID No. 6, SEQ ID No. 7, SEQ ID No. 8, SEQ ID No. 9, SEQ ID No. 10, SEQ ID No. 11, SEQ ID No. 12, SEQ ID No. 13, SEQ ID No. 14, SEQ ID No. 1, SEQ ID No. 15, SEQ ID No. 25, SEQ ID No. 26, SEQ ID No. 27, SEQ ID No. 28, SEQ ID No. 29, SEQ ID No. 30, SEQ ID No. 32, SEQ ID No. 33 or SEQ ID No. 35 except for one or more amino acid modifications at any one or more of the amino acid residues taught in set 2 identified when said parent sequence is aligned to the pfam consensus sequence (SEQ ID No. 2) and modified according to a structural model of P10480 to ensure best fit overlap as taught within WO 2005/066347 and hereinbelow.

Preferably, the parent enzyme is an enzyme which comprises, or is homologous to, the amino acid sequence shown as SEQ ID No. 34 and/or SEQ ID No. 15 and/or SEQ ID No. 35.

Preferably, the lipid acyltransferase may be a variant enzyme which comprises an amino acid sequence, which amino acid sequence is shown as SEQ ID No. 34 or SEQ ID No. 35 except for one or more amino acid modifications at any one or more of the amino acid residues defined in set 2 or set 4 or set 6 or set 7 as defined in WO 2005/066347 and hereinbelow.

Other suitable variant lipid acyltransferases for use in the methods/uses of the present invention are those described in PCT/IB2009/054535.

The tertiary structure of the lipid acyltransferases has revealed an unusual and interesting structure which allows lipid acyltransferases to be engineered more successfully. In particular the lipid acyltransferase tertiary structure has revealed a cave and canyon structure the residues forming these structures are defined herein below.

Alterations in the cave region may (for example) alter the enzyme's substrate chain length specificity for example.

Alterations in the canyon (particularly some preferred key modifications) have been found to be important in for example enhancing or changing the enzyme's substrate specificity.

In particular it has been found by the present inventors that there are a number of modifications in the canyon which rank highly and produce interesting variants with improved properties—these can be found at positions 31, 27, 85, 86, 119 and 120. In some embodiments positions 31 and/or 27 are highly preferred.

These variant lipid acyltransferase enzyme may be encoded by a nucleotide sequence which has at least 90% identity with a nucleotide sequence encoding a parent lipid acyltransferase and comprise at least one modification (suitably at least two modifications) at a position(s) which corresponds in the encoded amino acid sequence to an amino acid(s) located in a) the canyon region of the enzyme and/or b) insertion site 1 and/or c) insertion site 2, wherein the canyon region, insertion site 1 and/or insertion site 2 of the enzyme is defined as that region which when aligned based on primary or tertiary structure corresponds to the canyon region, insertion site 1 or insertion site 2 of the enzyme shown herein as SEQ ID No. 16 or SEQ ID No. 68 as described herein below.

In one embodiment preferably the modification(s) at a position located in the canyon and/or insertion site 1 and/or insertion site 2 is combined with at least one modification at a position which corresponds in the encoded amino acid sequence to an amino acid located outside of the canyon region and/or insertion site 1 and/or insertion site 2.

In one embodiment, the lipid acyltransferase comprises at least one modification (suitably at least two modifications) at a position(s) which corresponds in the encoded amino acid sequence to an amino acid(s) located at position 27, 31, 85, 86, 122, 119, 120, 201, 245, 232, 235 and/or 236 (preferably at position 27, 31, 85, 86, 119 and/or 120, more preferably at position 27 and/or 31), wherein the position numbering is defined as that position which when aligned based on primary or tertiary structure corresponds to the same position of the enzyme shown herein as SEQ ID No. 16.

In a further embodiment, the variant lipid acyltransferase comprises at least one modification at a position(s) which corresponds in the encoded amino acid sequence to an amino acid(s) located at position 27 and/or 31 in combination with at least one further modification, wherein the position numbering is defined as that position which when aligned based on primary or tertiary structure corresponds to the same position of the enzyme shown herein as SEQ ID No. 16.

Suitably, the at least one further modification may be at one or more of the following positions 85, 86, 122, 119, 120, 201, 245, 23, 81, 82, 289, 227, 229, 233, 33, 207, 130, wherein the position numbering is defined as that position which when aligned based on primary or tertiary structure corresponds to the same position of the enzyme shown herein as SEQ ID No. 16.

The lipid acyltransferase amino acid sequence for use in the present invention may comprise a modified backbone such that at least one modification (suitably at least two modifications) is made at a position(s) which corresponds in the encoded amino acid sequence to an amino acid(s) located in a) the canyon region of the enzyme and/or b) insertion site 1 and/or c) insertion site 2, wherein the canyon region, insertion site 1 and/or insertion site 2 enzyme is defined as that region which when aligned based on primary or tertiary structure corresponds to the canyon region, insertion site 1 or insertion site 2, respectively, of the enzyme shown herein as SEQ ID No. 16 or SEQ ID No. 68.

In one embodiment preferably the modification(s) at a position located in the canyon and/or insertion site 1 and/or insertion site 2 is combined with at least one modification at a position which corresponds in the encoded amino acid sequence to an amino acid located outside of the canyon region and/or insertion site 1 and/or insertion site 2.

Preferably, the lipid acyltransferase amino acid sequence backbone is modified such that at least one modification (suitably at least two modifications) is made at a position(s) which corresponds in the encoded amino acid sequence to an amino acid(s) located in position 27, 31, 85, 86, 122, 119, 120, 201, 245, 232, 235 and/or 236 (preferably at position 27, 31, 85, 86 119 and/or 120, more preferably at position 27 and/or 31), wherein the position numbering is defined as that position which when aligned based on primary or tertiary structure corresponds to the same position of the enzyme shown herein as SEQ ID No. 16.

In further preferred embodiments, the lipid acyltransferase amino acid sequence backbone comprises at least one modification (suitably at least two modifications) at a position(s) which corresponds in the encoded amino acid sequence to an amino acid(s) located in position 27, 31 in combination with at least one further modification, wherein the position numbering is defined as that position which when aligned based on primary or tertiary structure corresponds to the same position of the enzyme shown herein as SEQ ID No. 16.

Suitably, the at least one further modification may be at one or more of the following positions 85, 86, 122, 119, 120, 201, 245, 23, 81, 82, 289, 227, 229, 233, 33, 207, 130, wherein the position numbering is defined as that position which when aligned based on primary or tertiary structure corresponds to the same position of the enzyme shown herein as SEQ ID No. 16.

Further provided is an altered or variant lipid acyltransferase for use in the present invention comprising an amino acid sequence that is at least 70% identical to the lipid acyltransferase from Aeromonas salmonicida shown herein as SEQ ID No. 16 or 68, wherein a substrate chain length specificity determining segment that lies immediately N-terminal of the Asp residue of the catalytic triad of said altered lipid acyltransferase has an altered length relative to said lipid acyltransferase from Aeromonas salmonicida shown herein as SEQ ID No. 16 or 68.

Preferably the alteration comprises an amino acid insertion or deletion in said substrate chain length specificity determining segment, such as substituting said substrate chain length specificity determining segment of said parent enzyme with the substrate chain length specificity determining segment of a different lipid acyltransferase to produce said altered lipid acyltransferase. Preferably, said altering increases the length of acyl chain that can be transferred by said lipid acyltransferase.

Preferably, the altered lipid acyltransferase comprises an amino acid sequence that is at least 90% identical to the lipid acyltransferase from Aeromonas salmonicida shown herein as SEQ ID No. 16 or 68.

The nucleotide sequence encoding the variant lipid acyltransferase enzyme before modification is a nucleotide sequence shown herein as SEQ ID No. 120, SEQ ID No. 49, SEQ ID No. 50, SEQ ID No. 51, SEQ ID No. 62, SEQ ID No. 63 or SEQ ID No. 24; or is a nucleotide sequence which has at least 70% identity (preferably at least 80%, more preferably at least 90%, even more preferably at least 95% identity) with a nucleotide sequence shown herein as SEQ ID No. 120, SEQ ID No. 49, SEQ ID No. 50, SEQ ID No. 51, SEQ ID No. 62, SEQ ID No. 63 or SEQ ID No. 24; or is a nucleotide sequence which is related to SEQ ID No. 120, SEQ ID No. 49, SEQ ID No. 50, SEQ ID No. 51, SEQ ID No. 62, SEQ ID No. 63, SEQ ID No. 24 by the degeneration of the genetic code; or is a nucleotide sequence which hybridises under medium stringency or high stringency conditions to a nucleotide sequence shown herein as SEQ ID No. 120, SEQ ID No. 49, SEQ ID No. 50, SEQ ID No. 51, SEQ ID No. 62, SEQ ID No. 63 or SEQ ID No. 24.

In a preferred embodiment, the variant lipid acyltransferase is encoded by a nucleic acid (preferably an isolated or recombinant nucleic acid) sequence which hybridises under medium or high stringency conditions over substantially the entire length of SEQ ID No. 49 or SEQ ID No. 120 or a compliment of SEQ ID No. 49 or SEQ ID No. 120, wherein the encoded polypeptide comprising one or more amino acid residues selected from Q, H, N, T, F, Y or C at position 31; R, Y, S, V, I, A, T, M, F, C or L at position 86; R, G, H, K, Y, D, N, V, C, Q, L, E, S or F at position 27; H, R, D, E 85; T or I at position 119; K or E at position 120; S, L, A, F, W, Y, R, H, M or C at position 122; R at position 201; S as position 245; A or V at position 235; G or S at position 232; G or E at position 236, wherein the positions are equivalent amino acid positions with respect of SEQ ID No. 16.

The variant lipid acyltransferase may comprise a pro-peptide or a polypeptide which has lipid acyltransferase activity and comprises an amino acid sequence which is at least 90% (preferably at least 95%, more preferably at least 98%, more preferably at least 99%) identical with the amino acid sequence shown as SEQ ID No. 16 or 68 and comprises one or more modifications at one or more of the following positions: 27, 31, 85, 86, 122, 119, 120, 201, 245, 232, 235 and/or 236 (preferably at position 27, 31, 85, 86, 119 and/or 120 more preferably at position 27 and/or 31).

In one embodiment the variant comprises a pro-peptide or a polypeptide which has lipid acyltransferase activity and comprises an amino acid sequence shown as SEQ ID No. 16 or 68 except for one or more modifications at one or more of the following positions: 27, 31, 85, 86, 122, 119, 120, 201, 245, 232, 235 and/or 236 (preferably at position 27, 31, 85, 86, 119 and/or 120 more preferably at position 27 and/or 31).

In another embodiment, the lipid acyltransferase comprises a pro-peptide or a polypeptide which has lipid acyltransferase activity and comprises an amino acid sequence which is at least 90% (preferably at least 95%, more preferably at least 98%, more preferably at least 99%) identical with the amino acid sequence shown as SEQ ID No. 16 or 68 and comprises one or more modifications at positions 27 and/or 31 in combination with at least one further modification, wherein the position numbering is defined as that position which when aligned based on primary or tertiary structure corresponds to the same position of the enzyme shown herein as SEQ ID No. 6.

Suitably, the at least one further modification may be at one or more of the following positions 85, 86, 122, 119, 120, 201, 245, 23, 81, 82, 289, 227, 229, 233, 33, 207, 130, wherein the position numbering is defined as that position which when aligned based on primary or tertiary structure corresponds to the same position of the enzyme shown herein as SEQ ID No. 16.

In a preferred embodiment, the lipid acyltransferase comprises a pro-peptide or a polypeptide which has lipid acyltransferase activity and comprises an amino acid sequence shown as SEQ ID No. 16 or 68 except for one or more modifications at one or more of the following positions: 27 and/or 31 in combination with at least one further modification.

Suitably, the at least one further modification may be at one or more of the following positions 85, 86, 122, 119, 120, 201, 245, 23, 81, 82, 289, 227, 229, 233, 33, 207 and/or 130, wherein the position numbering is defined as that position which when aligned based on primary or tertiary structure corresponds to the same position of the enzyme shown herein as SEQ ID No. 16.

The lipid acyltransferase may be a pro-peptide which undergoes further post-translational modification to a mature peptide, i.e. a polypeptide which has lipid acyltransferase activity. By way of example only SEQ ID No. 68 is the same as SEQ ID No. 16 except that SEQ ID No. 68 has undergone post-translational and/or post-transcriptional modification to remove some amino acids, more specifically 38 amino acids. Therefore the polypeptide shown herein as SEQ ID No. 16 could be considered in some circumstances (i.e. in some host cells) as a pro-peptide—which is further processed to a mature peptide by post-translational and/or post-transcriptional modification. The precise modifications, e.g. cleavage site(s), in respect of the post-translational and/or post-transcriptional modification may vary slightly depending on host species. In some host species there may be no post translational and/or post-transcriptional modification, hence the pro-peptide would then be equivalent to the mature peptide (i.e. a polypeptide which has lipid acyltransferase activity). Without wishing to be bound by theory, the cleavage site(s) may be shifted by a few residues (e.g. 1, 2 or 3 residues) in either direction compared with the cleavage site shown by reference to SEQ ID No. 68 compared with SEQ ID No. 16. In other words, rather than cleavage at position 235-ATR to position 273 (RRSAS) for example, the cleavage may commence at residue 232, 233, 234, 235, 236, 237 or 238 for example. In addition or alternatively, the cleavage may end at residue 270, 271, 272, 273, 274, 275 or 276 for example. In addition or alternatively, the cleavage may result in the removal of about 38 amino acids, in some embodiments the cleavage may result in the removal of between 30-45 residues, such as 34-42 residues, such as 36-40 residues, preferably 38 residues.

In some embodiments, in order to establish homology to primary structure, the amino acid sequence of a lipid acyltransferase is directly compared to the lipid acyltransferase enzyme shown herein as SEQ ID No. 16 or 68 primary sequence and particularly to a set of residues known to be invariant in all or most lipid acyltransferases for which sequences are known. After aligning the conserved residues, allowing for necessary insertions and deletions in order to maintain alignment (i.e., avoiding the elimination of conserved residues through arbitrary deletion and insertion), the residues equivalent to particular amino acids in the primary sequence of SEQ ID No. 16 or 68 are defined. In preferred embodiments, alignment of conserved residues conserves 100% of such residues. However, alignment of greater than 75% or as little as 50% of conserved residues are also adequate to define equivalent residues. In preferred embodiments, conservation of the catalytic serine and histidine residues are maintained. Conserved residues are used to define the corresponding equivalent amino acid residues of the lipid acyltransferase shown in SEQ ID No. 16 or 68 in other lipid acyltransferases, such as from other Aeromonas species, as well as any other organisms.

In order to align a parent lipid acyltransferase with SEQ ID No. 16 or SEQ ID No. 68 (the reference sequence), sequence alignment such as pairwise alignment can be used (http://www.ebi.ac.uk/emboss/align/index.html). Thereby, the equivalent amino acids in alternative parental lipid acyltransferase polypeptides, which correspond to one or more of the amino acids defined with reference to SEQ ID No. 68 or SEQ ID No. 16 can be determined and modified. As the skilled person will readily appreciate, when using the emboss pairwise alignment, standard settings usually suffice. Corresponding residues can be identified using “needle” in order to make an alignment that covers the whole length of both sequences. However, it is also possible to find the best region of similarity between two sequences, using “water”.

Alternatively, particularly in instances where parent lipid acyltransferase shares low primary sequence homology with SEQ ID No. 16 or SEQ ID No. 68, the corresponding amino acids in alternative parent lipid acyltransferase which correspond to one or more of the amino acids defined with reference to SEQ ID No. 16 or SEQ ID No. 68 can be determined by structural alignment to the structural model of SEQ ID No. 68 or SEQ ID No. 16, preferably SEQ ID No. 68.

Thus, equivalent residues may be defined by determining homology at the level of tertiary structure for a lipid acyltransferase whose tertiary structure has been determined by X-ray crystallography. In this context, “equivalent residues” are defined as those for which the atomic coordinates of two or more of the main chain atoms of a particular amino acid residue of the lipid acyltransferase shown herein as SEQ ID No. 16 or 68 (N on N, CA on CA, C on C, and O on O) are within 0.13 nm and preferably 0.1 nm after alignment. Alignment is achieved after the best model has been oriented and positioned to give the maximum overlap of atomic coordinates of non-hydrogen protein atoms of the lipid acyltransferase in question to the lipid acyltransferase shown herein as SEQ ID No. 16 or 68. As known in the art, the best model is the crystallographic model giving the lowest R factor for experimental diffraction data at the highest resolution available. Equivalent residues which are functionally and/or structurally analogous to a specific residue of the lipid acyltransferase as shown herein as SEQ ID No. 16 or 68 are defined as those amino acids of the lipid acyltransferase that preferentially adopt a conformation such that they either alter, modify or modulate the protein structure, to effect changes in substrate specification, e.g. substrate binding and/or catalysis in a manner defined and attributed to a specific residue of the lipid acyltransferase shown herein as SEQ ID No. 16 or 68. Further, they are those residues of the lipid acyltransferase (in cases where a tertiary structure has been obtained by x-ray crystallography), which occupy an analogous position to the extent that although the main chain atoms of the given residue may not satisfy the criteria of equivalence on the basis of occupying a homologous position, the atomic coordinates of at least two of the side chain atoms of the residue lie with 0.13 nm of the corresponding side chain atoms of the lipid acyltransferase shown herein as SEQ ID No. 16 or 68.

The coordinates of the three dimensional structure of the lipid acyltransferase shown herein as SEQ ID No. 68 (which is a Aeromonas salmonicida lipid acyltransferase comprising an N80D mutation) are described in PCT/IB2009/054535 and find use in determining equivalent residues on the level of tertiary structure.

There is a large insertion in the acyltransferase of Aeromonas salmonicida between the last beta strand and the ASP-X-X_HIS motif when compared to structurally similar E. coli thioesterase. This insertion creates a large cavity (hereinafter referred to as the “cave” that binds the aliphatic chain of the acyl enzyme intermediate. Modulating the sequence and size of this region results in a smaller or larger “cave” or cavity for the aliphatic chain of the acyl enzyme intermediate, i.e., the acyl chain that is transferred by the enzyme. Thus the enzymes of this family may be engineered to preferentially transfer acyl chains of different lengths.

Four insertions are found in the Aeromonas salmonicida lipid acyltransferase relative to the E. coli thioesterase (PDB entry 1IVN) that link common secondary structural elements common to both structures.

The amino acids coordinates of these insertions in the lipid acyltransferase shown here as SEQ ID No. 68 are listed in the Table below:

### Table: Insertions in Lipid Acyltransferase:

| Insertion | Residues |
|---|---|
| Insertion 1 | 22-36 |
| Insertion 2 | 74-88 |
| Insertion 3 | 162-168 |
| Insertion 4 | 213-281 |

As described in detail in PCT/IB2009/054535 in the lipid acyltransferase, there is a large surface for substrate to bind that can be divided into two areas that are separated by Ser 16 and His 291, where Ser 16 and His 291 along with Asp288 form the characteristic catalytic triad. These two areas can be characterized as being a deep channel or “canyon”—hereinafter referred to the “canyon”—leading into an enclosed cavity or “cave” running through the molecule.

The residues forming the canyon are listed in the Table below:

Table: CANYON Residues:

| | |
|---|---|
| Insertion 1 | M23, M27, Y30, L31 |
| Segment 1 | F42, G67, G68 |
| Insertion 2 | D80, P81, K82, Q84, V85, I86 |
| Segment 2a | Y117, A119, Y120 |
| Insertion 4 | G229, Y230, V231 |

The residues forming the cave are listed in table below.

Table: CAVE Residues:

| | |
|---|---|
| Segment 1 | D15, S16, L18 |
| Segment 2 | W111, A114, L115, L118 |
| Segment 3 | P156, D157, L158, Q160, N161 |
| Segment 4 | F206, A207, E208, M209, L210 |
| Segment 5 | M285, F286, V290, H291, P292 V295 |

Segments 3 and 4 precede insertions 3 and 4 respectively, and segment 5 immediately follows insertion 4. Insertions 4 and 5 also contribute to the over enclosure resulting in the cave, thus the cave is different to the canyon in that insertions 1 and 2 form the lining of the canyon while insertions 3 and 4 form the overlaying structure. Insertions 3 and insertion 4 cover the cave.

In one embodiment the lipid acyltransferase for use in the present invention may be altered by modifying the amino acid residues in one or more of the canyon, the cave, the insertion 1, the insertion 2, the insertion 3 or the insertion 4.

In one embodiment the lipid acyltransferase for use in the present invention may be altered by modifying the amino acid residues in one or more of the canyon, insertion 1 or insertion 2.

In one embodiment, the dimensions of the acyl chain binding cavity of a lipid acyltransferase may be altered by making changes to the amino acid residues that form the larger cave. This may be done by modulating the size the regions that link the common features of secondary structure as discussed above. In particular, the size of the cave may be altered by changing the amino acids in the region between the last (fifth) beta strand of the enzyme and the Asp-X-X-His motif that forms part of the catalytic triad.

The substrate chain length specificity determining segment of a lipid acyltransferase is a region of contiguous amino acids that lies between the β5 β-strand of the enzyme and the Asp residue of the catalytic triad of that enzyme (the Asp residue being part of the Asp-Xaa-Xaa-His motif).

The tertiary structures of the Aeromonas salmonicida lipid acyltransferase and the E. coli thioesterase (deposited as NCBI's Genbank database as accession number 1IVN_A; GID:33357066) each showing a signature three-layer alpha/beta/alpha structure, where the beta-sheets are composed of five parallel strands allow the substrate chain length specificity determining segments of each of the lipid acyltransferase enzymes to be determined.

The substrate chain length specificity determining segment of the Aeromonas salmonicida lipid acyltransferase lies immediately N-terminal to the Asp residue of the catalytic triad of the enzyme. However, the length of the substrate chain length specificity determining segment may vary according to the distance between the Asp residue and the β5 β-strand of the enzyme. For example, the substrate chain length specificity determining segments of the lipid acyltransferase are about 13 amino, 19 amino acids and about 70 amino acids in length, respectively. As such, depending on the lipid acyltransferase, a substrate chain length specificity determining segment may be in the range of 10 to 70 amino acids in length, e.g., in the range of 10 to 30 amino acids in length, 30 to 50 amino acids in length, or 50 to 70 amino acids.

The Table below provides an exemplary sequence for the substrate chain length specificity determining segment of the lipid acyltransferase enzyme.

| A. salmonicida lipid acyltransferase | |
|---|---|
| (GCAT) | |
| AEMLRDPQNFGLSDVENPCYDGGYVWKPFATRSV | SEQ ID |
| STDRQLSASPQERLAIAGNPLLAQAVASPMARRSA | No. 124 |
| SPLNCEGKMF | |

In certain embodiments, the amino acid sequence of a substrate chain length specificity determining segment may or may not be the amino acid sequence of a wild-type enzyme. In certain embodiments, the substrate chain length specificity determining segment may have an amino acid sequence that is at least 70%, e.g., at least 80%, at least 90% or at least 95% identical to the substrate chain length specificity determining segment of a wild type lipid acyltransferase.

Suitably the variant enzyme may be prepared using site directed mutagenesis.

Preferred modifications are located at one or more of the following positions L031, I086, M027, V085, A119, Y120, W122, E201, F235, W232, A236, and/or Q245.

In particular key modifications include one or more of the following modifications: L31Q, H, N, T, F, Y or C (preferably L31 Q); M27R, G, H, K, Y, D, N, V, C, Q, L, E, S or F (preferably M27V); V85H, R, D or E; II86R, Y, S, V, I, A, T, M, F, C or L (preferably I86S or A); A119T or I; Y120K or E; W122S, L or A (preferably W122L); E201R; Q245S; F235A or V; W232G or S; and/or A236G or E.

In one embodiment when the at least one modification is made in the canyon the modification(s) are made at one or more of the following positions: 31, 27, 85, 86, 119, 120.

In particular key modifications in the canyon include one or more of the following modifications: L31Q, H, N, T, F, Y or C (preferably L31 Q); M27R, G, H, K, Y, D, N, V, C, Q, L, E, S or F (preferably M27V); V85H, R, D or E; I86R, Y, S, V, I, A, T, M, F, C or L (preferably I86S or A); A119T or I; Y120K or E, which may be in combination with one another and/or in combination with a further modification.

In one embodiment preferably when the modification is made in insertion site 1 the modifications are made at one or more positions 31 and/or 27. Suitably the modifications may be L31Q, H, N, T, F, Y or C (preferably L31 Q) and/or M27R, G, H, K, Y, D, N, V, C, Q, L, E, S or F (preferably M27V).

In one embodiment preferably when the modification is made in insertion site 2 the modifications are made at positions are 085, 086. Suitably the modifications may be V85H, R, D or E and/or I86R, Y, S, V, I, A, T, M, F, C or L.

In one embodiment preferably when the modification is made in insertion site 4 the modifications are made at position 245. Suitably the modification may be Q245S.

In one embodiment preferably the modification is made in at least insertion site 1.

In another embodiment preferably a modification is made in at least insertion site 1 in combination with a further modification in insertion site 2 and/or 4 and/or at one or more of the following positions 119, 120, 122, 201, 77, 130, 82, 120, 207, 167, 227, 215, 230, 289.

In a further embodiment preferably a modification is made in at least the canyon region in combination with a further modification in insertion site 4 and/or at one or more of the following positions 122, 201, 77, 130, 82, 120, 207, 167, 227, 215, 230, 289.

Preferred modifications are given for particular site:

### R130R, V, Q, H, A, D, L, I, K, N, C, Y, G, S, F, T or M;

### K82R, N, H, S, L, E, T, M or G;

### G121S, R, G, E, K, D, N, V, Q or A;

### Y74Y or W;

### Y83 F or P;

### I77T, M, H, Q, S, C, A, E, L, Y, F, R or V;

### A207E;

### Q167T, H, I, G, L or M;

### D227L, C, S, E, F, V, I, T, Y, P, G, R, D, H or A;

### N215G;

### Y230A, G, V, R, I, T, S, N, H, E, D, Q, K; or

### N289P.

In combination with one or more modifications at positions 31, 27, 85, 86, 119, 120, 122, 201, 245, 235, 232, and/or 236 (for example the modification may be one or more of the following: L31Q, H, N, T, F, Y or C (preferably L31 Q); M27R, G, H, K, Y, D, N, V, C, Q, L, E, S or F (preferably M27V); V85H, R, D or E; I86R, Y, S, V, I, A, T, M, F, C or L (preferably I86S or A); A119T or I; Y120K or E; W122S, L or A (preferably W122L); E201R; Q245S; F235A or V; W232G or S; and/or A236G or E) suitably the variant lipid acyltransferase may be additionally modified at one or more of the following positions 130, 82, 121, 74, 83, 77, 207, 167, 227, 215, 230, 289 (for example the additional modification may be one or more of the following: R130R, V, Q, H, A, D, L, I, K, N, C, Y, G, S, F, T or M; K82R, N, H, S, L, E, T, M or G; G121S, R, G, E, K, D, N, V, Q or A; Y74Y or W; Y83 F or P; I77T, M, H, Q, S, C, A, E, L, Y, F, R or V; A207E; Q167T, H, I, G, L or M; D227L, C, S, E, F, V, I, T, Y, P, G, R, D, H or A; N215G; Y230A, G, V, R, I, T, S, N, H, E, D, Q, K; and/or N289P), preferably the variant lipid acyltransferase may be additionally modified at at least one or more of the following positions: 130, 82, 77 or 227.

For the avoidance of doubt the lipid acyltransferase backbone when aligned (on a primary or tertiary basis) with the lipid acyltransferase enzyme shown herein as SEQ ID No. 16 preferably has D in position 80. We have therefore shown in many of the combinations taught herein N80D as a modification. If N80D is not mentioned as a suitable modification and the parent backbone does not comprise D in position 80, then an additional modification of N80D should be incorporated into the variant lipid acyltransferase to ensure that the variant comprises D in position 80.

When the backbone or parent lipid acyltransferase already contains the N80D modification, the other modifications can be expressed without referencing the N80D modification, i.e. L31Q, N80D, W122L could have been expressed as L31Q, W122L for example.

However, it is important to note that the N80D modification is a preferred modification and a backbone enzyme or parent enzyme is preferably used which already possesses amino acid D in position 80. If, however, a backbone is used which does not contain amino acid D in position (such as one more of the lipid acyltransferases shown here as SEQ ID No. 1, 3, 4, 15, 34, or 35 for instance) then preferably an additional modification of N80D is included.

Suitably, the substitution at position 31 identified by alignment of the parent sequence with SEQ ID No. 68 or SEQ ID No. 16 may be a substitution to an amino acid residue selected from the group consisting of: Q, H, Y and F, preferably Q.

Suitably, the variant polypeptide comprises one or more further modification(s) at any one or more of amino acid residue positions: 27, 77, 80, 82, 85, 85, 86, 121, 122, 130, 167, 207, 227, 230 and 289, which position is identified by alignment of the parent sequence with SEQ ID No. 68. Suitably, at least one of the one or more further modification(s) may be at amino acid residue position: 86, 122 or 130, which position is identified by alignment of the parent sequence with SEQ ID No. 68.

Suitably, the variant lipid acyltransferase comprises one or more of the following further substitutions: I86 (A, C, F, L, M, S, T, V, R, I or Y); W122 (S, A, F, W, C, H, L, M, R or Y); R130A, C, D, G, H, I, K, L, M, N, Q, T, V, R, F or Y); or any combination thereof.

The variant lipid acyltransferase may comprise one of the following combinations of modifications (where the parent back bone already comprises amino acid D in position 80, the modification can be expressed without reference to N80D):
L31Q, N80D, I86S, W122F
L31Q, N80D, W122L
L31Q, N80D, I86V, W122L
L31Q, N80D, I86I, W122L
L31Q, N80D, I86S, R130R
L31Q, N80D, K82R, I86A
L31Q, N80D, I86S, W122W
L31Q, N80D, I86S, W122Y
M27V, L31Q, N80D
L31Q, N80D, I86A, W122L
L31Q, N80D, W122L
L31Q, N80D, I86S, G121S
L31Q, N80D, I86S
L31Q, N80D, K82R, I86S
L31Q, N80D, I86S, W122L, R130Y
L31Q, N80D, I86S, W122L, R130V
L31Q, N80D, I86S
L31Q, N80D, I86T, W122L
L31Q, N80D, I86S, W122L
L31Q, N80D, W122L, R130Q
L31Q, N80D, I86S, W122L, R130R
L31Q, N80D, I86S
L31Q, N80D, G121R
L31Q, N80D, I86A
M27C, L31Q, N80D
M27Q, L31Q, N80D
L31Q, N80D, G121S
L31Q, N80D, I86S, W122R
L31Q, N80D, R130Q
L31Q, N80D, I86S, W122H
L31Q, N80D, I86M, W122L
L31Q, N80D, R130N
L31Q, N80D, I86S, W122L
L31Q, N80D, K82N
L31Q, N80D, I86S, W122M
L31Q, N80D, W122L
L31Q, N80D, K82H
L31Q, N80D, R130H
L31Q, N80D, R130A
L31Q, N80D, G121S
L31Q, N80D, I86S, W122L, R130D
L31Q, N80D, I86M
L31Q, Y74Y, N80D
L31Q, N80D, R130L
L31Q, N80D, Y83F
L31Q, N80D, K82S
L31Q, I77T, N80D
L31Q, N80D, I86S, W122L, R130I
L31Q, N80D, I86S, W122L
L31Q, N80D, I86F, W122L
M27N, L31Q, N80D
L31Q, N80D, Y83P
L31Q, N80D, R130K
L31Q, N80D, K82R, I86S, W122L
L31Q, N80D, K82L
L31Q, N80D, I86S, G121G
L31Q, N80D, I86A, R130Q
M27H, L31Q, N80D
L31Q, N80D, W122L, A207E
L31Q, N80D, W122L, R130L
L31Q, N80D, K82E
L31Q, N80D, G121E
L31Q, N80D, W122L, R130R
L31Q, I77M, N80D
L31Q, N80D, K82T
L31Q, N80D, W122L
L31Q, N80D, W122H
L31Q, N80D, Q167T
L31Q, I77H, N80D
L31Q, N80D, G121K
L31Q, I77Q, N80D
L31Q, N80D, W122L, R130N
L31Q, N80D, W122L
L31Q, N80D, G121D
L31Q, N80D, R130T
L31Q, N80D, R130T
L31Q, N80D, K82M
L31Q, N80D, Q167H
L31Q, N80D, I86T
L31Q, N80D, Q1671
L31Q, N80D, I86C
L31Q, N80D, Q167G
M27L, L31Q, N80D
L31Q, N80D, I86S, G121R
L31Q, I77S, N80D
L31Q, I77C, N80D
L31Q, N80D, G121N
L31Q, I77A, N80D
L31Q, N80D, R130M
L31Q, N80D, W122F
M27G, L31Q, N80D
L31Q, N80D, K82G
L31Q, N80D, I86S, W122L, R130K
L31Q, N80D, R130A
L31Q, N80D, I86I
L31Q, I77E, N80D
L31Q, N80D, D227L
L31Q, N80D, V85H, N215G
L31Q, N80D, I86A, W122L, R130N
L31Q, I77R, N80D
L31Q, N80D, I86F
L31Q, N80D, I86Y, W122L
M27K, L31Q, N80D
L31Q, N80D, D227C
L31Q, N80D, R130L
L31Q, N80D, I86C, W122L
L31Q, N80D, Q167L
L31Q, N80D, V85H
L31Q, N80D, Q167M
M27D, L31Q, N80D
L31Q, N80D, I86L
L31Q, N80D, Y230A
L31Q, N80D, W122R
L31Q, N80D, Y230G
L31Q, N80D, D227S
L31Q, N80D, W122L, A207E, N289P
L31Q, N80D, W122Y
L31Q, N80D, I86L, W122L
L31Q, N80D, K82R, I86S, G121S, R130Q
L31Q, Y74W, N80D
L31Q, N80D, R130F
L31Q, N80D, G121V
L31Q, N80D, W122L, R130M
L31Q, N8013, R130V
L31Q, N80D, Y230V
L31Q, N80D, N215G
L31Q, N80D, I86S, W122L, R130N
L31Q, N80D, Y230R
M27E, L31Q, N80D
L31Q, N80D, Y2301
L31Q, N80D, I86S, W122L, R130S
L31Q, N80D, K82R
L31Q, N80D, D227E
L31Q, N80D, K82R, I86A, G121S
L31Q, N80D, R130G
L31Q, I77V, N80D
L31Q, N80D, G121G
L31Q, N80D, Y230T
L31Q, N80D, K82R, I86S, R130N
L31Q, N80D, D227F
L31Q, N80D, I86A, G121R
L31Q, N80D, I86S, R130N
L31Q, N80D, W122C
L31Q, N80D, Y230S
L31Q, N80D, R130Y
L31Q, N80D, R130C
L31Q, I77L, N80D
A119T, N80D
A199A, N80D
G67A, N80D, V85H
   wherein said positions are identified by alignment of the parent sequence with SEQ ID No. 68 or SEQ ID No. 16.

Suitably, the variant lipid acyltransferase may be identical to the parent lipid acyltransferase except for a modification at position 31 and, optionally, one or more further modification(s) at any one or more of amino acid residue positions: 27, 77, 80, 82, 85, 85, 86, 121, 122, 130, 167, 207, 227, 230 and 289, which position is identified by alignment of the parent sequence with SEQ ID No. 68 or SEQ ID No. 16.

Suitably, the variant lipid acyltransferase may be identical to the parent lipid acyltransferase except for a modification at position 31 and, optionally, one or more further modification(s) at any one or more of amino acid residue positions: 86, 122 or 130, which position is identified by alignment of the parent sequence with SEQ ID No. 68 or SEQ ID No. 16.

In one embodiment, where the parent sequence is SEQ ID No. 16 or SEQ ID No. 68 or where the parent sequence is encoded by SEQ ID No. 49 or SEQ ID No. 120, the variant polypeptide has any one of the modifications as detailed above, except for a modification at position 80. In this regard, SEQ ID No. 16, SEQ ID No. 68 or a polypeptide encoded by SEQ ID No. 49 or SEQ ID No. 120 will already have aspartic acid at position 80, when said positions are identified by alignment of the parent sequence with SEQ ID No. 16.

Suitably, the variant lipid acyltransferase or the variant lipid acyltransferase obtainable by a method according to the present invention may have at least 75% identity to the parent lipid acyltransferase, suitably the variant lipid acyltransferase may have at least 75% or at least 80% or at least 85% or at least 90% or at least 95% or at least 98% identity to the parent lipid acyltransferase.

The present invention also relates to a variant polypeptide having lipid acyltransferase activity, wherein the variant comprises a modification at at least position 31 compared to a parent lipid acyltransferase, wherein position 31 is identified by alignment with SEQ ID No. 68 or SEQ ID No. 16.

In one embodiment preferably the variant lipid acyltransferase has the following modifications and/or the following modifications are made in the methods of the present invention:
L31Q, N80D, W122L (which can be expressed as L31Q, W122L where the backbone enzyme already has D in position 80);
M27V, L31Q, N80D (which can be expressed as N27V, L31Q where the backbone enzyme already has D in position 80);
L31Q, N80D, K82R, I86A (which can be expressed as L31Q, K82R, I86A where the backbone enzyme already has D in position 80); and/or
L31Q, N80D, I86S, W122F (which can be expressed as L31Q, I86S, W122F where the backbone enzyme already has D in position 80).

### Improved Properties

The variant lipid acyltransferase for use in the present invention have at least one improved property compared with a parent (i.e. backbone) or unmodified lipid acyltransferase.

The term “improved property” as used herein may include a) an altered substrate specificity of the lipid acyltransferase, for instance and by way of example only i) an altered ability of the enzymes to use certain compounds as acceptors, for example an improved ability to utilise a carbohydrate as an acceptor molecule thus improving the enzymes ability to produce a carbohydrate ester) or ii) an altering ability to use saturated or unsaturated fatty acids as a substrate or iii) a changed specificity such that the variant lipid acyltransferase preferentially utilises the fatty acid from the Sn1 or Sn2 position of a lipid substrate or iv) an altered substrate chain length specificity of in the variant enzyme; b) altered kinetics of the enzyme; and/or c) lowered ability of the variant lipid acyltransferase to carry out a hydrolysis reaction whilst maintaining or enhancing the enzymes ability to carry out an acyl transferase reaction.

Other improved properties may be for example related to improvements and/or changes in pH and/or temperature stability, and/or detergent and/or oxidative stability.

Indeed, it is contemplated that enzymes having various degrees of stability in one or more of these characteristics (pH, temperature, proteolytic stability, detergent stability, and/or oxidative stability) can be prepared in accordance with the present invention.

Characterization of wild-type (e.g. parent lipid acyltransferase) and mutant (e.g. variant lipid acyltransferase) proteins is accomplished via any means suitable and is preferably based on the assessment of properties of interest.

In some embodiments the variant enzyme of the present invention, when compared with the parent enzyme, may have an increased transferase activity and either the same or less hydrolytic activity. In other words, suitably the variant enzyme may have a higher transferase activity to hydrolytic activity (e.g. transferase:hydrolysis activity) compared with the parent enzyme. Suitably, the variant enzyme may preferentially transfer an acyl group from a lipid (including phospholipid, galactolipid or triacylglycerol) to an acyl acceptor rather than simply hydrolysing the lipid.

Suitably, the lipid acyltransferase for use in the invention may be a variant with enhanced enzyme activity on polar lipids, preferably phospholipids and/or glycolipids, when compared to the parent enzyme. Preferably, such variants also have low or no activity on lyso-polar lipids. The enhanced activity on polar lipids, preferably phospholipids and/or glycolipids, may be the result of hydrolysis and/or transferase activity or a combination of both. Preferably the enhanced activity on polar lipids in the result of transferase activity.

Variant lipid acyltransferases for use in the invention may have decreased activity on triglycerides, and/or monoglycerides and/or diglycerides compared with the parent enzyme.

Suitably the variant enzyme may have no activity on triglycerides and/or monoglycerides and/or diglycerides.

### Definition of Sets

### Amino Acid Set 1:

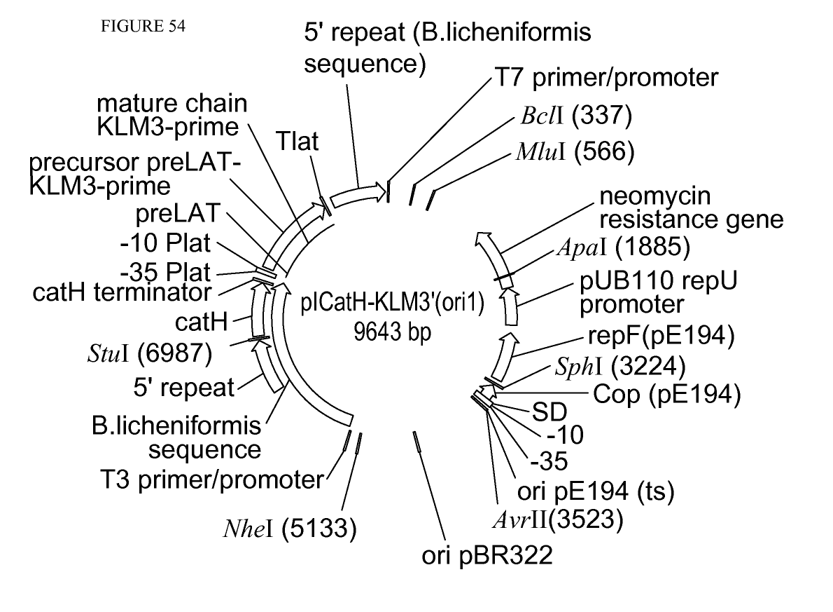

Amino acid set 1 (note that these are amino acids in 1IVN—FIG. 53 and FIG. 54) Gly8, Asp9, Ser10, Leu11, Ser12, Tyr15, Gly44, Asp45, Thr46, Glu69, Leu70, Gly71, Gly72, Asn73, Asp74, Gly75, Leu76, Gln106, Ile107, Arg108, Leu109, Pro110, Tyr113, Phe121, Phe139, Phe140, Met141, Tyr145, Met151, Asp154, His157, Gly155, Ile156, Pro158

The highly conserved motifs, such as GDSx and catalytic residues, were deselected from set 1 (residues underlined). For the avoidance of doubt, set 1 defines the amino acid residues within 10A of the central carbon atom of a glycerol in the active site of the 1IVN model.

### Amino Acid Set 2:

Amino acid set 2 (note that the numbering of the amino acids refers to the amino acids in the P10480 mature sequence)

Leu17, Lys22, Met23, Gly40, Asn80, Pro81, Lys82, Asn87, Asn88, Trp111, Val112, Ala114, Tyr117, Leu118, Pro156, Gly159, Gln160, Asn161, Pro162, Ser163, Ala164, Arg165, Ser166, Gln167, Lys168, Val169, Val170, Glu171, Ala172, Tyr179, His180, Asn181, Met209, Leu210, Arg211, Asn215, Lys284, Met285, Gln289 and Val290.

Selected residues in Set 1 compared with Set 2 are shown in Table 1.

TABLE 1

| | |
|---|---|
| IVN model | P10480 |

| | |
|---|---|
| A. hyd homologue | Mature sequence Residue |

| IVN | PFAM | Structure | Number |
|---|---|---|---|
| Gly8 | Gly32 | | |
| Asp9 | Asp33 | | |
| Ser10 | Ser34 | | |
| Leu11 | Leu35 | | Leu 17 |
| Ser12 | Ser36 | | Ser18 |
| | | | Lys22 |
| | | | Met23 |
| Tyr15 | Gly58 | | Gly40 |
| Gly44 | Asn98 | | Asn80 |
| Asp45 | Pro99 | | Pro81 |
| Thr46 | Lys100 | | Lys82 |
| | | | Asn87 |
| | | | Asn88 |
| Glu69 | Trp129 | | Trp111 |
| Leu70 | Val130 | | Val112 |
| Gly71 | Gly131 | | |
| Gly72 | Ala132 | | Ala114 |
| Asn73 | Asn133 | | |
| Asp74 | Asp134 | | |
| Gly75 | Tyr135 | | Tyr117 |
| Leu76 | Leu136 | | Leu118 |
| Gln106 | | Pro174 | Pro156 |
| Ile107 | | Gly177 | Gly159 |
| Arg108 | | Gln178 | Gln160 |
| Leu109 | | Asn179 | Asn161 |
| Pro110 | | 180 to 190 | Pro162 |
| Tyr113 | | | Ser163 |
| | | | Ala164 |
| | | | Arg165 |
| | | | Ser166 |
| | | | Gln167 |
| | | | Lys168 |
| | | | Val169 |
| | | | Val170 |
| | | | Glu171 |
| | | | Ala172 |
| Phe121 | His198 | Tyr197 | Tyr179 |
| | | His198 | His180 |
| | | Asn199 | Asn181 |
| Phe139 | Met227 | | Met209 |
| Phe140 | Leu228 | | Leu210 |
| Met141 | Arg229 | | Arg211 |
| Tyr145 | Asn233 | | Asn215 |
| | | | Lys284 |
| Met151 | Met303 | | Met285 |
| Asp154 | Asp306 | | |
| Gly155 | Gln307 | | Gln289 |
| Ile156 | Val308 | | Val290 |
| His157 | His309 | | |
| Pro158 | Pro310 | | |

### Amino Acid Set 3:

Amino acid set 3 is identical to set 2 but refers to the Aeromonas salmonicida (SEQ ID No. 35) coding sequence, i.e. the amino acid residue numbers are 18 higher in set 3 as this reflects the difference between the amino acid numbering in the mature protein (SEQ ID No. 35) compared with the protein including a signal sequence (SEQ ID No. 4).

The mature proteins of Aeromonas salmonicida GDSX (SEQ ID No. 35) and Aeromonas hydrophila GDSX (SEQ ID No. 34) differ in five amino acids. These are Thr3Ser, LYS182Gln, Glu309Ala, Thr310Asn, and Gly318-, where the salmonicida residue is listed first and the hydrophila residue is listed last. The hydrophila protein is only 317 amino acids long and lacks a residue in position 318. The Aeromonas salmonicida GDSX has considerably high activity on polar lipids such as galactolipid substrates than the Aeromonas hydrophila protein. Site scanning was performed on all five amino acid positions.

### Amino Acid Set 4:

Amino acid set 4 is S3, Q182, E309, S310, and −318.

### Amino Acid Set 5:

F13S, D15N, S18G, S18V, Y30F, D116N, D116E, D157 N, Y226F, D228N Y230F.

### Amino Acid Set 6:

Amino acid set 6 is Ser3, Leu17, Lys22, Met23, Gly40, Asn80, Pro81, Lys82, Asn 87, Asn88, Trp111, Val112, Ala114, Tyr117, Leu118, Pro156, Gly159, Gln160, Asn161, Pro162, Ser163, Ala164, Arg165, Ser166, Gln167, Lys168, Val169, Val170, Glu171, Ala172, Tyr179, His180, Asn181, Gln182, Met209, Leu210, Arg211, Asn215, Lys284, Met285, Gln289, Val290, Glu309, Ser310, −318.

The numbering of the amino acids in set 6 refers to the amino acids residues in P10480 (SEQ ID No. 3)—corresponding amino acids in other sequence backbones can be determined by homology alignment and/or structural alignment to P10480 and/or 1IVN.

### Amino Acid Set 7:

Amino acid set 7 is Ser3, Leu17, Lys22, Met23, Gly40, Asn80, Pro81, Lys82, Asn 87, Asn88, Trp111, Val112, Ala114, Tyr117, Leu118, Pro156, Gly159, Gln160, Asn161, Pro162, Ser163, Ala164, Arg165, Ser166, Gln167, Lys168, Val169, Val170, Glu171, Ala172, Tyr179, His180, Asn181, Gln182, Met209, Leu210, Arg211, Asn215, Lys284, Met285, Gln289, Val290, Glu309, Ser310, −318, Y30X (where X is selected from A, C, D, E, G, H, I, K, L, M, N, P, Q, R, S, T, V, or W), Y226X (where X is selected from A, C, D, E, G, H, I, K, L, M, N, P, Q, R, S, T, V, or W), Y230X (where X is selected from A, C, D, E, G, H, I, K, L, M, N, P, Q, R, S, T, V, or W), S18X (where X is selected from A, C, D, E, F, H, I, K, L, M, N, P, Q, R, T, W or Y), D157X (where X is selected from A, C, E, F, G, H, I, K, L, M, P, Q, R, S, T, V, W or Y).

The numbering of the amino acids in set 7 refers to the amino acids residues in P10480 (SEQ ID No. 3)—corresponding amino acids in other sequence backbones can be determined by homology alignment and/or structural alignment to P10480 and/or 1IVN).

Suitably, the variant enzyme comprises one or more of the following amino acid modifications compared with the parent enzyme:

### S3E, A, G, K, M, Y, R, P, N, T or G

E309Q, R or A, preferably Q or R
−318Y, H, S or Y, preferably Y.

Preferably, X of the GDSX motif is L. Thus, preferably the parent enzyme comprises the amino acid motif GDSL.

Suitably, said first parent lipid acyltransferase may comprise any one of the following amino acid sequences: SEQ ID No. 34, SEQ ID No. 3, SEQ ID No. 4, SEQ ID No. 5, SEQ ID No. 6, SEQ ID No. 7, SEQ ID No. 8, SEQ ID No. 9, SEQ ID No. 10, SEQ ID No. 11, SEQ ID No. 12, SEQ ID No. 13, SEQ ID No. 14, SEQ ID No. 1, SEQ ID No. 15, SEQ ID No. 25, SEQ ID No. 26, SEQ ID No. 27, SEQ ID No. 28, SEQ ID No. 29, SEQ ID No. 30, SEQ ID No. 32, SEQ ID No. 33 or SEQ ID No. 35.

Suitably, said second related lipid acyltransferase may comprise any one of the following amino acid sequences: SEQ ID No. 3, SEQ ID No. 34, SEQ ID No. 4, SEQ ID No. 5, SEQ ID No. 6, SEQ ID No. 7, SEQ ID No. 8, SEQ ID No. 9, SEQ ID No. 10, SEQ ID No. 11, SEQ ID No. 12, SEQ ID No. 13, SEQ ID No. 14, SEQ ID No. 1, SEQ ID No. 15, SEQ ID No. 25, SEQ ID No. 26, SEQ ID No. 27, SEQ ID No. 28, SEQ ID No. 29, SEQ ID No. 30, SEQ ID No. 32, SEQ ID No. 33 or SEQ ID No. 35.

The variant enzyme must comprise at least one amino acid modification compared with the parent enzyme. In some embodiments, the variant enzyme may comprise at least 2, preferably at least 3, preferably at least 4, preferably at least 5, preferably at least 6, preferably at least 7, preferably at least 8, preferably at least 9, preferably at least 10 amino acid modifications compared with the parent enzyme.

When referring to specific amino acid residues herein the numbering is that obtained from alignment of the variant sequence with the reference sequence shown as SEQ ID No. 34 or SEQ ID No. 35.

In one aspect preferably the variant enzyme comprises one or more of the following amino acid substitutions:

S3A, C, D, E, F, G, H, I, K, L, M, N, P, Q, R, T, V, W, or Y; and/or
L17A, C, D, E, F, G, H, I, K, M, N, P, Q, R, S, T, V, W, or Y; and/or
S18A, C, D, E, F, H, I, K, L, M, N, P, Q, R, T, W, or Y; and/or
K22A, C, D, E, F, G, H, I, L, M, N, P, Q, R, S, T, V, W, or Y; and/or
M23A, C, D, E, F, G, H, I, K, L, N, P, Q, R, S, T, V, W, or Y; and/or
Y30A, C, D, E, G, H, I, K, L, M, N, P, Q, R, S, T, V, or W; and/or
G40A, C, D, E, F, H, I, K, L, M, N, P, Q, R, S, T, V, W, or Y; and/or
N80A, C, D, E, F, G, H, I, K, L, M, P, Q, R, S, T, V, W, or Y; and/or
P81A, C, D, E, F, G, H, I, K, L, M, N, Q, R, S, T, V, W, or Y; and/or
K82A, C, D, E, F, G, H, I, L, M, N, P, Q, R, S, T, V, W, or Y; and/or
N87A, C, D, E, F, G, H, I, K, L, M, P, Q, R, S, T, V, W, or Y; and/or
N88A, C, D, E, F, G, H, I, K, L, M, P, Q, R, S, T, V, W, or Y; and/or
W111A, C, D, E, F, G, H, I, K, L, M, N, P, Q, R, S, T, V, W or Y; and/or
V112A, C, D, E, F, G, H, I, K, L, M, N, P, Q, R, S, T, W, or Y; and/or
A114C, D, E, F, G, H, I, K, L, M, N, P, Q, R, S, T, V, W, or Y; and/or
Y117A, C, D, E, F, G, H, I, K, L, M, N, P, Q, R, S, T, V, or W; and/or
L118A, C, D, E, F, G, H, I, K, M, N, P, Q, R, S, T, V, W, or Y; and/or
P156A, C, D, E, F, G, H, I, K, L, M, N, Q, R, S, T, V, W, or Y; and/or
D157A, C, E, F, G, H, I, K, L, M, P, Q, R, S, T, V, W, or Y; and/or
G159A, C, D, E, F, H, I, K, L, M, N, P, Q, R, S, T, V, W, or Y; and/or
Q160A, C, D, E, F, G, H, I, K, L, M, N, P, R, S, T, V, W, or Y; and/or
N161A, C, D, E, F, G, H, I, K, L, M P, Q, R, S, T, V, W, or Y; and/or
P162A, C, D, E, F, G, H, I, K, L, M, N, Q, R, S, T, V, W, or Y; and/or
S163A, C, D, E, F, G, H, I, K, L, M, N, P, Q, R, T, V, W, or Y; and/or
A164C, D, E, F, G, H, I, K, L, M, N, P, Q, R, S, T, V, W, or Y; and/or
R165A, C, D, E, F, G, H, I, K, L, M, N, P, Q, S, T, V, W, or Y; and/or
S166A, C, D, E, F, G, H, I, K, L, M, N, P, Q, R, T, V, W, or Y; and/or
Q167A, C, D, E, F, G, H, I, K, L, M, N, P, R, S, T, V, W, or Y; and/or
K168A, C, D, E, F, G, H, I, L, M, N, P, Q, R, S, T, V, W, or Y; and/or
V169A, C, D, E, F, G, H, I, K, L, M, N, P, Q, R, S, T, W, or Y; and/or
V170A, C, D, E, F, G, H, I, K, L, M, N, P, Q, R, S, T, W, or Y; and/or
E171A, C, D, F, G, H, I, K, L, M, N, P, Q, R, S, T, V, W, or Y; and/or
A172C, D, E, F, G, H, I, K, L, M, N, P, Q, R, S, T, V, W, or Y; and/or
Y179A, C, D, E, F, G, H, I, K, L, M, N, P, Q, R, S, T, V, or W; and/or
H180A, C, D, E, F, G, I, K, L, M, P, Q, R, S, T, V, W, or Y; and/or
N181A, C, D, E, F, G, H, I, K, L, M, P, Q, R, S, T, V, W, or Y; and/or
Q182A, C, D, E, F, G, H, I, K, L, M, N, P, R, S, T, V, W, or Y, preferably K; and/or
M209A, C, D, E, F, G, H, I, K, L, N, P, Q, R, S, T, V, W, or Y; and/or
L210 A, C, D, E, F, G, H, I, K, M, N, P, Q, R, S, T, V, W, or Y; and/or
R211 A, C, D, E, F, G, H, I, K, L, M, N, P, Q, R, S, T, V, W, or Y; and/or
N215 A, C, D, E, F, G, H, I, K, L, M, N, P, Q, R, S, T, V, W, or Y; and/or
Y226A, C, D, E, G, H, I, K, L, M, N, P, Q, R, S, T, V, or W; and/or
Y230A, C, D, E, G, H, I, K, L, M, N, P, Q, R, S, T, V or W; and/or
K284A, C, D, E, F, G, H, I, L, M, N, P, Q, R, S, T, V, W, or Y; and/or
M285A, C, D, E, F, G, H, I, K, L, N, P, Q, R, S, T, V, W, or Y; and/or
Q289A, C, D, E, F, G, H, I, K, L, M, N, P, R, S, T, V, W, or Y; and/or
V290A, C, D, E, F, G, H, I, K, L, M, N, P, Q, R, S, T, W, or Y; and/or
E309A, C, D, F, G, H, I, K, L, M, N, P, Q, R, S, T, V, W, or Y; and/or

### S310A, C, D, E, F, G, H, I, K, L, M, N, P, Q, R, T, V, W, or Y.

In addition or alternatively thereto there may be one or more C-terminal extensions. Preferably the additional C-terminal extension is comprised of one or more aliphatic amino acids, preferably a non-polar amino acid, more preferably of I, L, V or G. Thus, the present invention further provides for a variant enzyme comprising one or more of the following C-terminal extensions: 3181, 318L, 318V, 318G.

Preferred variant enzymes may have a decreased hydrolytic activity against a phospholipid, such as phosphatidylcholine (PC), may also have an increased transferase activity from a phospholipid.

Preferred variant enzymes may have an increased transferase activity from a phospholipid, such as phosphatidylcholine (PC), these may also have an increased hydrolytic activity against a phospholipid.

Modification of one or more of the following residues may result in a variant enzyme having an increased absolute transferase activity against phospholipid:

S3, D157, S310, E309, Y179, N215, K22, Q289, M23, H180, M209, L210, R211, P81, V112, N80, L82, N88; N87

Specific preferred modifications which may provide a variant enzyme having an improved transferase activity from a phospholipid may be selected from one or more of the following:

S3A, C, D, E, F, G, H, I, K, L, M, N, P, Q, R, T, V, W or Y; preferably N, E, K, R, A, P or M, most preferably S3A
D157A, C, E, F, G, H, I, K, L, M, N, P, Q, R, S, T, V, W or Y; preferably D157S, R, E, N, G, T, V, Q, K or C
S310A, C, D, E, F, G, H, I, K, L, M, N, P, Q, R, T, V, W or Y; preferably S310T −318 E
E309A, C, D, E, F, G, H, I, K, L, M, N, P, Q, R, T, V, W or Y; preferably E309 R, E, L, R or A
Y179A, C, D, E, F, G, H, I, K, L, M, N, P, Q, R, S, T, V or W; preferably Y179 D, T, E, R, N, V, K, Q or S, more preferably E, R, N, V, K or Q
N215A, C, D, E, F, G, H, I, K, L, M, P, Q, R, S, T, V, W or Y; preferably N215 S, L, R or Y
K22A, C, D, E, F, G, H, I, L, M, N, P, Q, R, S, T, V, W or Y; preferably K22 E, R, C or A
Q289A, C, D, E, F, G, H, I, K, L, M, N, P, R, S, T, V, W or Y; preferably Q289 R, E, G, P or N
M23A, C, D, E, F, G, H, I, K, L N, P, Q, R, S, T, V, W or Y; preferably M23 K, Q, L, G, T or S
H180A, C, D, E, F, G, I, K, L, M, P, Q, R, S, T, V, W or Y; preferably H180 Q, R or K
M209 A, C, D, E, F, G, H, I, K, L, N, P, Q, R, S, T, V, W or Y; preferably M209 Q, S, R, A, N, Y, E, V or L
L210A, C, D, E, F, G, H, I, K, M, N, P, Q, R, S, T, V, W or Y; preferably L210 R, A, V, S, T, I, W or M
R211A, C, D, E, F, G, H, I, K, L, M, N, P, Q, S, T, V, W or Y; preferably R211T
P81A, C, D, E, F, G, H, I, K, L, M, N, Q, R, S, T, V, W or Y; preferably P81G
V112A, C, D, E, F, G, H, I, K, L, M, N, P, Q, R, S, T, W or Y; preferably V112C
N80A, C, D, E, F, G, H, I, K, L, M, P, Q, R, S, T, V, W or Y; preferably N80 R, G, N, D, P, T, E, V, A or G
L82A, C, D, E, F, G, H, I, M, N, P, Q, R, S, T, V, W or Y; preferably L82N, S or E
N88A, C, D, E, F, G, H, I, K, L, M, P, Q, R, S, T, V, W or Y; preferably N88C
N87A, C, D, E, F, G, H, I, K, L, M, P, Q, R, S, T, V, W or Y; preferably N87M or G

Preferred modification of one or more of the following residues results in a variant enzyme having an increased absolute transferase activity against phospholipid:

### S3 N, R, A, G

### M23 K, Q, L, G, T, S

### H180 R

### L82 G

### Y179 E, R, N, V, K or Q

### E309 R, S, L or A

One preferred modification is N80D. This is particularly the case when using the reference sequence SEQ ID No. 35 as the backbone. Thus, the reference sequence may be SEQ ID No. 16. This modification may be in combination with one or more further modifications. Therefore in a preferred embodiment of the present invention the nucleotide sequence encoding a lipid acyltransferase for use in any one of the methods and uses of the present invention may encode a lipid acyltransferase that comprises SEQ ID No. 35 or an amino acid sequence which has 75% or more, preferably 85% or more, more preferably 90% or more, even more preferably 95% or more, even more preferably 98% or more, or even more preferably 99% or more identity to SEQ ID No. 35.

As noted above, when referring to specific amino acid residues herein the numbering is that obtained from alignment of the variant sequence with the reference sequence shown as SEQ ID No. 34 or SEQ ID No. 35.

Much by preference, the nucleotide sequence encoding a lipid acyltransferase for use in any one of the methods and uses of the present invention may encode a lipid comprising the amino acid sequence shown as SEQ ID No. 16 or the amino acid sequence shown as SEQ ID No. 68, or an amino acid sequence which has 70% or more, preferably 75% or more, preferably 85% or more, more preferably 90% or more, even more preferably 95% or more, even more preferably 98% or more, or even more preferably 99% or more identity to SEQ ID No. 16 or SEQ ID No. 68. This enzyme may be considered a variant enzyme.

In a preferred embodiment, the variant enzyme comprises one of SEQ ID No. 121, SEQ ID No. 122 or SEQ ID No. 123.

For the purposes of the present invention, the degree of identity is based on the number of sequence elements which are the same. The degree of identity in accordance with the present invention for amino acid sequences may be suitably determined by means of computer programs known in the art, such as Vector NTI 10 (Invitrogen Corp.). For pairwise alignment the score used is preferably BLOSUM62 with Gap opening penalty of 10.0 and Gap extension penalty of 0.1.

Suitably, the degree of identity with regard to an amino acid sequence is determined over at least 20 contiguous amino acids, preferably over at least 30 contiguous amino acids, preferably over at least 40 contiguous amino acids, preferably over at least 50 contiguous amino acids, preferably over at least 60 contiguous amino acids.

Suitably, the degree of identity with regard to an amino acid sequence may be determined over the whole sequence.

Suitably, the nucleotide sequence encoding a lipid acyltransferase or the lipid acyl transferase enzyme for use in the present invention may be obtainable, preferably obtained, from organisms from one or more of the following genera: Aeromonas, Streptomyces, Saccharomyces, Lactococcus, Mycobacterium, Streptococcus, Lactobacillus, Desulfitobacterium, Bacillus, Campylobacter, Vibrionaceae, Xylella, Sulfolobus, Aspergillus, Schizosaccharomyces, Listeria, Neisseria, Mesorhizobium, Ralstonia, Xanthomonas, Candida, Thermobifida and Corynebacterium.

Suitably, the nucleotide sequence encoding a lipid acyltransferase or the lipid acyl transferase enzyme for use in the present invention may be obtainable, preferably obtained, from one or more of the following organisms: Aeromonas hydrophila, Aeromonas salmonicida, Streptomyces coelicolor, Streptomyces rimosus, Mycobacterium, Streptococcus pyogenes, Lactococcus lactis, Streptococcus pyogenes, Streptococcus thermophilus, Streptomyces thermosacchari, Streptomyces avermitilis Lactobacillus helveticus, Desulfitobacterium dehalogenans, Bacillus sp, Campylobacter jejuni, Vibrionaceae, Xylella fastidiosa, Sulfolobus solfataricus, Saccharomyces cerevisiae, Aspergillus terreus, Schizosaccharomyces pombe, Listeria innocua, Listeria monocytogenes, Neisseria meningitidis, Mesorhizobium loti, Ralstonia solanacearum, Xanthomonas campestris, Xanthomonas axonopodis, Candida parapsilosis, Thermobifida fusca and Corynebacterium efficiens.

In one aspect, preferably the nucleotide sequence encoding a lipid acyltransferase for use in any one of the methods and/or uses of the present invention encodes a lipid acyl transferase enzyme according to the present invention is obtainable, preferably obtained or derived, from one or more of Aeromonas spp., Aeromonas hydrophila or Aeromonas salmonicida.

In one aspect, preferably the lipid acyltransferase for use in any one of the methods and/or uses of the present invention is a lipid acyl transferase enzyme obtainable, preferably obtained or derived, from one or more of Aeromonas spp., Aeromonas hydrophila or Aeromonas salmonicida.

Enzymes which function as lipid acyltransferases in accordance with the present invention can be routinely identified using the assay taught herein below:

### Assay for Transferase Activity

The transferase activity is preferably measured by the molar amount of cholesterol ester formed by acyl transfer from phospholipids and/or lipids in milk to cholesterol relative to the amount of cholesterol originally available.

Milk is incubated with enzyme or water (as control) for 30 minutes at 40° C. Milk lipids are isolated by solvent extraction and the isolated lipids are analysed by GLC.

Based on GLC analysis the amount of cholesterol (CHL), cholesterol ester (CHLE) and free fatty acids (FFA) are calculated:

$$\% Transferase = \frac{CHLE ( t ) - CHLE ( 0 )}{CHLE ( t ) - CHLE ( 0 ) + FFA ( t ) - FFA ( 0 )} \times 100$$

### Where

CHLE(0)=mol/l cholesterol ester (control)
CHLE(t)=mol/l cholesterol ester (enzyme treatment)
FFA(0)=mol/l free fatty acids (cControl)
FFA(t)=mol/l free fatty acids (eEnzyme treatment)

GLC analysis may be carried out according to Example 5 below. Using this assay, lipid acyltransferases/lipid acyl transferase in accordance with the present invention are those which have at least 5% transferase activity, preferably at least 10% transferase activity, preferably at least 15%, 20%, 25% 26%, 28%, 30%, 40%, 50%, 60% or 70% transferase activity.

The term “transferase” as used herein is interchangeable with the term “lipid acyltransferase”.

Suitably, the lipid acyltransferase as defined herein catalyses one or more of the following reactions: interesterification, transesterification, alcoholysis, hydrolysis.

The term “interesterification” refers to the enzymatic catalysed transfer of acyl groups between a lipid donor and lipid acceptor, wherein the lipid donor is not a free acyl group.

The term “transesterification” as used herein means the enzymatic catalysed transfer of an acyl group from a lipid donor (other than a free fatty acid) to an acyl acceptor (other than water).

As used herein, the term “alcoholysis” refers to the enzymatic cleavage of a covalent bond of an acid derivative by reaction with an alcohol ROH so that one of the products combines with the H of the alcohol and the other product combines with the OR group of the alcohol.

As used herein, the term “alcohol” refers to an alkyl compound containing a hydroxyl group.

As used herein, the term “hydrolysis” refers to the enzymatic catalysed transfer of an acyl group from a lipid to the OH group of a water molecule.

The term “without increasing or without substantially increasing the free fatty acids” as used herein means that preferably the lipid acyl transferase according to the present invention has 100% transferase activity (i.e. transfers 100% of the acyl groups from an acyl donor onto the acyl acceptor, with no hydrolytic activity); however, the enzyme may transfer less than 100% of the acyl groups present in the lipid acyl donor to the acyl acceptor. In which case, preferably the acyltransferase activity accounts for at least 5%, more preferably at least 10%, more preferably at least 20%, more preferably at least 30%, more preferably at least 40%, more preferably 50%, more preferably at least 60%, more preferably at least 70%, more preferably at least 80%, more preferably at least 90% and more preferably at least 98% of the total enzyme activity. The % transferase activity (i.e. the transferase activity as a percentage of the total enzymatic activity) may be determined by the following the “Assay for Transferase Activity” given above.

In some aspects of the present invention, the term “without substantially increasing free fatty acids” as used herein means that the amount of free fatty acid in a edible oil treated with an lipid acyltransferase according to the present invention is less than the amount of free fatty acid produced in the edible oil when an enzyme other than a lipid acyltransferase according to the present invention had been used, such as for example as compared with the amount of free fatty acid produced when a conventional phospholipase enzyme, e.g. Lecitase Ultra™ (Novozymes A/S, Denmark), had been used.

The enzyme according to the present invention may be used with one or more other suitable food grade enzymes. Thus, it is within the scope of the present invention that, in addition to the enzyme of the invention, at least one further enzyme is added to the foodstuff. Such further enzymes include starch degrading enzymes such as endo- or exoamylases, pullulanases, debranching enzymes, hemicellulases including xylanases, cellulases, oxidoreductases, e.g. peroxidases, phenol oxidases, glucose oxidase, pyranose oxidase, sulfhydryl oxidase, or a carbohydrate oxidase such as one which oxidises maltose, for example hexose oxidase (HOX), lipases, phospholipases, glycolipases, galactolipases and proteases.

In one embodiment the enzyme may be Dairy HOX™, which acts as an oxygen scavenger to prolong shelf life of cheese while providing browning control in pizza ovens. Therefore in a one aspect the present invention relates to the use of an enzyme capable of reducing the Maillard reaction in a foodstuff (see WO 02/39828 incorporated herein by reference), such as a dairy product, for example cheese, wherein the enzyme is preferably a maltose oxidising enzyme such as carbohydrate oxidae, glucose oxidase and/or hexose oxidase, in the process or preparing a food material and/or foodstuff according to the present invention.

In one preferred embodiment the lipid acyltransferase is used in combination with a lipase having one or more of the following lipase activities: glycolipase activity (E.C. 3.1.1.26, triacylglycerol lipase activity (E.C. 3.1.1.3), phospholipase A2 activity (E.C. 3.1.1.4) or phospholipase A1 activity (E.C. 3.1.1.32). Suitable, lipolytic enzymes are well known in the art and include by way of example the following lipolytic enzymes: LIPOPAN® F, LIPOPAN® XTRA and/or LECITASE® ULTRA (Novozymes A/S, Denmark), phospholipase A2 (e.g. phospholipase A2 from LIPOMOD™ 22L from Biocatalysts, LIPOMAX™ from Genencor), LIPOLASE® (Novozymes A/S, Denmark), YIELDMAX™ (Chr. Hansen, Denmark), PANAMORE™ (DSM), the lipases taught in WO 03/97835, EP 0 977 869 or EP 1 193 314. This combination of a lipid acyl transferase as defined herein and a lipase may be particularly preferred in dough or baked products or in fine food products such as cakes and confectionary.

In some embodiments, it may also be beneficial to combine the use of lipid acyltransferase with a lipolytic enzymes such as rennet paste prepared from calf, Iamb, kid stomachs, or Palatase A750L (Novo), Palatase M200L (Novo), Palatase M1000 (Novo), or Piccantase A (DSM), also Piccantase from animal sources from DSM (K, KL, L & C) or Lipomod 187, Lipomod 338 (Biocatalysts). These lipases are used conventionally in the production of cheese to produce cheese flavours. These lipases may also be used to produce an enzymatically-modified foodstuff, for example a dairy product (e.g. cheese), particularly where said dairy product consists of, is produced from or comprises butterfat. A combination of the lipid acyltransferase with one or more of these lipases may have a beneficial effect on flavour in the dairy product (e.g. cheese for instance).

The use of lipases in combination with the enzyme of the invention may be particularly advantageous in instances where some accumulation of free fatty acids may be desirable, for example in cheese where the free fatty acids can impart a desirable flavour, or in the preparation of fine foods. The person skilled in the art will be able to combine proportions of lipolytic enzymes, for example LIPOPAN® F, LIPOPAN®XTRA and/or LECITASE® ULTRA (Novozymes A/S, Denmark), phospholipase A2 (e.g. phospholipase A2 from LIPOMOD™ 22L from Biocatalysts, LIPOMAX™ from Genencor), LIPOLASE® (Novozymes A/S, Denmark), YIELDMAX™ (Chr. Hansen, Denmark), PANAMORE™ (DSM), the lipases taught in WO 03/97835, EP 0 977 869 or EP 1 193 314 and the lipid acyltransferase of the present invention to provide the desired ratio of hydrolytic to transferase activity which results in a preferred technical effect or combination of technical effects in the foodstuff (such as those listed herein under ‘Technical Effects’).

It may also be beneficial to combine the use of lipid acyltransferase with a phospholipase, such as phospholipase A1, phospholipase A2, phospholipase B, Phospholipase C and/or phospholipase D.

The combined use may be performed sequentially or concurrently, e.g. the lipid acyl transferase treatment may occur prior to or during the further enzyme treatment. Alternatively, the further enzyme treatment may occur prior to or during the lipid acyl transferase treatment.

In the case of sequential enzyme treatments, in some embodiments it may be advantageous to remove the first enzyme used, e.g. by heat deactivation or by use of an immobilised enzyme, prior to treatment with the second (and/or third etc.) enzyme.

### Post-Transcription and Post-Translational Modifications

Suitably the lipid acyltransferase in accordance with the present invention may be encoded by any one of the nucleotide sequences taught herein.

Depending upon the host cell used post-transcriptional and/or post-translational modifications may be made. It is envisaged that the lipid acyltransferase for use in the present methods and/or uses encompasses lipid acyltransferases which have undergone post-transcriptional and/or post-translational modification.

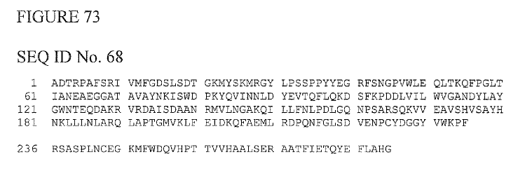

By way of example only, the expression of the nucleotide sequence shown herein as SEQ ID No. 49 (see FIG. 57) in a host cell (such as Bacillus licheniformis for example) results in post-transcriptional and/or post-translational modifications which lead to the amino acid sequence shown herein as SEQ ID No. 68 (see FIG. 73).

SEQ ID No. 68 is the same as SEQ ID No. 16 (shown herein in FIG. 1) except that SEQ ID No. 68 has undergone post-translational and/or post-transcriptional modification to remove 38 amino acids.

SEQ ID NO. 16 may also be post transcriptionally and/or post translationally modified to remove 39, 40 or 41 amino as shown in SEQ ID NOs. 121, 122 and 123 respectively.

### Isolated

In one aspect, the lipid acyltransferase is a recovered/isolated lipid acyltransferase. Thus, the lipid acyltransferase produced may be in an isolated form.

In another aspect, the nucleotide sequence encoding a lipid acyltransferase for use in the present invention may be in an isolated form.

The term “isolated” means that the sequence or protein is at least substantially free from at least one other component with which the sequence or protein is naturally associated in nature and as found in nature.

### Purified

In one aspect, the lipid acyltransferase may be in a purified form.

In another aspect, the nucleotide sequence encoding a lipid acyltransferase for use in the present invention may be in a purified form.

The term “purified” means that the sequence is in a relatively pure state—e.g. at least about 51% pure, or at least about 75%, or at least about 80%, or at least about 90% pure, or at least about 95% pure or at least about 98% pure.

### Cloning a Nucleotide Sequence Encoding a Polypeptide According to the Present Invention

A nucleotide sequence encoding either a polypeptide which has the specific properties as defined herein or a polypeptide which is suitable for modification may be isolated from any cell or organism producing said polypeptide. Various methods are well known within the art for the isolation of nucleotide sequences.

For example, a genomic DNA and/or cDNA library may be constructed using chromosomal DNA or messenger RNA from the organism producing the polypeptide. If the amino acid sequence of the polypeptide is known, labeled oligonucleotide probes may be synthesised and used to identify polypeptide-encoding clones from the genomic library prepared from the organism. Alternatively, a labelled oligonucleotide probe containing sequences homologous to another known polypeptide gene could be used to identify polypeptide-encoding clones. In the latter case, hybridisation and washing conditions of lower stringency are used.

Alternatively, polypeptide-encoding clones could be identified by inserting fragments of genomic DNA into an expression vector, such as a plasmid, transforming enzyme-negative bacteria with the resulting genomic DNA library, and then plating the transformed bacteria onto agar containing an enzyme inhibited by the polypeptide, thereby allowing clones expressing the polypeptide to be identified.

In a yet further alternative, the nucleotide sequence encoding the polypeptide may be prepared synthetically by established standard methods, e.g. the phosphoroamidite method described by Beucage S. L. et al (1981) Tetrahedron Letters 22, p 1859-1869, or the method described by Matthes et al (1984) EMBO J. 3, p 801-805. In the phosphoroamidite method, oligonucleotides are synthesised, e.g. in an automatic DNA synthesiser, purified, annealed, ligated and cloned in appropriate vectors.

The nucleotide sequence may be of mixed genomic and synthetic origin, mixed synthetic and cDNA origin, or mixed genomic and cDNA origin, prepared by ligating fragments of synthetic, genomic or cDNA origin (as appropriate) in accordance with standard techniques. Each ligated fragment corresponds to various parts of the entire nucleotide sequence. The DNA sequence may also be prepared by polymerase chain reaction (PCR) using specific primers, for instance as described in U.S. Pat. No. 4,683,202 or in Saiki R K et al (Science (1988) 239, pp 487-491).

### Nucleotide Sequences

The present invention also encompasses nucleotide sequences encoding polypeptides having the specific properties as defined herein. The term “nucleotide sequence” as used herein refers to an oligonucleotide sequence or polynucleotide sequence, and variant, homologues, fragments and derivatives thereof (such as portions thereof). The nucleotide sequence may be of genomic or synthetic or recombinant origin, which may be double-stranded or single-stranded whether representing the sense or antisense strand.

The term “nucleotide sequence” in relation to the present invention includes genomic DNA, cDNA, synthetic DNA, and RNA. Preferably it means DNA, more preferably cDNA for the coding sequence.

In a preferred embodiment, the nucleotide sequence per se encoding a polypeptide having the specific properties as defined herein does not cover the native nucleotide sequence in its natural environment when it is linked to its naturally associated sequence(s) that is/are also in its/their natural environment. For ease of reference, we shall call this preferred embodiment the “non-native nucleotide sequence”. In this regard, the term “native nucleotide sequence” means an entire nucleotide sequence that is in its native environment and when operatively linked to an entire promoter with which it is naturally associated, which promoter is also in its native environment. Thus, the polypeptide of the present invention can be expressed by a nucleotide sequence in its native organism but wherein the nucleotide sequence is not under the control of the promoter with which it is naturally associated within that organism.

Preferably the polypeptide is not a native polypeptide. In this regard, the term “native polypeptide” means an entire polypeptide that is in its native environment and when it has been expressed by its native nucleotide sequence.

Typically, the nucleotide sequence encoding polypeptides having the specific properties as defined herein is prepared using recombinant DNA techniques (i.e. recombinant DNA). However, in an alternative embodiment of the invention, the nucleotide sequence could be synthesised, in whole or in part, using chemical methods well known in the art (see Caruthers M H et al (1980) Nuc Acids Res Symp Ser 215-23 and Horn T et al (1980) Nuc Acids Res Symp Ser 225-232).

### Molecular Evolution

Once an enzyme-encoding nucleotide sequence has been isolated, or a putative enzyme-encoding nucleotide sequence has been identified, it may be desirable to modify the selected nucleotide sequence, for example it may be desirable to mutate the sequence in order to prepare an enzyme in accordance with the present invention.

Mutations may be introduced using synthetic oligonucleotides. These oligonucleotides contain nucleotide sequences flanking the desired mutation sites.

A suitable method is disclosed in Morinaga et al (Biotechnology (1984)2, p646-649). Another method of introducing mutations into enzyme-encoding nucleotide sequences is described in Nelson and Long (Analytical Biochemistry (1989), 180, p 147-151).

Instead of site directed mutagenesis, such as described above, one can introduce mutations randomly for instance using a commercial kit such as the GeneMorph PCR mutagenesis kit from Stratagene, or the Diversify PCR random mutagenesis kit from Clontech. EP 0 583 265 refers to methods of optimising PCR based mutagenesis, which can also be combined with the use of mutagenic DNA analogues such as those described in EP 0 866 796. Error prone PCR technologies are suitable for the production of variants of lipid acyl transferases with preferred characteristics. WO0206457 refers to molecular evolution of lipases.

A third method to obtain novel sequences is to fragment non-identical nucleotide sequences, either by using any number of restriction enzymes or an enzyme such as Dnase I, and reassembling full nucleotide sequences coding for functional proteins. Alternatively one can use one or multiple non-identical nucleotide sequences and introduce mutations during the reassembly of the full nucleotide sequence. DNA shuffling and family shuffling technologies are suitable for the production of variants of lipid acyl transferases with preferred characteristics. Suitable methods for performing ‘shuffling’ can be found in EP0 752 008, EP1 138 763, EP1 103 606. Shuffling can also be combined with other forms of DNA mutagenesis as described in U.S. Pat. No. 6,180,406 and WO 01/34835.

Thus, it is possible to produce numerous site directed or random mutations into a nucleotide sequence, either in vivo or in vitro, and to subsequently screen for improved functionality of the encoded polypeptide by various means. Using in silico and exo mediated recombination methods (see WO 00/58517, U.S. Pat. No. 6,344,328, U.S. Pat. No. 6,361,974), for example, molecular evolution can be performed where the variant produced retains very low homology to known enzymes or proteins. Such variants thereby obtained may have significant structural analogy to known transferase enzymes, but have very low amino acid sequence homology.

As a non-limiting example, In addition, mutations or natural variants of a polynucleotide sequence can be recombined with either the wild type or other mutations or natural variants to produce new variants. Such new variants can also be screened for improved functionality of the encoded polypeptide.

The application of the above-mentioned and similar molecular evolution methods allows the identification and selection of variants of the enzymes of the present invention which have preferred characteristics without any prior knowledge of protein structure or function, and allows the production of non-predictable but beneficial mutations or variants. There are numerous examples of the application of molecular evolution in the art for the optimisation or alteration of enzyme activity, such examples include, but are not limited to one or more of the following: optimised expression and/or activity in a host cell or in vitro, increased enzymatic activity, altered substrate and/or product specificity, increased or decreased enzymatic or structural stability, altered enzymatic activity/specificity in preferred environmental conditions, e.g. temperature, pH, substrate.

As will be apparent to a person skilled in the art, using molecular evolution tools an enzyme may be altered to improve the functionality of the enzyme.

Suitably, the nucleotide sequence encoding a lipid acyltransferase used in the invention may encode a variant lipid acyltransferase, i.e. the lipid acyltransferase may contain at least one amino acid substitution, deletion or addition, when compared to a parental enzyme. Variant enzymes retain at least 1%, 2%, 3%, 5%, 10%, 15%, 20%, 30%, 40%, 50%, 60%, 70%, 80%, 90%, 95%, 97%, 99% homology with the parent enzyme. Suitable parent enzymes may include any enzyme with esterase or lipase activity. Preferably, the parent enzyme aligns to the pfam00657 consensus sequence.

In a preferable embodiment a variant lipid acyltransferase enzyme retains or incorporates at least one or more of the pfam00657 consensus sequence amino acid residues found in the GDSx, GANDY and HPT blocks.

Enzymes, such as lipases with no or low lipid acyltransferase activity in an aqueous environment may be mutated using molecular evolution tools to introduce or enhance the transferase activity, thereby producing a lipid acyltransferase enzyme with significant transferase activity suitable for use in the compositions and methods of the present invention.

Suitably, the nucleotide sequence encoding a lipid acyltransferase for use in any one of the methods and/or uses of the present invention may encode a lipid acyltransferase that may be a variant with enhanced enzyme activity on polar lipids, preferably phospholipids and/or glycolipids when compared to the parent enzyme. Preferably, such variants also have low or no activity on lyso polar lipids. The enhanced activity on polar lipids, phospholipids and/or glycolipids may be the result of hydrolysis and/or transferase activity or a combination of both.

Variant lipid acyltransferases may have decreased activity on triglycerides, and/or monoglycerides and/or diglycerides compared with the parent enzyme.

Suitably the variant enzyme may have no activity on triglycerides and/or monoglycerides and/or diglycerides.

Alternatively, the variant enzyme may have increased activity on triglycerides, and/or may also have increased activity on one or more of the following, polar lipids, phospholipids, lecithin, phosphatidylcholine, glycolipids, digalactosyl monoglyceride, monogalactosyl monoglyceride.

Variants of lipid acyltransferases are known, and one or more of such variants may be suitable for use in the methods and uses according to the present invention and/or in the enzyme compositions according to the present invention. By way of example only, variants of lipid acyltransferases are described in the following references may be used in accordance with the present invention: Hilton & Buckley J. Biol. Chem. 1991 Jan. 15: 266 (2): 997-1000; Robertson et al J. Biol. Chem. 1994 Jan. 21; 269(3):2146-50; Brumlik et al J. Bacteria 1996 April; 178 (7): 2060-4; Peelman et al Protein Sci. 1998 March; 7(3):587-99.

### Amino Acid Sequences

The present invention also encompasses the use of amino acid sequences encoded by a nucleotide sequence which encodes a lipid acyltransferase for use in any one of the methods and/or uses of the present invention.

As used herein, the term “amino acid sequence” is synonymous with the term “polypeptide” and/or the term “protein”. In some instances, the term “amino acid sequence” is synonymous with the term “peptide”.

The amino acid sequence may be prepared/isolated from a suitable source, or it may be made synthetically or it may be prepared by use of recombinant DNA techniques.

Suitably, the amino acid sequences may be obtained from the isolated polypeptides taught herein by standard techniques.

One suitable method for determining amino acid sequences from isolated polypeptides is as follows:

Purified polypeptide may be freeze-dried and 100 μg of the freeze-dried material may be dissolved in 50 μl of a mixture of 8 M urea and 0.4 M ammonium hydrogen carbonate, pH 8.4. The dissolved protein may be denatured and reduced for 15 minutes at 50° C. following overlay with nitrogen and addition of 5 μl of 45 mM dithiothreitol. After cooling to room temperature, 5 μl of 100 mM iodoacetamide may be added for the cysteine residues to be derivatized for 15 minutes at room temperature in the dark under nitrogen.

135 μl of water and 5 μg of endoproteinase Lys-C in 5 μl of water may be added to the above reaction mixture and the digestion may be carried out at 37° C. under nitrogen for 24 hours.

The resulting peptides may be separated by reverse phase HPLC on a VYDAC C18 column (0.46×15 cm; 10 μm; The Separation Group, California, USA) using solvent A: 0.1% TFA in water and solvent B: 0.1% TFA in acetonitrile. Selected peptides may be re-chromatographed on a Develosil C18 column using the same solvent system, prior to N-terminal sequencing. Sequencing may be done using an Applied Biosystems 476A sequencer using pulsed liquid fast cycles according to the manufacturer's instructions (Applied Biosystems, California, USA).

### Sequence Identity or Sequence Homology

Here, the term “homologue” means an entity having a certain homology with the subject amino acid sequences and the subject nucleotide sequences. Here, the term “homology” can be equated with “identity”.

The homologous amino acid sequence and/or nucleotide sequence should provide and/or encode a polypeptide which retains the functional activity and/or enhances the activity of the enzyme.

In the present context, a homologous sequence is taken to include an amino acid sequence which may be at least 75, 85 or 90% identical, preferably at least 95 or 98% identical to the subject sequence. Typically, the homologues will comprise the same active sites etc. as the subject amino acid sequence. Although homology can also be considered in terms of similarity (i.e. amino acid residues having similar chemical properties/functions), in the context of the present invention it is preferred to express homology in terms of sequence identity.

In the present context, a homologous sequence is taken to include a nucleotide sequence which may be at least 75, 85 or 90% identical, preferably at least 95 or 98% identical to a nucleotide sequence encoding a polypeptide of the present invention (the subject sequence). Typically, the homologues will comprise the same sequences that code for the active sites etc. as the subject sequence. Although homology can also be considered in terms of similarity (i.e. amino acid residues having similar chemical properties/functions), in the context of the present invention it is preferred to express homology in terms of sequence identity.

Homology comparisons can be conducted by eye, or more usually, with the aid of readily available sequence comparison programs. These commercially available computer programs can calculate % homology between two or more sequences.

% homology may be calculated over contiguous sequences, i.e. one sequence is aligned with the other sequence and each amino acid in one sequence is directly compared with the corresponding amino acid in the other sequence, one residue at a time. This is called an “ungapped” alignment. Typically, such ungapped alignments are performed only over a relatively short number of residues.

Although this is a very simple and consistent method, it fails to take into consideration that, for example, in an otherwise identical pair of sequences, one insertion or deletion will cause the following amino acid residues to be put out of alignment, thus potentially resulting in a large reduction in % homology when a global alignment is performed. Consequently, most sequence comparison methods are designed to produce optimal alignments that take into consideration possible insertions and deletions without penalising unduly the overall homology score. This is achieved by inserting “gaps” in the sequence alignment to try to maximise local homology.

However, these more complex methods assign “gap penalties” to each gap that occurs in the alignment so that, for the same number of identical amino acids, a sequence alignment with as few gaps as possible—reflecting higher relatedness between the two compared sequences—will achieve a higher score than one with many gaps. “Affine gap costs” are typically used that charge a relatively high cost for the existence of a gap and a smaller penalty for each subsequent residue in the gap. This is the most commonly used gap scoring system. High gap penalties will of course produce optimised alignments with fewer gaps. Most alignment programs allow the gap penalties to be modified. However, it is preferred to use the default values when using such software for sequence comparisons.

Calculation of maximum % homology therefore firstly requires the production of an optimal alignment, taking into consideration gap penalties. A suitable computer program for carrying out such an alignment is the Vector NTI (Invitrogen Corp.). Examples of other software that can perform sequence comparisons include, but are not limited to, the BLAST package (see Ausubel et al 1999 Short Protocols in Molecular Biology, 4^{th} Ed—Chapter 18), and FASTA (Altschul et al 1990 J. Mol. Biol. 403-410). Both BLAST and FASTA are available for offline and online searching (see Ausubel at a/1999, pages 7-58 to 7-60). However, for some applications, it is preferred to use the Vector NTI program. A new tool, called BLAST 2 Sequences is also available for comparing protein and nucleotide sequence (see FEMS Microbiol Lett 1999 174(2): 247-50; FEMS Microbiol Lett 1999 177(1): 187-8 and tatiana@ncbi.nlm.nih.gov).

Although the final % homology can be measured in terms of identity, the alignment process itself is typically not based on an all-or-nothing pair comparison. Instead, a scaled similarity score matrix is generally used that assigns scores to each pairwise comparison based on chemical similarity or evolutionary distance. An example of such a matrix commonly used is the BLOSUM62 matrix—the default matrix for the BLAST suite of programs. Vector NTI programs generally use either the public default values or a custom symbol comparison table if supplied (see user manual for further details). For some applications, it is preferred to use the default values for the Vector NTI package.

Alternatively, percentage homologies may be calculated using the multiple alignment feature in Vector NTI (Invitrogen Corp.), based on an algorithm, analogous to CLUSTAL (Higgins D G & Sharp P M (1988), Gene 73(1), 237-244).

Once the software has produced an optimal alignment, it is possible to calculate % homology, preferably % sequence identity. The software typically does this as part of the sequence comparison and generates a numerical result.

Should Gap Penalties be used when determining sequence identity, then preferably the following parameters are used for pairwise alignment:

FOR BLAST

| | |
|---|---|
| GAP OPEN | 0 |
| GAP EXTENSION | 0 |

FOR CLUSTAL

| | DNA | PROTEIN | |
|---|---|---|---|
| WORD SIZE | 2 | 1 | K triple |
| GAP PENALTY | 15 | 10 | |
| GAP EXTENSION | 6.66 | 0.1 | |

In one embodiment, preferably the sequence identity for the nucleotide sequences is determined using CLUSTAL with the gap penalty and gap extension set as defined above.

Suitably, the degree of identity with regard to a nucleotide sequence is determined over at least 20 contiguous nucleotides, preferably over at least 30 contiguous nucleotides, preferably over at least 40 contiguous nucleotides, preferably over at least 50 contiguous nucleotides, preferably over at least 60 contiguous nucleotides, preferably over at least 100 contiguous nucleotides.

Suitably, the degree of identity with regard to a nucleotide sequence may be determined over the whole sequence.

In one embodiment the degree of amino acid sequence identity in accordance with the present invention may be suitably determined by means of computer programs known in the art, such as Vector NTI 10 (Invitrogen Corp.). For pairwise alignment the matrix used is preferably BLOSUM62 with Gap opening penalty of 10.0 and Gap extension penalty of 0.1.

Suitably, the degree of identity with regard to an amino acid sequence is determined over at least 20 contiguous amino acids, preferably over at least 30 contiguous amino acids, preferably over at least 40 contiguous amino acids, preferably over at least 50 contiguous amino acids, preferably over at least 60 contiguous amino acids.

Suitably, the degree of identity with regard to an amino acid sequence may be determined over the whole sequence.

The sequences may also have deletions, insertions or substitutions of amino acid residues which produce a silent change and result in a functionally equivalent substance. Deliberate amino acid substitutions may be made on the basis of similarity in polarity, charge, solubility, hydrophobicity, hydrophilicity, and/or the amphipathic nature of the residues as long as the secondary binding activity of the substance is retained. For example, negatively charged amino acids include aspartic acid and glutamic acid; positively charged amino acids include lysine and arginine; and amino acids with uncharged polar head groups having similar hydrophilicity values include leucine, isoleucine, valine, glycine, alanine, asparagine, glutamine, serine, threonine, phenylalanine, and tyrosine.

Conservative substitutions may be made, for example according to Table 2 below. Amino acids in the same block in the second column and preferably in the same line in the third column may be substituted for each other:

TABLE 2

| | | |
|---|---|---|
| ALIPHATIC | Non-polar | G A P |
| | | I L V |
| | Polar - uncharged | C S T M |
| | | N Q |
| | Polar - charged | D E |
| | | K R |
| AROMATIC | | H F W Y |

The present invention also encompasses homologous substitution (substitution and replacement are both used herein to mean the interchange of an existing amino acid residue, with an alternative residue) that may occur i.e. like-for-like substitution such as basic for basic, acidic for acidic, polar for polar etc. Non-homologous substitution may also occur i.e. from one class of residue to another or alternatively involving the inclusion of unnatural amino acids such as ornithine (hereinafter referred to as Z), diaminobutyric acid ornithine (hereinafter referred to as B), norleucine ornithine (hereinafter referred to as O), pyriylalanine, thienylalanine, naphthylalanine and phenylglycine.

Replacements may also be made by unnatural amino acids.

Variant amino acid sequences may include suitable spacer groups that may be inserted between any two amino acid residues of the sequence including alkyl groups such as methyl, ethyl or propyl groups in addition to amino acid spacers such as glycine or β-alanine residues. A further form of variation, involves the presence of one or more amino acid residues in peptoid form, will be well understood by those skilled in the art. For the avoidance of doubt, “the peptoid form” is used to refer to variant amino acid residues wherein the α-carbon substituent group is on the residue's nitrogen atom rather than the α-carbon. Processes for preparing peptides in the peptoid form are known in the art, for example Simon R J et al., PNAS (1992) 89(20), 9367-9371 and Norwell D C, Trends Biotechnol. (1995) 13(4), 132-134.

Nucleotide sequences for use in the present invention or encoding a polypeptide having the specific properties defined herein may include within them synthetic or modified nucleotides. A number of different types of modification to oligonucleotides are known in the art. These include methylphosphonate and phosphorothioate backbones and/or the addition of acridine or polylysine chains at the 3′ and/or 5′ ends of the molecule. For the purposes of the present invention, it is to be understood that the nucleotide sequences described herein may be modified by any method available in the art. Such modifications may be carried out in order to enhance the in vivo activity or life span of nucleotide sequences.

The present invention also encompasses the use of nucleotide sequences that are complementary to the sequences discussed herein, or any derivative, fragment or derivative thereof. If the sequence is complementary to a fragment thereof then that sequence can be used as a probe to identify similar coding sequences in other organisms etc.

Polynucleotides which are not 100% homologous to the sequences of the present invention but fall within the scope of the invention can be obtained in a number of ways. Other variants of the sequences described herein may be obtained for example by probing DNA libraries made from a range of individuals, for example individuals from different populations. In addition, other viral/bacterial, or cellular homologues particularly cellular homologues found in mammalian cells (e.g. rat, mouse, bovine and primate cells), may be obtained and such homologues and fragments thereof in general will be capable of selectively hybridising to the sequences shown in the sequence listing herein. Such sequences may be obtained by probing cDNA libraries made from or genomic DNA libraries from other animal species, and probing such libraries with probes comprising all or part of any one of the sequences in the attached sequence listings under conditions of medium to high stringency. Similar considerations apply to obtaining species homologues and allelic variants of the polypeptide or nucleotide sequences of the invention.

Variants and strain/species homologues may also be obtained using degenerate PCR which will use primers designed to target sequences within the variants and homologues encoding conserved amino acid sequences within the sequences of the present invention. Conserved sequences can be predicted, for example, by aligning the amino acid sequences from several variants/homologues. Sequence alignments can be performed using computer software known in the art. For example the GCG Wisconsin PileUp program is widely used.

The primers used in degenerate PCR will contain one or more degenerate positions and will be used at stringency conditions lower than those used for cloning sequences with single sequence primers against known sequences.

Alternatively, such polynucleotides may be obtained by site directed mutagenesis of characterised sequences. This may be useful where for example silent codon sequence changes are required to optimise codon preferences for a particular host cell in which the polynucleotide sequences are being expressed. Other sequence changes may be desired in order to introduce restriction polypeptide recognition sites, or to alter the property or function of the polypeptides encoded by the polynucleotides.

Polynucleotides (nucleotide sequences) of the invention may be used to produce a primer, e.g. a PCR primer, a primer for an alternative amplification reaction, a probe e.g. labelled with a revealing label by conventional means using radioactive or non-radioactive labels, or the polynucleotides may be cloned into vectors. Such primers, probes and other fragments will be at least 15, preferably at least 20, for example at least 25, 30 or 40 nucleotides in length, and are also encompassed by the term polynucleotides of the invention as used herein.

Polynucleotides such as DNA polynucleotides and probes according to the invention may be produced recombinantly, synthetically, or by any means available to those of skill in the art. They may also be cloned by standard techniques.

In general, primers will be produced by synthetic means, involving a stepwise manufacture of the desired nucleic acid sequence one nucleotide at a time. Techniques for accomplishing this using automated techniques are readily available in the art.

Longer polynucleotides will generally be produced using recombinant means, for example using a PCR (polymerase chain reaction) cloning techniques. This will involve making a pair of primers (e.g. of about 15 to 30 nucleotides) flanking a region of the lipid targeting sequence which it is desired to clone, bringing the primers into contact with mRNA or cDNA obtained from an animal or human cell, performing a polymerase chain reaction under conditions which bring about amplification of the desired region, isolating the amplified fragment (e.g. by purifying the reaction mixture on an agarose gel) and recovering the amplified DNA. The primers may be designed to contain suitable restriction enzyme recognition sites so that the amplified DNA can be cloned into a suitable cloning vector.

### Hybridisation

The present invention also encompasses the use of sequences that are complementary to the sequences of the present invention or sequences that are capable of hybridising either to the sequences of the present invention or to sequences that are complementary thereto.

The term “hybridisation” as used herein shall include “the process by which a strand of nucleic acid joins with a complementary strand through base pairing” as well as the process of amplification as carried out in polymerase chain reaction (PCR) technologies.

The present invention also encompasses the use of nucleotide sequences that are capable of hybridising to the sequences that are complementary to the subject sequences discussed herein, or any derivative, fragment or derivative thereof.

The present invention also encompasses sequences that are complementary to sequences that are capable of hybridising to the nucleotide sequences discussed herein.

Hybridisation conditions are based on the melting temperature (Tm) of the nucleotide binding complex, as taught in Berger and Kimmel (1987, Guide to Molecular Cloning Techniques, Methods in Enzymology, Vol. 152, Academic Press, San Diego Calif.), and confer a defined “stringency” as explained below.

Maximum stringency typically occurs at about Tm-5° C. (5° C. below the Tm of the probe); high stringency at about 5° C. to 10° C. below Tm; intermediate stringency at about 10° C. to 20° C. below Tm; and low stringency at about 20° C. to 25° C. below Tm. As will be understood by those of skill in the art, a maximum stringency hybridisation can be used to identify or detect identical nucleotide sequences while an intermediate (or low) stringency hybridisation can be used to identify or detect similar or related polynucleotide sequences.

Preferably, the present invention encompasses the use of sequences that are complementary to sequences that are capable of hybridising under high stringency conditions or intermediate stringency conditions to nucleotide sequences encoding polypeptides having the specific properties as defined herein.

More preferably, the present invention encompasses the use of sequences that are complementary to sequences that are capable of hybridising under high stringency conditions (e.g. 65° C. and 0.1×SSC {1×SSC=0.15 M NaCl, 0.015 M Na-citrate pH 7.0}) to nucleotide sequences encoding polypeptides having the specific properties as defined herein.

The present invention also relates to the use of nucleotide sequences that can hybridise to the nucleotide sequences discussed herein (including complementary sequences of those discussed herein).

The present invention also relates to the use of nucleotide sequences that are complementary to sequences that can hybridise to the nucleotide sequences discussed herein (including complementary sequences of those discussed herein).

Also included within the scope of the present invention are the use of polynucleotide sequences that are capable of hybridising to the nucleotide sequences discussed herein under conditions of intermediate to maximal stringency.

In a preferred aspect, the present invention covers the use of nucleotide sequences that can hybridise to the nucleotide sequences discussed herein, or the complement thereof, under stringent conditions (e.g. 50° C. and 0.2×SSC).

In a more preferred aspect, the present invention covers the use of nucleotide sequences that can hybridise to the nucleotide sequences discussed herein, or the complement thereof, under high stringency conditions (e.g. 65° C. and 0.1×SSC).

### Expression of Polypeptides

A nucleotide sequence for use in the present invention or for encoding a polypeptide having the specific properties as defined herein can be incorporated into a recombinant replicable vector. The vector may be used to replicate and express the nucleotide sequence, in polypeptide form, in and/or from a compatible host cell. Expression may be controlled using control sequences which include promoters/enhancers and other expression regulation signals. Prokaryotic promoters and promoters functional in eukaryotic cells may be used. Tissue specific or stimuli specific promoters may be used. Chimeric promoters may also be used comprising sequence elements from two or more different promoters described above.

The polypeptide produced by a host recombinant cell by expression of the nucleotide sequence may be secreted or may be contained intracellularly depending on the sequence and/or the vector used. The coding sequences can be designed with signal sequences which direct secretion of the substance coding sequences through a particular prokaryotic or eukaryotic cell membrane.

### Constructs

The term “construct”—which is synonymous with terms such as “conjugate”, “cassette” and “hybrid”—includes a nucleotide sequence encoding a polypeptide having the specific properties as defined herein for use according to the present invention directly or indirectly attached to a promoter. An example of an indirect attachment is the provision of a suitable spacer group such as an intron sequence, such as the Sh1-intron or the ADH intron, intermediate the promoter and the nucleotide sequence of the present invention. The same is true for the term “fused” in relation to the present invention which includes direct or indirect attachment. In some cases, the terms do not cover the natural combination of the nucleotide sequence coding for the protein ordinarily associated with the wild type gene promoter and when they are both in their natural environment.

The construct may even contain or express a marker which allows for the selection of the genetic construct.

For some applications, preferably the construct comprises at least a nucleotide sequence of the present invention or a nucleotide sequence encoding a polypeptide having the specific properties as defined herein operably linked to a promoter.

### Organism

The term “organism” in relation to the present invention includes any organism that could comprise a nucleotide sequence according to the present invention or a nucleotide sequence encoding for a polypeptide having the specific properties as defined herein and/or products obtained therefrom.

The term “transgenic organism” in relation to the present invention includes any organism that comprises a nucleotide sequence coding for a polypeptide having the specific properties as defined herein and/or the products obtained therefrom, and/or wherein a promoter can allow expression of the nucleotide sequence coding for a polypeptide having the specific properties as defined herein within the organism. Preferably the nucleotide sequence is incorporated in the genome of the organism.

The term “transgenic organism” does not cover native nucleotide coding sequences in their natural environment when they are under the control of their native promoter which is also in its natural environment.

Therefore, the transgenic organism of the present invention includes an organism comprising any one of, or combinations of, a nucleotide sequence coding for a polypeptide having the specific properties as defined herein, constructs as defined herein, vectors as defined herein, plasmids as defined herein, cells as defined herein, or the products thereof. For example the transgenic organism can also comprise a nucleotide sequence coding for a polypeptide having the specific properties as defined herein under the control of a promoter not associated with a sequence encoding a lipid acyltransferase in nature.

### Transformation of Host Cells/Organism

The host organism can be a prokaryotic or a eukaryotic organism.

Examples of suitable prokaryotic hosts include bacteria such as E. coli and Bacillus licheniformis, preferably B. licheniformis.

Teachings on the transformation of prokaryotic hosts is well documented in the art, for example see Sambrook et al (Molecular Cloning: A Laboratory Manual, 2nd edition, 1989, Cold Spring Harbor Laboratory Press). If a prokaryotic host is used then the nucleotide sequence may need to be suitably modified before transformation—such as by removal of introns.

In another embodiment the transgenic organism can be a yeast.

Filamentous fungi cells may be transformed using various methods known in the art—such as a process involving protoplast formation and transformation of the protoplasts followed by regeneration of the cell wall in a manner known. The use of Aspergillus as a host microorganism is described in EP 0 238 023.

Another host organism can be a plant. A review of the general techniques used for transforming plants may be found in articles by Potrykus (Annu Rev Plant Physiol Plant Mol Biol [1991] 42:205-225) and Christou (Agro-Food-Industry Hi-Tech March/April 1994 17-27). Further teachings on plant transformation may be found in EP-A-0449375.

General teachings on the transformation of fungi, yeasts and plants are presented in following sections.

### Transformed Fungus

A host organism may be a fungus—such as a filamentous fungus. Examples of suitable such hosts include any member belonging to the genera Thermomyces, Acremonium, Aspergillus, Penicillium, Mucor, Neurospora, Trichoderma and the like.

Teachings on transforming filamentous fungi are reviewed in U.S. Pat. No. 5,741,665 which states that standard techniques for transformation of filamentous fungi and culturing the fungi are well known in the art. An extensive review of techniques as applied to N. crassa is found, for example in Davis and de Serres, Methods Enzymol (1971) 17A: 79-143.

Further teachings on transforming filamentous fungi are reviewed in U.S. Pat. No. 5,674,707.

In one aspect, the host organism can be of the genus Aspergillus, such as Aspergillus niger.

A transgenic Aspergillus according to the present invention can also be prepared by following, for example, the teachings of Turner G. 1994 (Vectors for genetic manipulation. In: Martinelli S. D., Kinghorn J. R. (Editors) Aspergillus: 50 years on. Progress in industrial microbiology vol 29. Elsevier Amsterdam 1994. pp. 641-666).

Gene expression in filamentous fungi has been reviewed in Punt et al., (2002) Trends Biotechnol 2002 May; 20(5):200-6, Archer & Peberdy Crit Rev Biotechnol (1997) 17(4):273-306.

### Transformed Yeast

In another embodiment, the transgenic organism can be a yeast.

A review of the principles of heterologous gene expression in yeast are provided in, for example, Methods Mol Biol (1995), 49:341-54, and Curr Opin Biotechnol (1997) October; 8(5):554-60

In this regard, yeast—such as the species Saccharomyces cerevisi or Pichia pastoris (see FEMS Microbiol Rev (2000, 24(1):45-66), may be used as a vehicle for heterologous gene expression.

A review of the principles of heterologous gene expression in Saccharomyces cerevisiae and secretion of gene products is given by E Hinchcliffe E Kenny (1993, “Yeast as a vehicle for the expression of heterologous genes”, Yeasts, Vol 5, Anthony H Rose and J Stuart Harrison, eds, 2nd edition, Academic Press Ltd.).

For the transformation of yeast, several transformation protocols have been developed. For example, a transgenic Saccharomyces according to the present invention can be prepared by following the teachings of Hinnen et al., (1978, Proceedings of the National Academy of Sciences of the USA 75, 1929); Beggs, J D (1978, Nature, London, 275, 104); and Ito, H et al (1983, J Bacteriology 153, 163-168).

The transformed yeast cells may be selected using various selective markers—such as auxotrophic markers dominant antibiotic resistance markers.

A suitable yeast host organism can be selected from the biotechnologically relevant yeasts species such as, but not limited to, yeast species selected from Pichia spp., Hansenula spp., Kluyveromyces, Yarrowinia spp., Saccharomyces spp., including S. cerevisiae, or Schizosaccharomyce spp. including Schizosaccharomyce pombe.

A strain of the methylotrophic yeast species Pichia pastoris may be used as the host organism.

In one embodiment, the host organism may be a Hansenula species, such as H. polymorpha (as described in WO01/39544).

### Transformed Plants/Plant Cells

A host organism suitable for the present invention may be a plant. A review of the general techniques may be found in articles by Potrykus (Annu Rev Plant Physiol Plant Mol Biol [1991] 42:205-225) and Christou (Agro-Food-Industry Hi-Tech March/April 1994 17-27), or in WO 01/16308. The transgenic plant may produce enhanced levels of phytosterol esters and phytostanol esters, for example.

Therefore the present invention also relates to a method for the production of a transgenic plant with enhanced levels of phytosterol esters and phytostanol esters, comprising the steps of transforming a plant cell with a lipid acyltransferase as defined herein (in particular with an expression vector or construct comprising a lipid acyltransferase as defined herein), and growing a plant from the transformed plant cell.

### Secretion

Often, it is desirable for the polypeptide to be secreted from the expression host into the culture medium from where the enzyme may be more easily recovered. According to the present invention, the secretion leader sequence may be selected on the basis of the desired expression host. Hybrid signal sequences may also be used with the context of the present invention.

Typical examples of secretion leader sequences not associated with a nucleotide sequence encoding a lipid acyltransferase in nature are those originating from the fungal amyloglucosidase (AG) gene (glaA—both 18 and 24 amino acid versions e.g. from Aspergillus), the a-factor gene (yeasts e.g. Saccharomyces, Kluyveromyces and Hansenula) or the α-amylase gene (Bacillus).

### Detection

A variety of protocols for detecting and measuring the expression of the amino acid sequence are known in the art. Examples include enzyme-linked immunosorbent assay (ELISA), radioimmunoassay (RIA) and fluorescent activated cell sorting (FACS).

A wide variety of labels and conjugation techniques are known by those skilled in the art and can be used in various nucleic and amino acid assays.

A number of companies such as Pharmacia Biotech (Piscataway, N.J.), Promega (Madison, Wis.), and US Biochemical Corp (Cleveland, Ohio) supply commercial kits and protocols for these procedures.

Suitable reporter molecules or labels include those radionuclides, enzymes, fluorescent, chemiluminescent, or chromogenic agents as well as substrates, cofactors, inhibitors, magnetic particles and the like. Patents teaching the use of such labels include U.S. Pat. No. 3,817,837; U.S. Pat. No. 3,850,752; U.S. Pat. No. 3,939,350; U.S. Pat. No. 3,996,345; U.S. Pat. No. 4,277,437; U.S. Pat. No. 4,275,149 and U.S. Pat. No. 4,366,241.

Also, recombinant immunoglobulins may be produced as shown in U.S. Pat. No. 4,816,567.

### Fusion Proteins

The lipid acyltransferase for use in the present invention may be produced as a fusion protein, for example to aid in extraction and purification thereof. Examples of fusion protein partners include glutathione-S-transferase (GST), 6×His, GAL4 (DNA binding and/or transcriptional activation domains) and β-galactosidase. It may also be convenient to include a proteolytic cleavage site between the fusion protein partner and the protein sequence of interest to allow removal of fusion protein sequences. Preferably the fusion protein will not hinder the activity of the protein sequence.

Gene fusion expression systems in E. coli have been reviewed in Curr. Opin. Biotechnol. (1995) 6(5):501-6.

The amino acid sequence of a polypeptide having the specific properties as defined herein may be ligated to a non-native sequence to encode a fusion protein. For example, for screening of peptide libraries for agents capable of affecting the substance activity, it may be useful to encode a chimeric substance expressing a non-native epitope that is recognised by a commercially available antibody.

The invention will now be described, by way of example only, with reference to the following Figures and Examples.

FIG. 1 shows the amino acid sequence of a mutant Aeromonas salmonicida mature lipid acyltransferase (GCAT) with a mutation of Asn80Asp (notably, amino acid 80 is in the mature sequence) (SEQ ID 16);

FIG. 2 shows an amino acid sequence (SEQ ID No. 1) of a lipid acyl transferase from Aeromonas hydrophila (ATCC #7965);

FIG. 3 shows a pfam00657 consensus sequence from database version 6 (SEQ ID No. 2);

FIG. 4 shows an amino acid sequence (SEQ ID No. 3) obtained from the organism Aeromonas hydrophila (P10480; GI:121051);

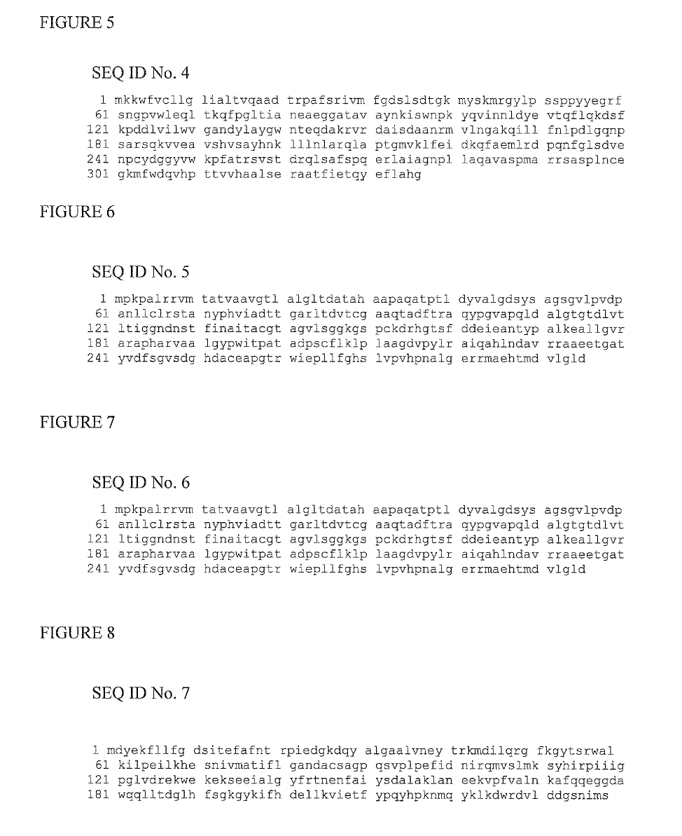

FIG. 5 shows an amino acid sequence (SEQ ID No. 4) obtained from the organism Aeromonas salmonicida (AAG098404; GI:9964017);

FIG. 6 shows an amino acid sequence (SEQ ID No. 5) obtained from the organism Streptomyces coeficolor A3(2) (Genbank accession number NP_{—}631558);

FIG. 7 shows an amino acid sequence (SEQ ID No. 6) obtained from the organism Streptomyces coelicolor A3(2) (Genbank accession number: CAC42140);

FIG. 8 shows an amino acid sequence (SEQ ID No. 7) obtained from the organism Saccharomyces cerevisiae (Genbank accession number P41734);

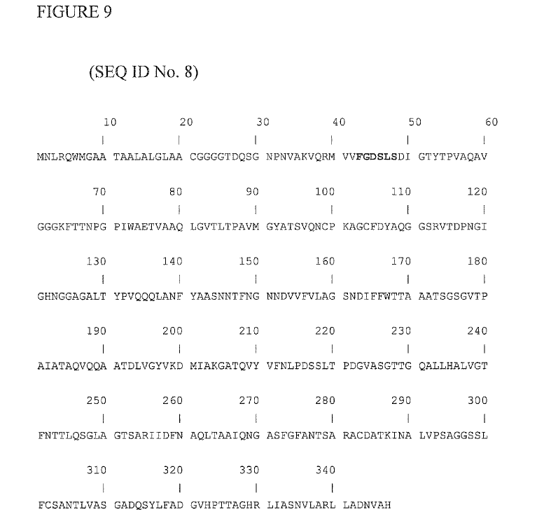

FIG. 9 shows an amino acid sequence (SEQ ID No. 8) obtained from the organism Ralstonia (Genbank accession number: AL646052);

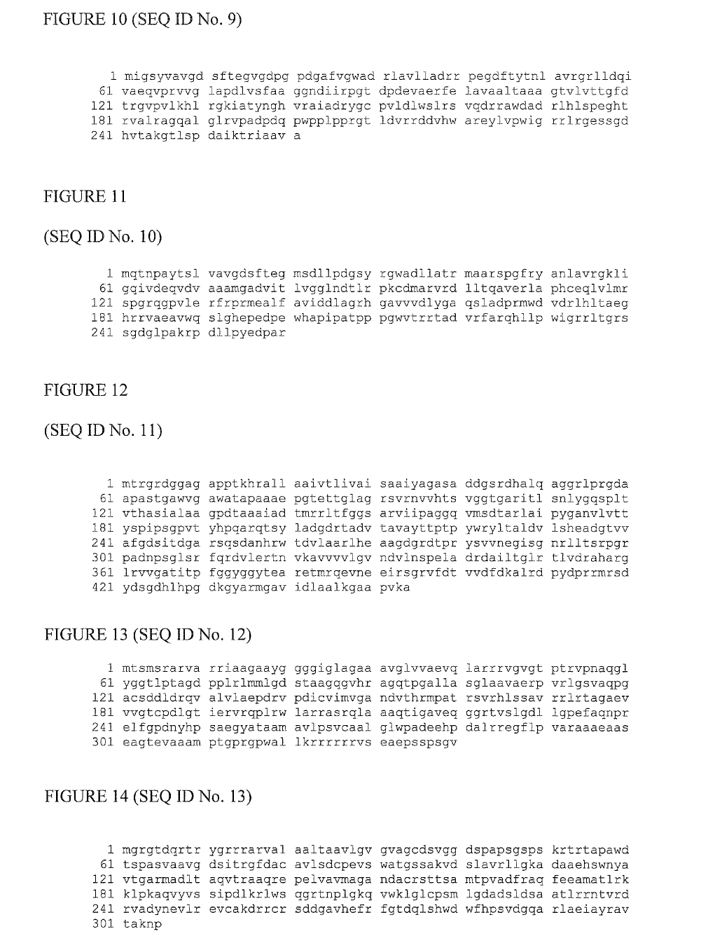

FIG. 10 shows SEQ ID No. 9. Scoe1 NCBI protein accession code CAB39707.1 GI:4539178 conserved hypothetical protein [Streptomyces coelicolor A3(2)];

FIG. 11 shows an amino acid shown as SEQ ID No. 10. Scoe2 NCBI protein accession code CAC01477.1 GI:9716139 conserved hypothetical protein [Streptomyces coelicolor A3(2)];

FIG. 12 shows an amino acid sequence (SEQ ID No. 11) Scoe3 NCBI protein accession code CAB88833.1 GI:7635996 putative secreted protein [Streptomyces coelicolor A3(2)];

FIG. 13 shows an amino acid sequence (SEQ ID No. 12) Scoe4 NCBI protein accession code CAB89450.1 GI:7672261 putative secreted protein [Streptomyces coelicolor A3(2)];

FIG. 14 shows an amino acid sequence (SEQ ID No. 13) Scoe5 NCBI protein accession code CAB62724.1 GI:6562793 putative lipoprotein [Streptomyces coelicolor A3(2)];

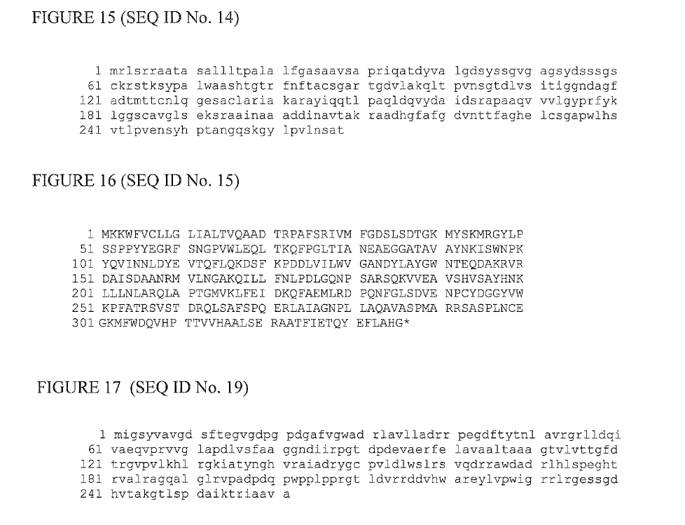

FIG. 15 shows an amino acid sequence (SEQ ID No. 14) Srim1 NCBI protein accession code AAK84028.1 GI:15082088 GDSL-lipase [Streptomyces rimosus];

FIG. 16 shows an amino acid sequence (SEQ ID No. 15) of a lipid acyltransferase from Aeromonas salmonicida subsp. Salmonicida (ATCC #14174);

FIG. 17 shows SEQ ID No. 19. Scoe1 NCBI protein accession code CAB39707.1 GI:4539178 conserved hypothetical protein [Streptomyces coelicolor A3(2)];

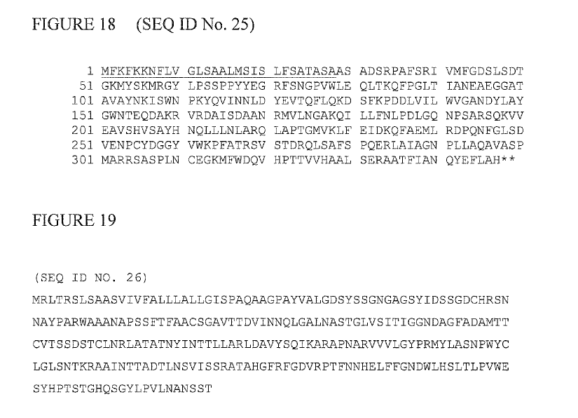

FIG. 18 shows an amino acid sequence (SEQ ID No. 25) of the fusion construct used for mutagenesis of the Aeromonas hydrophila lipid acyltransferase gene. The underlined amino acids is a xylanase signal peptide;

FIG. 19 shows a polypeptide sequence of a lipid acyltransferase enzyme from Streptomyces (SEQ ID No. 26);

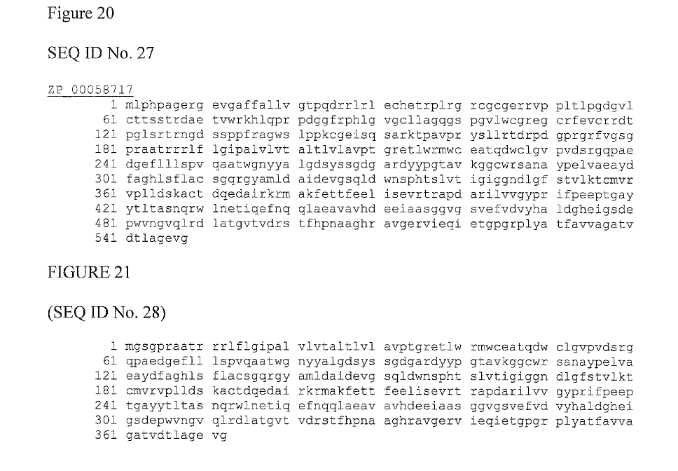

FIG. 20 shows a polypeptide sequence of a lipid acyltransferase enzyme from Thermobifida (SEQ ID No. 27);

FIG. 21 shows a polypeptide sequence of a lipid acyltransferase enzyme from Thermobifida (SEQ ID No. 28);

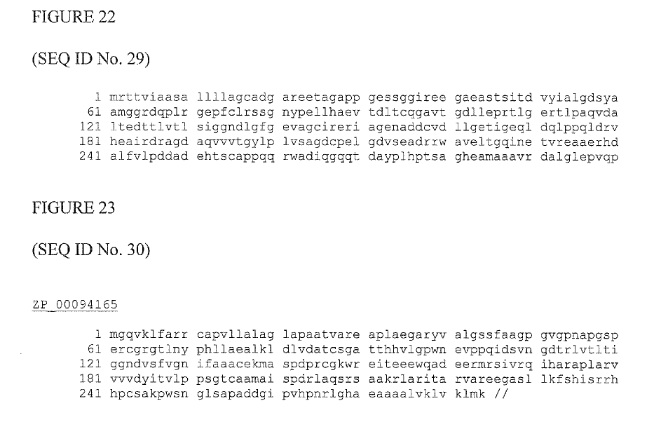

FIG. 22 shows a polypeptide of a lipid acyltransferase enzyme from Corynebacterium efficiens GDSx 300 amino acid (SEQ ID No. 29);

FIG. 23 shows a polypeptide of a lipid acyltransferase enzyme from Novosphingobium aromaticivorans GDSx 284 amino acid (SEQ ID No. 30);

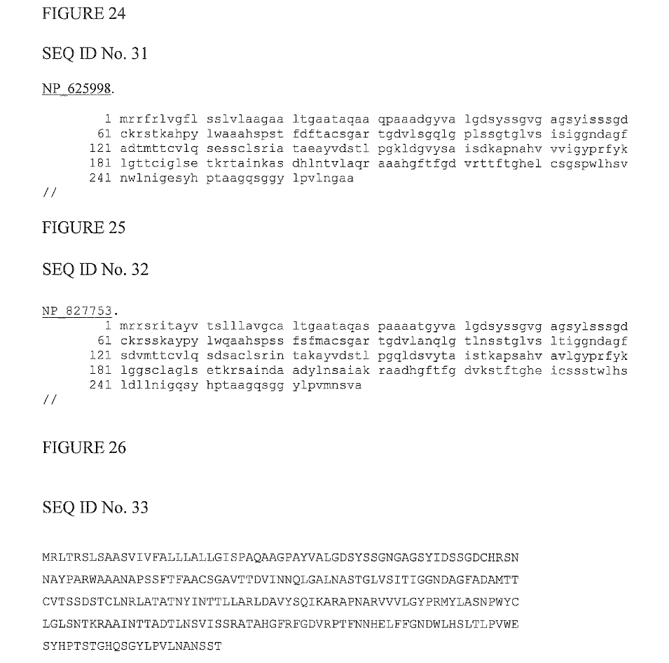

FIG. 24 shows a polypeptide of a lipid acyltransferase enzyme from Streptomyces coelicolor GDSx 269 aa (SEQ ID No. 31);

FIG. 25 shows a polypeptide of a lipid acyltransferase enzyme from Streptomyces avermitilis/GDSx 269 amino acid (SEQ ID No. 32);

FIG. 26 shows a polypeptide of a lipid acyltransferase enzyme from Streptomyces (SEQ ID No. 33);

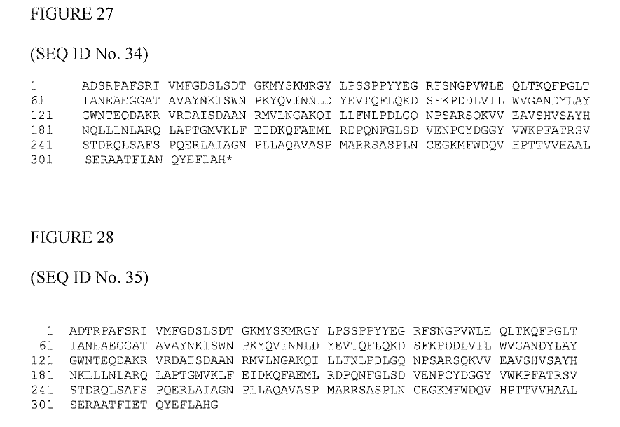

FIG. 27 shows an amino acid sequence (SEQ ID No. 34) obtained from the organism Aeromonas hydrophila (P10480; GI:121051) (notably, this is the mature sequence);

FIG. 28 shows the amino acid sequence (SEQ ID No. 35) of Aeromonas salmonicida mature lipid acyltransferase (GCAT) (notably, this is the mature sequence);

FIG. 29 shows a nucleotide sequence (SEQ ID No. 36) from Streptomyces thermosacchari;

FIG. 30 shows an amino acid sequence (SEQ ID No. 37) from Streptomyces thermosacchari;

FIG. 31 shows an amino acid sequence (SEQ ID No. 38) from Thermobifida fusca/GDSx 548 amino acid;

FIG. 32 shows a nucleotide sequence (SEQ ID No. 39) from Thermobifida fusca;

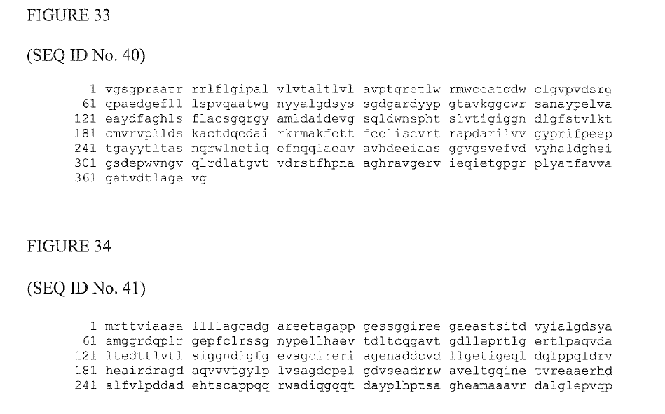

FIG. 33 shows an amino acid sequence (SEQ ID No. 40) from Thermobifida fusca/GDSx;

FIG. 34 shows an amino acid sequence (SEQ ID No. 41) from Corynebacterium efficiens/GDSx 300 amino acid;

FIG. 35 shows a nucleotide sequence (SEQ ID No. 42) from Corynebacterium efficiens;

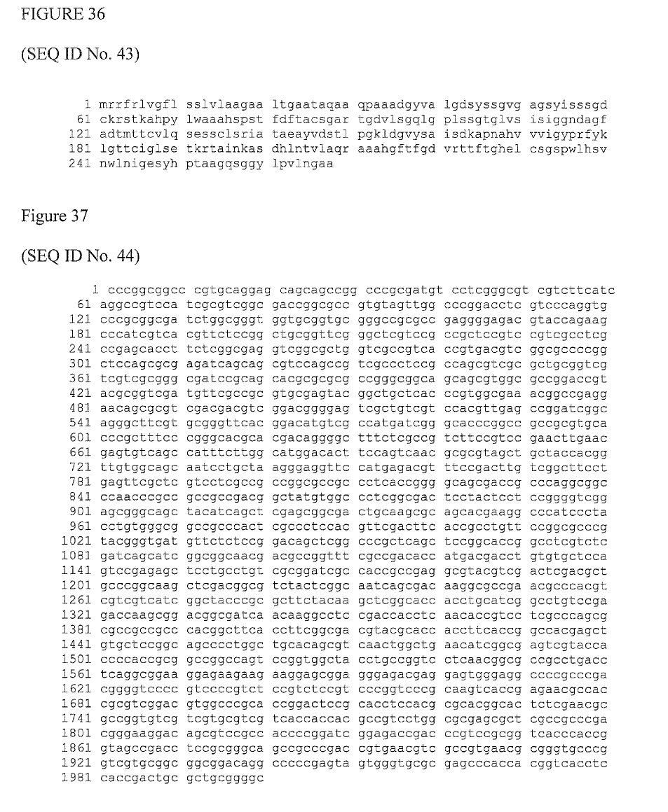

FIG. 36 shows an amino acid sequence (SEQ ID No. 43) from S. coelicolor/GDSx 268 amino acid;

FIG. 37 shows a nucleotide sequence (SEQ ID No. 44) from S. coelicolor;

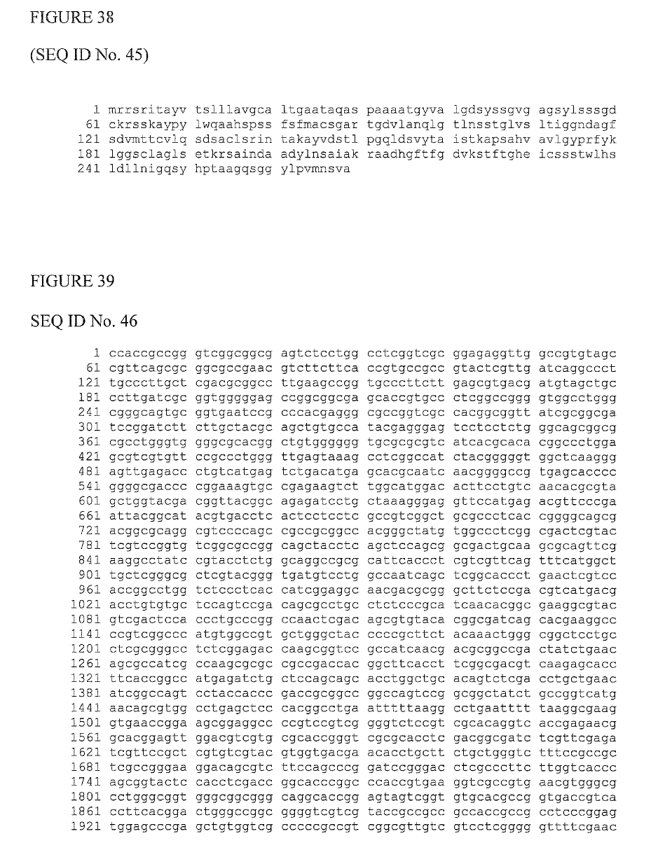

FIG. 38 shows an amino acid sequence (SEQ ID No. 45) from S. avermitilis;

FIG. 39 shows a nucleotide sequence (SEQ ID No. 46) from S. avermitilis;

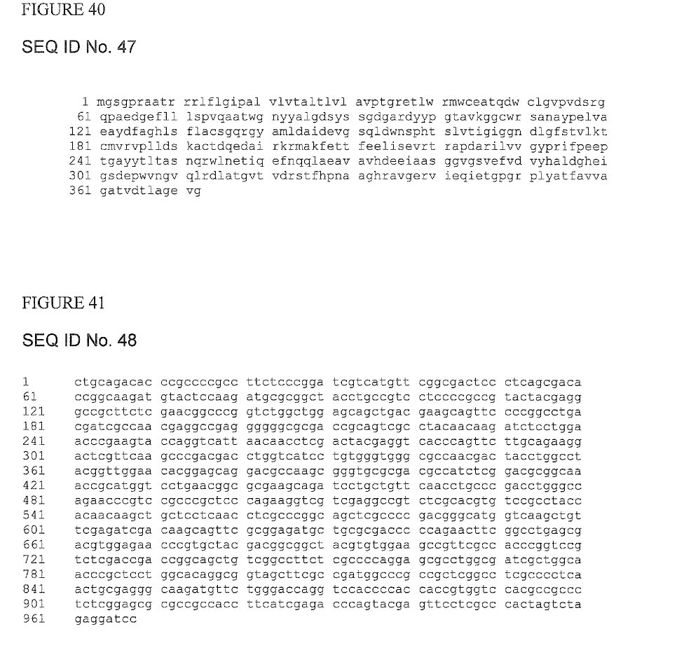

FIG. 40 shows an amino acid sequence (SEQ ID No. 47) from Thermobifida fusca/GDSx;

FIG. 41 shows a nucleotide sequence (SEQ ID No. 48) from Thermobifida fusca/GDSx;

FIG. 42 shows an alignment of the L131 and homologues from S. avermitilis and T. fusca illustrates that the conservation of the GDSx motif (GDSY in L131 and S. avermitilis and T. fusca), the GANDY box, which is either GGNDA or GGNDL, and the HPT block (considered to be the conserved catalytic histidine). These three conserved blocks are highlighted;

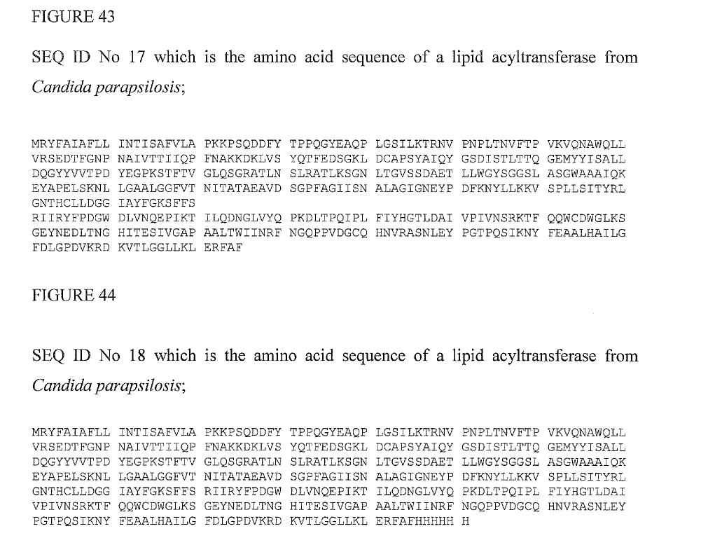

FIG. 43 shows SEQ ID No 17 which is the amino acid sequence of a lipid acyltransferase from Candida parapsilosis;

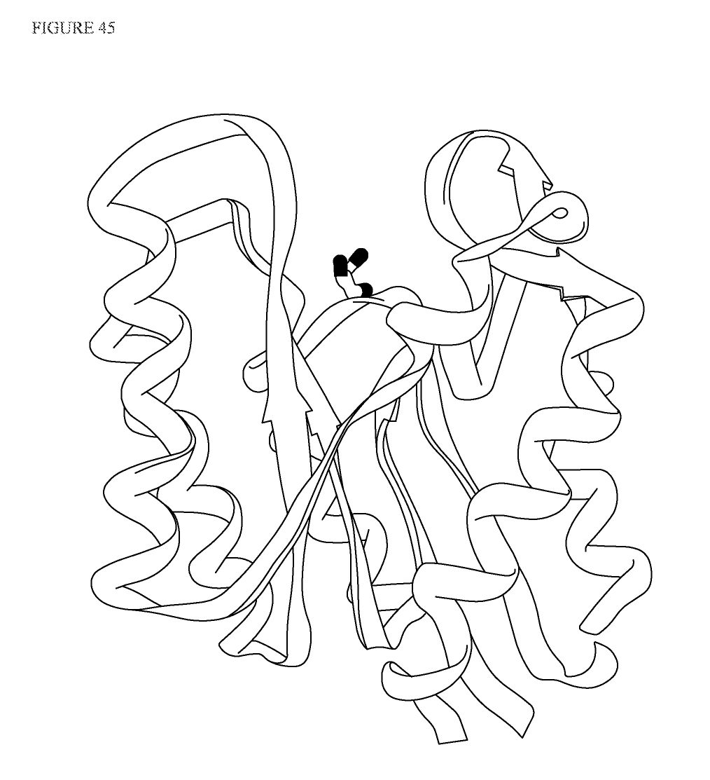

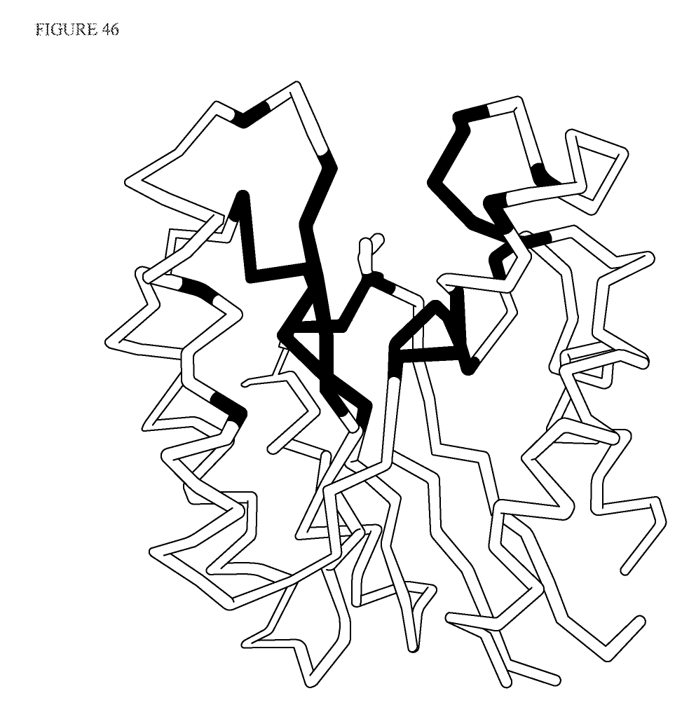

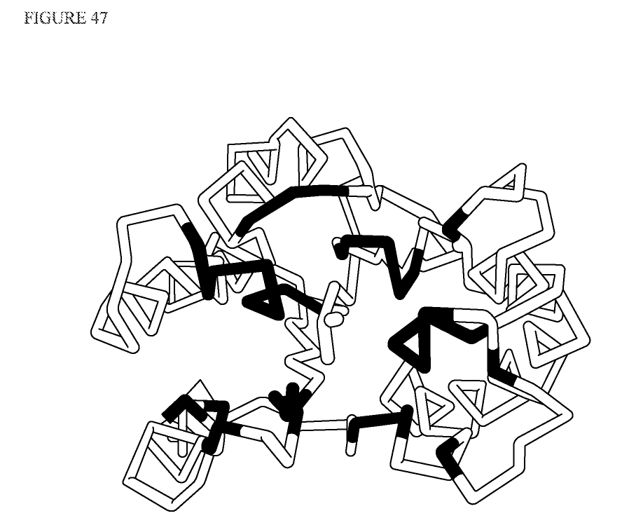

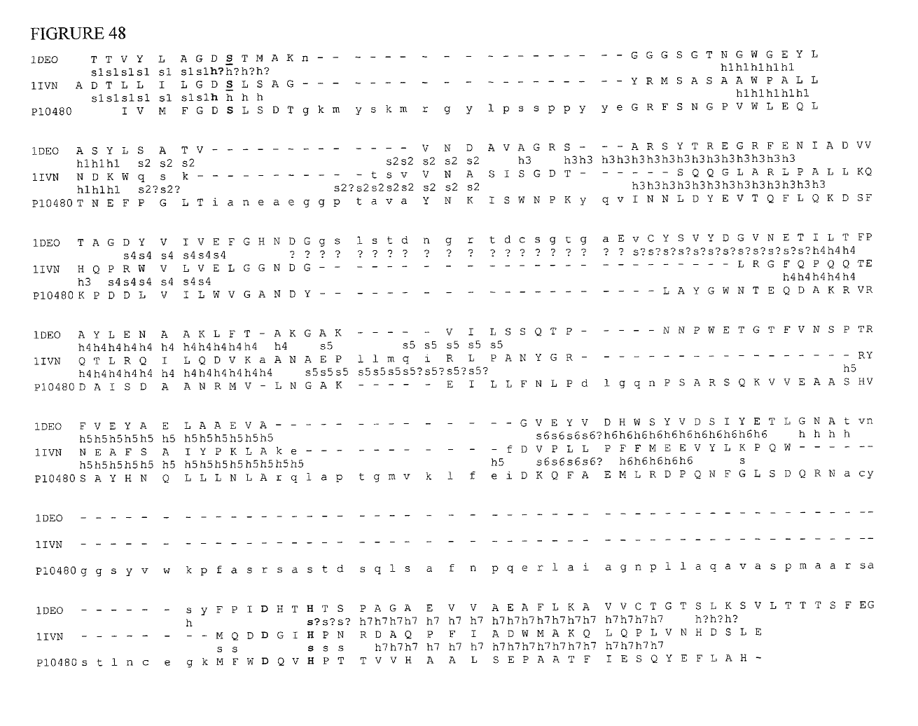

FIG. 44 shows SEQ ID No 18 which is the amino acid sequence of a lipid acyltransferase from Candida parapsilosis;

FIG. 45 shows a ribbon representation of the 1IVN.PDB crystal structure which has glycerol in the active site. The Figure was made using the Deep View Swiss-PDB viewer;

FIG. 46 shows 1IVN.PDB Crystal Structure—Side View using Deep View Swiss-PDB viewer, with glycerol in active site—residues within 10 Å of active site glycerol are coloured black;

FIG. 47 shows 1IVN.PDB Crystal Structure—Top View using Deep View Swiss-PDB viewer, with glycerol in active site—residues within 10 Å of active site glycerol are coloured black;

FIG. 48 shows alignment 1;

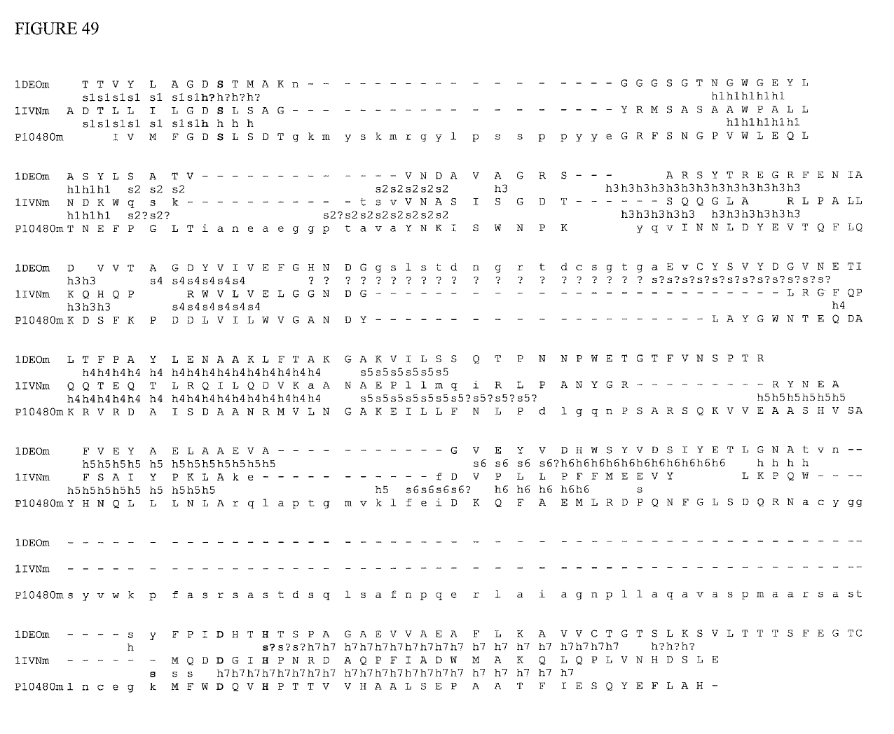

FIG. 49 shows alignment 2;

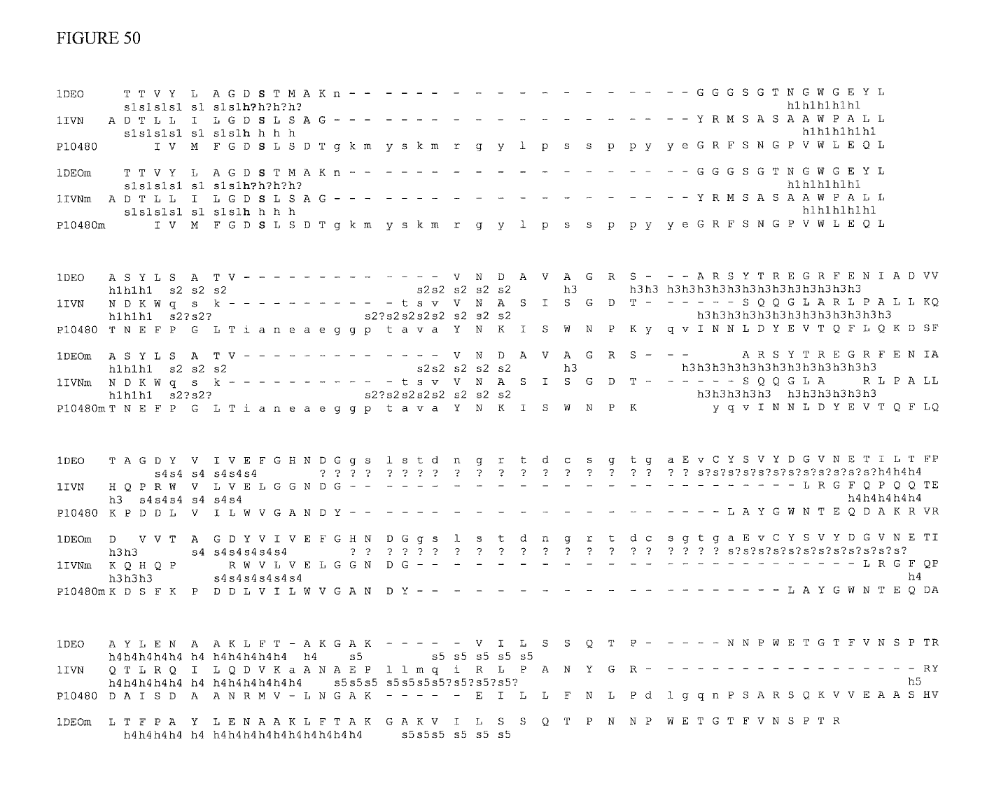

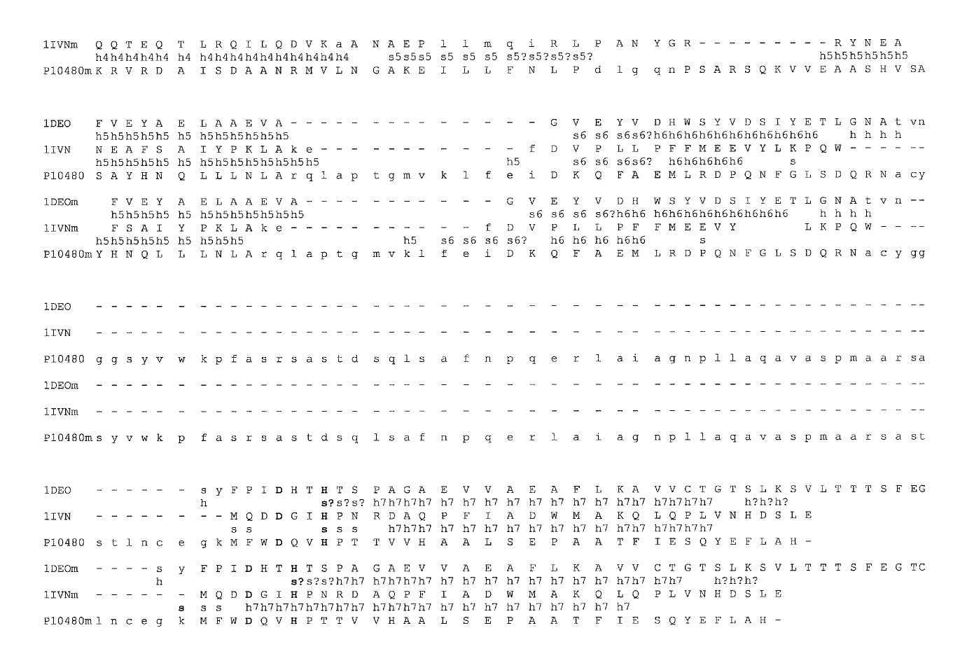

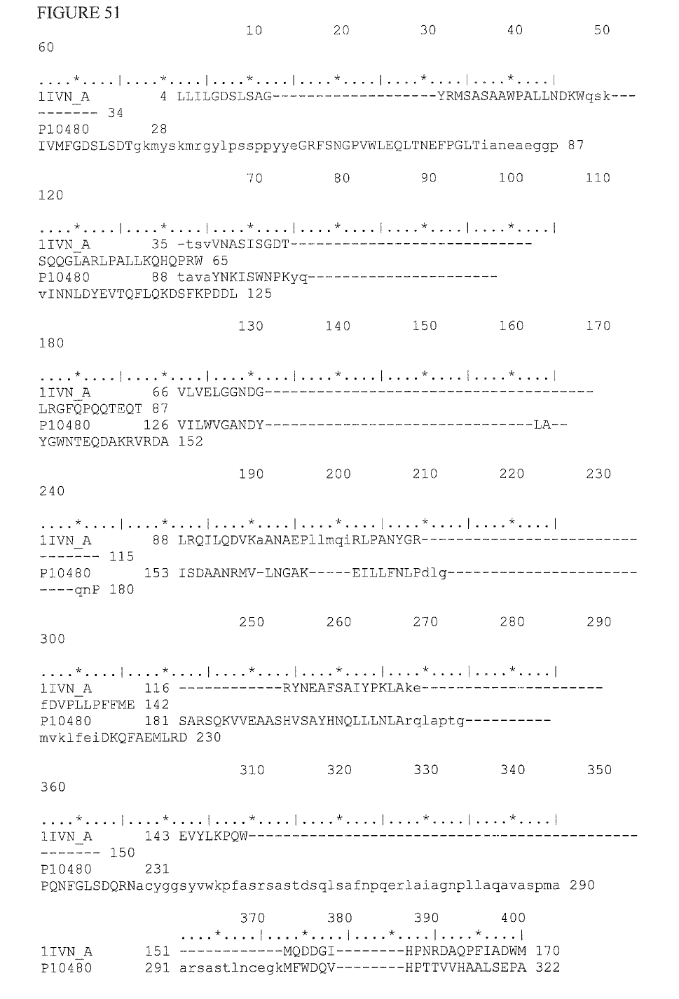

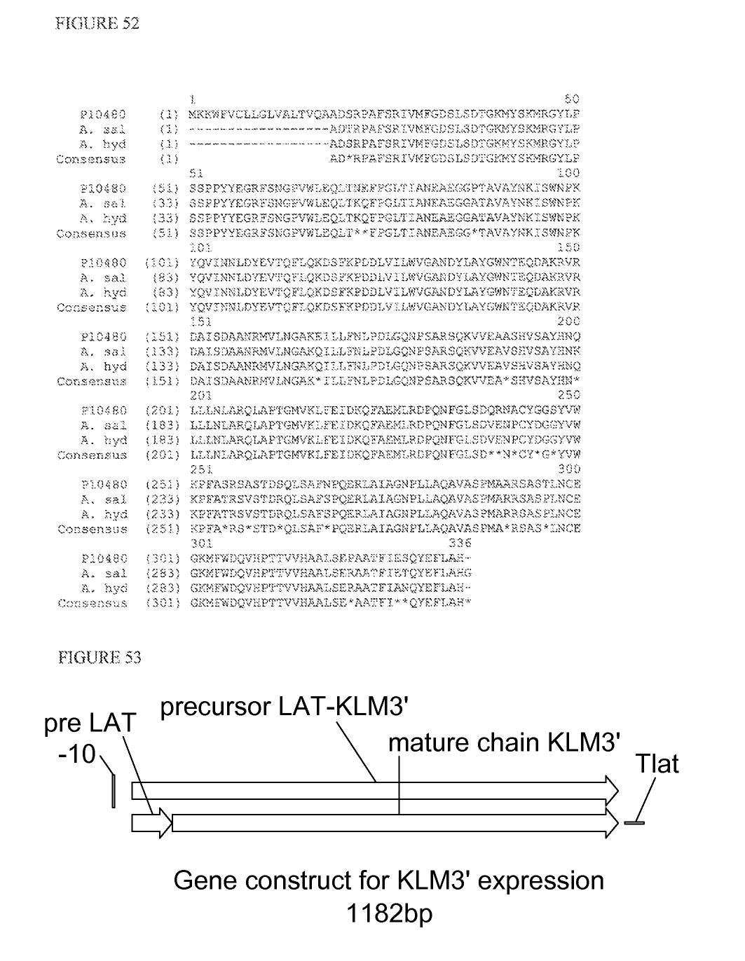

FIGS. 50 and 51 show an alignment of 1IVN to P10480 (P10480 is the database sequence for A. hydrophila enzyme), this alignment was obtained from the PFAM database and used in the model building process; and

FIG. 52 shows an alignment where P10480 is the database sequence for Aeromonas hydrophila. This sequence is used for the model construction and the site selection (note that the full protein (SEQ ID No. 25) is depicted, the mature protein (equivalent to SEQ ID No. 34) starts at residue 19. A. sal is Aeromonas salmonicida (SEQ ID No. 4) GDSX lipase, A. hyd is Aeromonas hydrophila (SEQ ID No. 34) GDSX lipase; the consensus sequence contains a * at the position of a difference between the listed sequences);

FIG. 53 shows a gene construct used in Example 1;

FIG. 54 shows a codon optimised gene construct (no. 052907) used in Example 1; and

FIG. 55 shows the sequence of the XhoI insert containing the LAT-KLM3′ precursor gene, the −35 and −10 boxes are underlined;

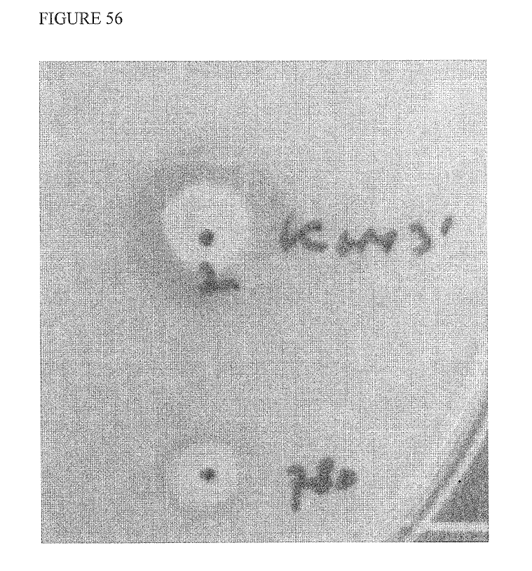

FIG. 56 shows BML780-KLM3′CAP50 (comprising SEQ ID No. 16—upper colony) and BML780 (the empty host strain—lower colony) after 48 h growth at 37° C. on 1% tributyrin agar;

FIG. 57 shows a nucleotide sequence from Aeromonas salmonicida (SEQ ID No. 49) including the signal sequence (preLAT—positions 1 to 87);

FIG. 58 shows a nucleotide sequence (SEQ ID No. 50) encoding a lipid acyl transferase according to the present invention obtained from the organism Aeromonas hydrophila;

FIG. 59 shows a nucleotide sequence (SEQ ID No. 51) encoding a lipid acyl transferase according to the present invention obtained from the organism Aeromonas salmonicida;

FIG. 60 shows a nucleotide sequence (SEQ ID No. 52) encoding a lipid acyl transferase according to the present invention obtained from the organism Streptomyces coelicolor A3(2) (Genbank accession number NC_{—}003888.1:8327480.8328367);

FIG. 61 shows a nucleotide sequence (SEQ ID No. 53) encoding a lipid acyl transferase according to the present invention obtained from the organism Streptomyces coelicolor A3(2) (Genbank accession number AL939131.1:265480.266367);

FIG. 62 shows a nucleotide sequence (SEQ ID No. 54) encoding a lipid acyl transferase according to the present invention obtained from the organism Saccharomyces cerevisiae (Genbank accession number Z75034);

FIG. 63 shows a nucleotide sequence (SEQ ID No. 55) encoding a lipid acyl transferase according to the present invention obtained from the organism Ralstonia;

FIG. 64 shows a nucleotide sequence shown as SEQ ID No. 56 encoding NCBI protein accession code CAB39707.1 GI:4539178 conserved hypothetical protein [Streptomyces coelicolor A3(2)];

FIG. 65 shows a nucleotide sequence shown as SEQ ID No. 57 encoding Scoe2 NCBI protein accession code CAC01477.1 GI:9716139 conserved hypothetical protein [Streptomyces coelicolor A3(2)];

FIG. 66 shows a nucleotide sequence shown as SEQ ID No. 58 encoding Scoe3 NCBI protein accession code CAB88833.1 GI:7635996 putative secreted protein. [Streptomyces coelicolor A3(2)];

FIG. 67 shows a nucleotide sequence shown as SEQ ID No. 59 encoding Scoe4 NCBI protein accession code CAB89450.1 GI:7672261 putative secreted protein. [Streptomyces coelicolor A3(2)];

FIG. 68 shows a nucleotide sequence shown as SEQ ID No. 60, encoding Scoe5 NCBI protein accession code CAB62724.1 GI:6562793 putative lipoprotein [Streptomyces coelicolor A3(2)];

FIG. 69 shows a nucleotide sequence shown as SEQ ID No. 61 encoding Srim1 NCBI protein accession code AAK84028.1 GI:15082088 GDSL-lipase [Streptomyces rimosus];

FIG. 70 shows a nucleotide sequence (SEQ ID No. 62) encoding a lipid acyltransferase from Aeromonas hydrophila (ATCC #7965);

FIG. 71 shows a nucleotide sequence (SEQ ID No 63) encoding a lipid acyltransferase from Aeromonas salmonicida subsp. Salmonicida (ATCC #14174);

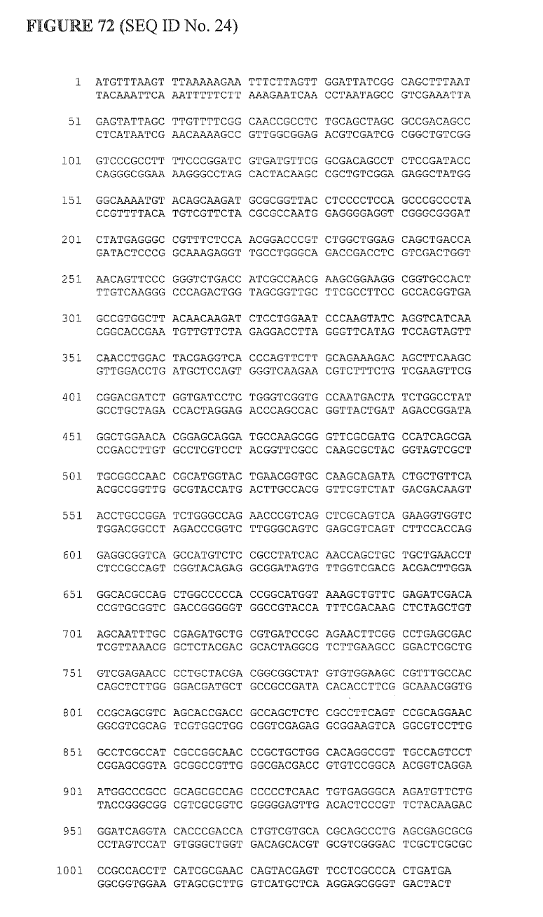

FIG. 72 shows a nucleotide sequence (SEQ ID No. 24) encoding an enzyme from Aeromonas hydrophila including a xylanase signal peptide;

FIG. 73 shows the amino acid sequence of a mutant Aeromonas salmonicida mature lipid acyltransferase (GCAT) with a mutation of Asn80Asp (notably, amino acid 80 is in the mature sequence)—shown herein as SEQ ID No. 16—and after undergoing post-translational modification as SEQ ID No. 68—amino acid residues 235 and 236 of SEQ ID No. 68 are not covalently linked following post-translational modification. The two peptides formed are held together by one or more S—S bridges. Amino acid 236 in SEQ ID No. 68 corresponds with the amino acid residue number 274 in SEQ ID No. 16 shown herein;

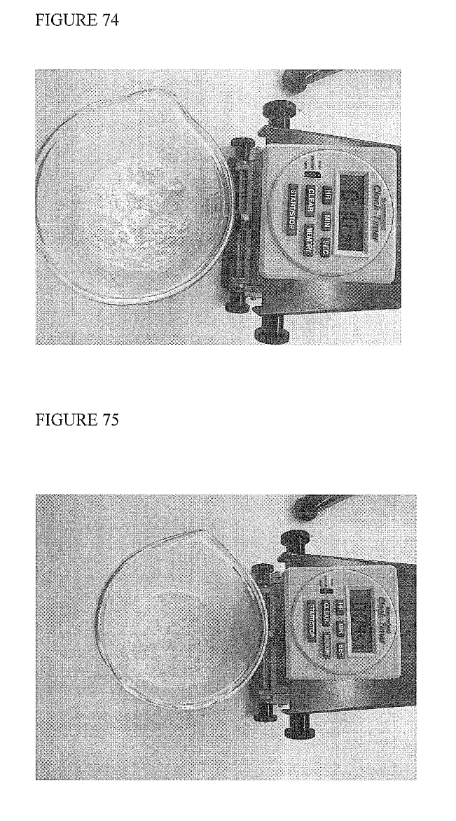

FIG. 74 shows milk powder made from standard, untreated whole milk;

FIG. 75 shows milk powder made from standard whole milk treated with a solution of KLM3 enzyme, (KTP08015, 1300 TIPU/g milk, corresponding to 12.4 mg enzyme/g milk); the activity of the enzyme in TIPU units being measured as described below;

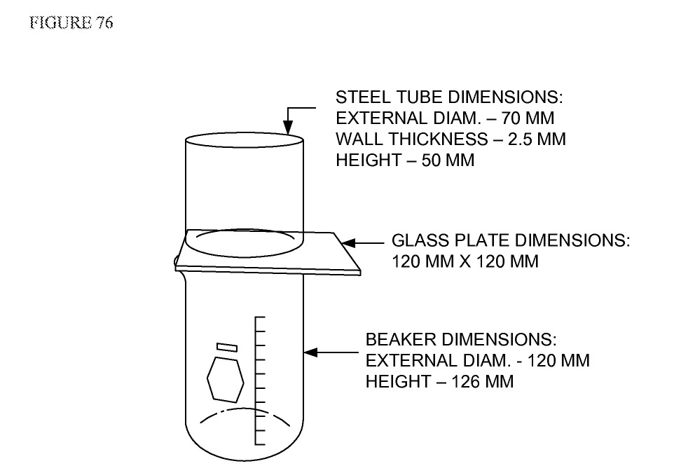

FIG. 76 illustrates the apparatus used to carry out the wettability test of Example 3;

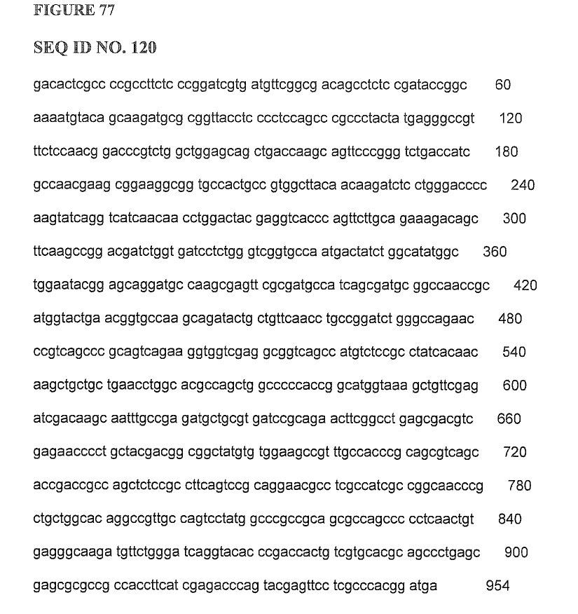

FIG. 77 shows a nucleotide sequence (SEQ ID NO. 120) which encodes a lipid acyltransferase from A. salmonicida;

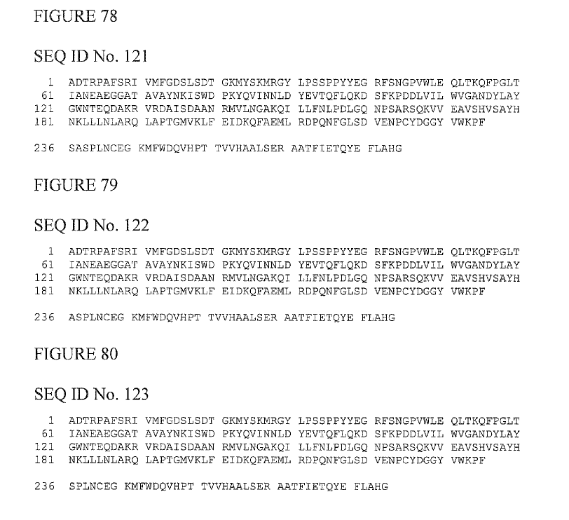

FIG. 78 shows the amino acid sequence of a mutant Aeromonas salmonicida mature lipid acyltransferase (GCAT) with a mutation of Asn80Asp (notably, amino acid 80 is in the mature sequence)—shown herein as SEQ ID No. 16—and after undergoing post-translational modification as SEQ ID No. 121—amino acid residues 235 and 236 of SEQ ID No. 121 are not covalently linked following post-translational modification; the two peptides formed are held together by one or more S—S bridges; amino acid 236 in SEQ ID No. 121 corresponds with the amino acid residue number 275 in SEQ ID No. 16 shown herein;

FIG. 79 shows the amino acid sequence of a mutant Aeromonas salmonicida mature lipid acyltransferase (GCAT) with a mutation of Asn80Asp (notably, amino acid 80 is in the mature sequence)—shown herein as SEQ ID No. 16—and after undergoing post-translational modification as SEQ ID No. 122—amino acid residues 235 and 236 of SEQ ID No. 122 are not covalently linked following post-translational modification; the two peptides formed are held together by one or more S—S bridges; amino acid 236 in SEQ ID No. 122 corresponds with the amino acid residue number 276 in SEQ ID No. 16 shown herein; and

FIG. 80 shows the amino acid sequence of a mutant Aeromonas salmonicida mature lipid acyltransferase (GCAT) with a mutation of Asn80Asp (notably, amino acid 80 is in the mature sequence)—shown herein as SEQ ID No. 16—and after undergoing post-translational modification as SEQ ID No. 123—amino acid residues 235 and 236 of SEQ ID No. 123 are not covalently linked following post-translational modification; the two peptides formed are held together by one or more S—S bridges; amino acid 236 in SEQ ID No. 123 corresponds with the amino acid residue number 277 in SEQ ID No. 16 shown herein.

### Determination of Phospholipase Activity (TIPU-K Assay):

### Substrate:

0.6% L-α phosphatidylcholine 95% Plant (Avanti #441601), 0.4% Triton-X 100 (Sigma X-100), and 5 mM CaCl₂ were dissolved in 0.05M 4-(2-hydroxyethyl)-1-piperazineethanesulfonic acid (HEPES) buffer pH 7.

### Assay Procedure:

34 μl substrate was added to a cuvette, using a KoneLab automatic analyzer. At time T=0 min, 4 μl enzyme solution was added. Also a blank with water instead of enzyme was analyzed. The sample was mixed and incubated at 30° C. for 10 minutes. The free fatty acid content of sample was analyzed by using the NEFA C kit from WAKO GmbH.

Enzyme activity TIPU pH 7 was calculated as micromole fatty acid produced per minute under assay conditions.

### Example 1

### Expression of KLM3′ in Bacillus licheniformis

A nucleotide sequence (SEQ ID No. 49) encoding a lipid acyltransferase (SEQ. ID No. 16, hereinafter KLM3′) was expressed in Bacillus licheniformis as a fusion protein with the signal peptide of B. licheniformis α-amylase (LAT) (see FIGS. 53 and 54). For optimal expression in Bacillus, a codon optimized gene construct (no. 052907) was ordered at Geneart (Geneart AG, Regensburg, Germany).

Construct no. 052907 contains an incomplete LAT promoter (only the −10 sequence) in front of the LAT-KLM3′ precursor gene and the LAT transcription (Tlat) downstream of the LAT-KLM3′ precursor gene (see FIGS. 53 and 55). To create a XhoI fragment that contains the LAT-KLM3′ precursor gene flanked by the complete LAT promoter at the 5′ end and the LAT terminator at the 3′ end, a PCR (polymerase chain reaction) amplification was performed with the primers Plat5XhoI_FW and EBS2XhoI_RV and gene construct 052907 as template.

Plat5Xhol_FW:
ccccgctcgaggcttttcttttggaagaaaatatagggaaaatggtacttgttaaaaattc
ggaatatttatacaatatcatatgtttcacattgaaagggg
EBS2Xhol_RV:
tggaatctcgaggttttatcctttaccttgtctcc

PCR was performed on a thermocycler with Phusion High Fidelity DNA polymerase (Finnzymes OY, Espoo, Finland) according to the instructions of the manufacturer (annealing temperature of 55° C.).

The resulting PCR fragment was digested with restriction enzyme XhoI and ligated with T4 DNA ligase into XhoI digested pICatH according to the instructions of the supplier (Invitrogen, Carlsbad, Calif., USA).

The ligation mixture was transformed into B. subtilis strain SC6.1 as described in US 2002-0182734 (WO 02/14490). The sequence of the XhoI insert containing the LAT-KLM3′ precursor gene was confirmed by DNA sequencing (BaseClear, Leiden, The Netherlands) and one of the correct plasmid clones was designated pICatH-KLM3′(ori1) (FIG. 53). pICatH-KLM3′(ori1) was transformed into B. licheniformis strain BML780 (a derivative of BRA7 and BML612, see WO2005111203) at the permissive temperature (37° C.).

One neomycin resistant (neoR) and chloramphenicol resistant (CmR) transformant was selected and designated BML780(pICatH-KLM3′(ori1)). The plasmid in BML780(pICatH-KLM3′(ori1)) was integrated into the catH region on the B. licheniformis genome by growing the strain at a non-permissive temperature (50° C.) in medium with 5 μg/ml chloramphenicol. One CmR resistant clone was selected and designated BML780-pICatH-KLM3′(ori1). BML780-pICatH-KLM3′(ori1) was grown again at the permissive temperature for several generations without antibiotics to loop-out vector sequences and then one neomycin sensitive (neoS), CmR clone was selected. In this clone, vector sequences of pICatH on the chromosome are excised (including the neomycin resistance gene) and only the catH-LATKLM3′ cassette is left. Next, the catH-LATKLM3′ cassette on the chromosome was amplified by growing the strain in/on media with increasing concentrations of chloramphenicol. After various rounds of amplification, one clone (resistant against 50 μg/ml chloramphenicol) was selected and designated BML780-KLM3′CAP50. To verify KLM3′ expression, BML780-KLM3′CAP50 and BML780 (the empty host strain) were grown for 48 h at 37° C. on a Heart Infusion (Bacto) agar plate with 1% tributyrin. A clearing zone, indicative for lipid acyltransferase activity, was clearly visible around the colony of BML780-KLM3′CAP50 but not around the host strain BML780 (see FIG. 56). This result shows that a substantial amount of KLM3′ is expressed in B. licheniformis strain BML780-KLM3′CAP50 and that these KLM3′ molecules are functional.

### Comparative Example 1

### Vector Construct

The plasmid construct is pCS32new N80D, which is a pCCmini derivative carrying the sequence encoding the mature form of the native Aeromonas salmonicida glycerophospholipid-cholesterol acyltransferase with a Asn to Asp substitution at position 80 (KLM3′), under control of the p32 promoter and with a CGTase signal sequence.

The host strain used for the expression is in the Bacillus subtilis OS21ΔAprE strain.

The expression level is measured as transferase activity, expressed as % cholesterol esterified, calculated from the difference in free cholesterol in the reference sample and free cholesterol in the enzyme sample in reactions with PC (T_{PC}) as donor and cholesterol as acceptor molecule.

### Culture Conditions

5 ml of LB broth (casein enzymatic digest, 10 g/l; low-sodium yeast extract, 5 g/l; sodium chloride, 5 g/l; inert tableting aids, 2 g/l) supplemented with 50 mg/l kanamycin, was inoculated with a single colony and incubated at 30° C. for 6 hours at 205 rpm. 0.7 ml of this culture was used to inoculate 50 ml of SAS media (K₂HPO₄, 10 g/l; MOPS (3-morpholinopropanesulfonic acid), 40 g/l; sodium Chloride, 5 g/l; Antifoam (Sin 260), 5 drops/l; Soy flour degreased, 20 g/l; Biospringer 106 (100% dw YE), 20 g/l) supplemented with 50 mg/l kanamycin and a solution of high maltose starch hydrolysates (60 g/l). Incubation was continued for 40 hours at 30° C. and 180 rpm before the culture supernatant was separated by centrifugation at 19000 rpm for 30 min. The supernatant was transferred into a clean tube and directly used for transferase activity measurement.

### Preparation of Substrates and Enzymatic Reaction

PC (Avanti Polar Lipids #441601) and cholesterol (Sigma C8503) was scaled in the ratio 9:1, dissolved in chloroform, and evaporated to dryness.

The substrate was prepared by dispersion of 3% PC:Cholesterol 9:1 in 50 mM HEPES buffer pH 7.

0.250 ml substrate solution was transferred into a 3 ml glass tube with screw lid. 0.025 ml culture supernatant was added and the mixture was incubated at 40° C. for 2 hours. A reference sample with water instead of enzyme was also prepared. Heating the reaction mixture in a boiling water bath for 10 minutes stopped the enzyme reaction. 2 ml of 99% ethanol was added to the reaction mixture before submitted to cholesterol assay analysis.

### Cholesterol Assay

100 μl substrate containing 1.4 U/ml Cholesterol oxidase (SERVA Electrophoresis GmbH cat. No 17109), 0.4 mg/ml ABTS (Sigma A-1888), 6 U/ml Peroxidase (Sigma 6782) in 0.1 M Tris-HCl, pH 6.6 and 0.5% Triton X-100 (Sigma X-100) was incubated at 37° C. for 5 minutes before 5 μl enzyme reaction sample was added and mixed. The reaction mixture was incubated for further 5 minutes and OD₄₀₅ was measured. The content of cholesterol was calculated from the analyses of standard solutions of cholesterol containing 0.4 mg/ml, 0.3 mg/ml, 0.20 mg/ml, 0.1 mg/ml, 0.05 mg/ml, and 0 mg/ml cholesterol in 99% ethanol.

### Results

Table 3 below shows the average of 8 separate expression cultures:

TABLE 3

| Strain | T_{PC}^{a} |
|---|---|
| OS21ΔAprE[pCS3 2new] | 74.2 ± 10.1^{b} |

^{a}T_{PC} is the transferase activity, expressed as % cholesterol esterified, calculated from the difference in free cholesterol in the reference sample and free cholesterol in the enzyme sample in reactions with PC as donor molecule and cholesterol as acceptor molecule.
^{b}Average of 8 separate expression cultures

### Example 2

### Enzymation Test

In the trials described below, the moisture content, wetting time and cholesterol and cholesterol ester levels of milk powder formed by spray drying 25 litres of standard whole milk which had been treated with an enzyme for 30 minutes and 4 hours (as described below) were compared with milk powder formed by feeding 25 litres of standard whole milk directly to the spray drying tower (referred to below as the control sample).

Enzyme Treatment of Whole Milk from ARLA

20 litres of whole milk was heated to 40° C. and 76 μl of a solution solution of the enzyme of SEQ ID No. 16 (hereinafter KLM3′), (KTP08015, 1300 TIPU/g milk, corresponding to 12.4 mg enzyme/g milk) was added.

Mixing was continued for 38 minutes to ensure homogeneity, and the treated milk was then divided into 2 lots. Lot 1 was pumped to the spray tower immediately; lot 2 was pumped to the spray tower 4 hours after adding the enzyme.

The parameters used for operation of the pilot plant spray dryer during trials were as follows:

### Control Sample (ARLA Whole Milk)

Spray tower: NIRO DRYER model P 6.3; 400 m³; air inlet at 220° C.; power 54 kW.

Outlet temperatures: 105/40.5° C. (air/product).

Feed temperature 40° C. Rannie feed pump 17 rpm.

Atomizing nozzle pressure 18 MPa (180 bar) (ata). Nozzle type KMFP SKYM M76.

### Enzyme Treated Lot 1

400 m³; air inlet at 195° C.; power 48 kW.

Outlet temperatures: 100-103/43° C. (air/product).

Feed temperature 40° C. Rannie feed pump 15 rpm.

Atomizing nozzle pressure 16 MPa (160 bar) (ata). Nozzle type KMFP SKYM M76.

### Enzyme Treated Lot 2

400 m³; air inlet at 195° C.; power 48 kW.

Outlet temperatures: 100-103/43° C. (air/product).

Feed temperature 42° C. Rannie feed pump 16 rpm.

Atomizing nozzle pressure: 17.5 MPa (175 bar) (ata). Nozzle type KMFP SKYM M76.

### Example 3

### Wettability Test

The milk powders derived from Example 2 were tested for wettability in accordance with IDF method 87:1979 with due consideration to the fact that method is intended for testing instantized milk powders, whereas the powders made from the pilot plant dryer is a non-instantized and non agglomerated powder. The apparatus used is illustrated in FIG. 76.

The results are shown in Table 4 below.

Powder characteristics show that the powder made from enzymated milk is more free-flowing and has slightly lower tendency for lumping.

TABLE 4

| Sample | Wetting time |
|---|---|
| Control | >10 minutes in all 3 repeat tests |
| Enzyme treated lot 1 | 1st repeat test 403 s; |
| | 2nd repeat test 394 s; |
| | average wetting time 399 s. |
| Enzyme treated lot 2 | 1st repeat test 320 s; |
| | 2nd repeat test 309 s; |
| | average wetting time 315 s. |

### Example 4

### Analysis of Residual Moisture Content in Powder Samples after Storage

The samples prepared according to Example 2 above were analysed for residual moisture content in powder samples after storage for one week at 5° C. using a Moisture Analyser ML-50 from A&D Company, Limited. The moisture analyses were conducted after drying at 120° C. until constant weight and at 140° C. until constant weight. The results are shown in Table 5 below.

TABLE 5

| | Drying temp, | Drying temp. | |
|---|---|---|---|
| Sample | 120° C. | 140° C. | Average, % water |
| Control | 2.5 | 2.6 | 2.6 |
| Enzyme treated lot 1 | 2.0 | 2.1 | 2.1 |
| Enzyme treated lot 2 | 1.7 | 1.8 | 1.8 |

### Example 5

### Determination of Cholesterol and Cholesterol Ester Levels

The milk powder samples prepared in Example 2 above were analysed by GLC for the content of cholesterol and cholesterol ester. The method used is described below.

100 mg milk powder was scaled in a 15 ml centrifuge tube with lid. 5 ml choleroform:methanol 2:1 was added, and the sample was extracted for 30 minutes by rotation on a RotaMix® at 40 rpm. The sample was centrifuged. A scaled aliquot of the solvent was transferred to a 10 ml Dramglass and the solvent was evaporated under a steam of Nitrogen at 50° C. The isolated sample was analysed by GLC.

### Gas Chromatography:

Perkin Elmer Autosystem 9000 Capillary Gas Chromatograph equipped with WCOT fused silica column 12.5 m×0.25 mm ID×0.1μ film thickness 5% phenyl-methyl-silicone (CP Sil 8 CB from Chrompack).

Carrier gas: Helium.

Injector. PSSI cold split injection (initial temp 50° C. heated to 385° C.), volume 1.0 μl.

Detector FID: 395° C.

| Oven program (used since 30 Oct. 2003): | 1 | 2 | 3 |
|---|---|---|---|
| Oven temperature, ° C. | 90 | 280 | 350 |
| Isothermal time, min. | 1 | 0 | 10 |
| Temperature rate, ° C./min. | 15 | 4 | |

### Preparation of Milk Samples for GC Analysis:

The lipid fraction is redissolved in heptane/pyridine (2:1) containing heptadecane as internal standard and cholesterol is measured by GC.

500 μl sample solution is then transferred to a crimp vial, 100 μl MSTFA:TMCS—99:1 (N-Methyl-N-trimethylsilyl-trifluoroacetamide) is added and reacted for 20 minutes at 60° C.

Calculation: Response factors for cholesterol and cholesterol esters are determined from pure reference material (weighing for pure material 8-10 mg in 12 ml pyridine, containing internal standard heptadecane, 0.5 mg/ml).

The results are shown in Table 6 below.

TABLE 6

| | Cholesterol, | Cholesterol | Esterified |
|---|---|---|---|
| Sample | % | ester, % | cholesterol, % |
| Control | 0.084 | 0 | 0 |
| Enzyme treated lot 1 | 0.021 | 0.080 | 69.2 |
| Enzyme treated lot 2 | 0.007 | 0.094 | 89.0 |

### CONCLUSIONS

Enzyme treatment of whole milk with lipid acyltransferase KLM3 has a strong impact on the wettability of the milk powder produced from the milk. The enzyme treatment also has an impact on the drying temperature, as it is shown that the enzyme treated samples has a lower water content than control.

Free cholesterol in milk produced from milk treated with acyltransferase was significantly reduced compared to a control without enzyme treatment.

All publications mentioned in the above specification are herein incorporated by reference. Various modifications and variations of the described methods and system of the present invention will be apparent to those skilled in the art without departing from the scope and spirit of the present invention. Although the present invention has been described in connection with specific preferred embodiments, it should be understood that the invention as claimed should not be unduly limited to such specific embodiments. Indeed, various modifications of the described modes for carrying out the invention which are obvious to those skilled in biochemistry and biotechnology or related fields are intended to be within the scope of the following claims.

1.-50. (canceled)

51. A method of producing powder milk, the method comprising:
(a) contacting milk or a fraction thereof with a lipid acyltransferase enzyme; and
(b) drying the lipid acyltransferase enzyme treated milk to produce the powder milk.

52. The method of claim 51, wherein the lipid acyltransferase enzyme is selected from lipid acyltransferases in enzyme class (E.C.) 2.3.1.x.

53. The method of claim 51, wherein the lipid acyltransferase enzyme activity when using a Transferase Assay has at least 10% of the lipid acyltransferase enzyme activity.

54. The method of claim 51, wherein the lipid acyltransferase enzyme is capable of esterifying at least about 10% of cholesterol present in the milk.

55. The method of claim 51, wherein the lipid acyltransferase enzyme is characterized as an enzyme which possesses lipid acyltransferase activity and which comprises one or more of an amino acid sequence motif GANDY or the amino acid motif GDSX, wherein X is one or more of amino acid residues L, A, V, I, F, Y, H, Q, T, N, M or S.

56. The method of claim 51, wherein the lipid acyltransferase enzyme is obtained from an organism from one or more of the following genera: Aeromonas, Streptomyces, Saccharomyces, Lactococcus, Mycobacterium, Streptococcus, Lactobacillus, Desulfitobacterium, Bacillus, Campylobacter, Vibrionaceae, Xylella, Sulfolobus, Aspergillus, Schizosaccharomyces, Listeria, Neisseria, Mesorhizobium, Ralstonia, Xanthomonas or Candida.

57. The method of claim 51, wherein the lipid acyltransferase enzyme is a polypeptide having lipid acyltransferase enzyme activity, wherein the polypeptide is obtained by expression of any one of the nucleotide sequences shown as SEQ ID No. 36, SEQ ID No. 38, SEQ ID No. 39, SEQ ID No. 42, SEQ ID No. 44, SEQ ID No. 46, SEQ ID No. 48, SEQ ID No. 49, SEQ ID No. 50, SEQ ID No. 51, SEQ ID No. 52, SEQ ID No. 53, SEQ ID No. 54, SEQ ID No. 55, SEQ ID No. 56, SEQ ID No. 57, SEQ ID No. 58, SEQ ID No. 59, SEQ ID No. 60, SEQ ID No. 61, SEQ ID No. 62, SEQ ID No. 63 or any of the nucleotide sequences having 75% or more identity therewith.

58. The method of claim 51, wherein the lipid acyltransferase enzyme is a polypeptide having lipid acyltransferase enzyme activity, wherein the polypeptide is obtained by expression of:
(i) nucleotide sequence shown as SEQ ID No. 49 or the nucleotide sequence shown as SEQ ID No. 49 which has 75% or more identity therewith;
(ii) a nucleic acid which encodes the polypeptide wherein the polypeptide is at least 70% identical with a polypeptide sequence shown in SEQ ID No. 16 or with the polypeptide sequence shown in SEQ ID No. 68; or
(iii) the nucleic acid which hybridizes under medium stringency conditions to a nucleic probe comprising the nucleotide sequence shown as SEQ ID No. 49.

59. The method of claim 51, wherein the lipid acyltransferase enzyme is a polypeptide having lipid acyltransferase enzyme activity, wherein the polypeptide comprises any one of amino acid sequences shown as SEQ ID No. 1, SEQ ID No. 3, SEQ ID No. 4, SEQ ID No. 5, SEQ ID No. 6, SEQ ID No. 7, SEQ ID No. 8, SEQ ID No. 9, SEQ ID No. 10, SEQ ID No. 11, SEQ ID No. 12, SEQ ID No. 13, SEQ ID No. 14, SEQ ID No. 15, SEQ ID No. 17, SEQ ID No. 16, SEQ ID No. 17, SEQ ID No. 18, SEQ ID No. 34, SEQ ID No. 35, SEQ ID No. 68 or any of the amino acid sequences having 75% or more identity therewith.

60. The method of claim 51, wherein the lipid acyltransferase enzyme is contacted with the milk and incubated therewith at a temperature of between about 0° C. and about 70° C.

61. The method of claim 51, wherein the lipid acyltransferase enzyme is contacted with the milk and incubated therewith for a time of between about 1 minute and about 36 hours.

62. The method of claim 51, wherein the lipid acyltransferase enzyme is used in manufacturing the powder milk for improving perceptible sensory difference of the powder milk.

63. The method of claim 51, wherein the lipid acyltransferase enzyme is used in manufacturing the powder milk for improving one or more of smell or taste of the powder milk.

64. The method of claim 51, wherein the lipid acyltransferase enzyme is used in manufacturing the powder milk for improving flowability of the powder milk.

65. The method of claim 51, wherein the lipid acyltransferase enzyme is used in manufacturing the powder milk for reducing fouling of equipment used in manufacture of the powder milk.

66. A method of using lipid acyltransferase enzyme in manufacturing powder milk for improving rehydration properties of the powder milk.

67. The method of claim 66, wherein a milk product is produced by rehydrating the powder milk.

68. The method of claim 66, wherein the improved rehydration properties comprise an improved wettability of the powder milk.

69. A method of using of a lipid acyltransferase enzyme in manufacturing powder milk for reducing cholesterol content of the powder milk.

70. The method of claim 69, wherein the lipid acyltransferase enzyme is used in manufacture of the powder milk for reducing free fatty acid content of the powder milk compared with the powder milk that has been treated with a phospholipase during its manufacture.
